(19) United States
(12) Patent Application Publication
(10) Pub. No.: US 2016/0349926 A1
(43) Pub. Date: Dec. 1, 2016

(54) INTERFACE DEVICE, PORTABLE DEVICE, CONTROL DEVICE AND MODULE

(71) Applicant: NEC Corporation, Minato-ku, Tokyo (JP)

(72) Inventor: Fujio OKUMURA, Tokyo (JP)

(21) Appl. No.: 15/110,486

(22) PCT Filed: Jan. 7, 2015
(86) PCT No.: PCT/JP2015/000030

§ 371 Date: Jul. 8, 2016

(30) Foreign Application Priority Data
Jan. 10, 2014 (JP) 2014-003224

(51) Int. Cl. G06F 3/042; G06F 3/0346; H04N 9/31; G06F 3/0482; G06F 3/0484; G06F 1/16; G06F 3/01; G06F 3/03

(52) U.S. Cl. CPC G06F 3/0426; G06F 3/017; G06F 3/0346; G06F 3/0304; G06F 3/0425; G06F 3/0482; G06F 3/04845; G06F 1/163; H04N 9/3194; G06F 3/04886

(57) ABSTRACT

In order to provide an interface that has input functionality with high recognition precision, this interface device (100) is provided with an imaging unit (110), a control unit (120), and a projection unit (130). The protection unit (130) projects projected video (300). The imaging unit (110) captures video of the area in which the projected video (300) is being projected. If captured video captured by the imaging unit (110) contains both the projected video (300) and a user-input object (400), then on the basis of the relationship between the position of the projected video (300) in the captured video and the position of the user-input object (400) in the captured video, the control unit (120) generates user-input information by recognizing user input being performed using the user-input object (400).

### TECHNICAL FIELD

The present invention relates to a technology in an interface.

### BACKGROUND ART

In recent years, research and development of an interface device, such as a virtual keyboard and a virtual mouse, have been conducted. The interface device includes, for example, a projection unit and an imaging unit. This interface device provides an interface function through display (projection) of, for example, a keyboard and information by the projection unit, and image processing of an image captured by the imaging unit. Recent miniaturization in the projection unit and the imaging unit provides easier miniaturization and more portability for such an interface device compared with a common input device such as a keyboard and a mouse.

NPL 1 discloses an example of a virtual keyboard. A device providing the virtual keyboard disclosed in NPL 1 includes a red semiconductor laser, an infrared semiconductor laser, and a camera. In the device (virtual keyboard), the red semiconductor laser projects an image of a keyboard, and at the same time, the infrared semiconductor laser irradiates a screen-shaped infrared beam to a region on which the keyboard is projected. Then, when an operator takes an action of pressing a key on the projected keyboard with a finger, the screen-shaped infrared beam hits the finger and reflects. By the camera capturing the reflected infrared light, the device (virtual keyboard) recognizes a position of the finger based on the captured picture image.

NPL 2 discloses an example of an interface device. The interface device disclosed in NPL 2 is configured with a combination of a projection device set on a shoulder an operator and a three-dimensional (3D) depth recognition device. The projection device projects a key pattern and the like, and the 3D depth recognition device, commonly called Kinect (Kinect is a registered trademark by Microsoft), recognizes that a key is pressed, by use of a three-dimensional position detection function.

### CITATION LIST

### Patent Literature

[PTL 1] Japanese Translation of PCT International Application Publication No. 2013-525923
[PTL 2] Japanese Unexamined Patent Application Publication No. 2009-129021
[PTL 3] Japanese Unexamined Patent Application Publication No. 2007-310789
[PTL 4] Japanese Unexamined Patent Application Publication No. 2005-301693

### Non Patent Literature

[NPL 1] Virtual Keyboard, [searched on Jan. 10, 2014], Internet (URL: http://ex4.sakura.ne.jp/kb/main_vkb.htm)
[NPL 2] Hrvoje Benko, Scott Saponas, “Omnitouch,” Microsoft, [searched on Jan. 10, 2014], Internet (URL: http://research.microsoft.com/en-us/news/features/touch-101711.aspx)
[NPL 3] Kashiko Kodate, Takeshi Kamiya, “Numerical Analysis of Diffractive Optical Element and Application Thereof,” Maruzen Publishing Co., Ltd., December, 2011, pp. 175-179
[NPL 4] Edward Buckley, “Holographic Laser Projection Technology,” Proc, SID Symposium 70.2, pp. 1074-1079, 2008

### SUMMARY OF INVENTION

### Technical Problem

In the virtual keyboard disclosed in NPL 1, a screen-shaped infrared beam needs to be irradiated based on a projected position (operation surface) of a keyboard. Consequently, there is a problem that a positional relation between the projected position (operation surface) of the keyboard and the device is uniquely determined. A mobile terminal such as a tablet becoming remarkably widespread in recent years has a convenient function that, whether a screen is turned horizontally or vertically, an image is rotated to be displayed in a direction easy for a user to view. However, in a case that the virtual keyboard disclosed in NPL 1 is equipped on a mobile terminal such as a tablet, there is a problem that, in spite of a convenient function as a mobile terminal, the function cannot be utilized when the virtual keyboard is used. In other words, in order to effectively use the virtual keyboard, an interval between the mobile terminal and the projected position of the keyboard needs to be a predetermined proper interval, and thereby a position of the mobile terminal is determined. Additionally, the mobile terminal needs to be placed at a certain angle to the projection surface of the keyboard, and thereby a degree of freedom in a position of the mobile terminal becomes small.

Further, in the technology disclosed in NPL 1, there is a fundamental problem that a device tends to malfunction. Specifically, while fingers are placed on keys in a basic position when a conventional keyboard is used, fingers need to be kept floating in the case of the virtual keyboard. Therefore, when a finger is unnecessarily brought close to the operation surface by mistake, the device recognizes the action as a keystroke.

The interface device disclosed in NPL 2 also has a problem related to recognition accuracy. An operation of recognizing a keystroke, by three-dimensionally detecting positions of a finger and a surface, requires an extremely high-accuracy recognition technology. Therefore, it appears difficult for the interface device disclosed in NPL 2 to prevent false recognition due to effects of a direction of a hand and ambient light and the like.

The present invention is devised to solve the aforementioned problems. In other words, a main object of the present invention is to provide an interface device having an input function with high recognition accuracy.

### Solution to Problem

An interface device of the present invention includes, as one aspect,

a projection unit that projects a first projected image;

an imaging unit that captures an image of a region on which the first projected image is projected; and

a control unit that, when the first projected image is captured and also an operating object is captured in a captured image that is an image captured by the imaging unit, recognizes operation information on operation of the operating object based on a positional relation between a captured position in which the first projected image is captured and a captured position in which the operating object is captured in the captured image.

An interface device of the present invention includes, as one aspect,

a projection unit that projects a projected image;

an imaging unit that captures an image of a region on which the projected image is projected; and

control unit that calculates a positional relation between a surface on which the projected image is projected and the imaging unit based on information about a captured position in which the projected image is captured in a captured image being an image captured by the imaging unit.

A portable device of the present invention includes, as one aspect, the interface device of the present invention.

A control device of the present invention includes, as one aspect,

a unit that receives a captured image displaying a projected image projected by projection unit being a control target;

when the projected image and also an operating object are displayed in the captured image, recognizes operation information on the operating object based on a relation between a captured position in which the projected image is displayed and a captured position in which the operating object is displayed in the captured image; and

controls the projection unit in response to the operation information.

A module of the present invention includes, as one aspect,

the control device of the present invention and

projection unit controlled by the control device.

A control method of the present invention includes, as one aspect,

receiving a captured image displaying a projected image projected by projection unit being a control target;

when the projected image and also an operating object are displayed in the captured image, recognizing operation information on the operating object based on a relation between a captured position in which the projected image is displayed and a captured position in which the operating object is displayed in the captured image; and

controlling the projection unit in response to the operation information.

A program storage medium of the present invention storing a computer program for causing a computer to perform:

processing of receiving a captured image displaying a projected image projected by projection unit being a control target, and, when the projected image and also an operating object are displayed in the captured image, recognizing operation information on the operating object based on a relation between a captured position in which the projected image is displayed and a captured position in which the operating object is displayed in the captured image; and

processing of controlling the projection unit in response to the operation information.

The object of the present invention is also achieved by a control method of the present invention related to an interface device of the present invention. Furthermore, the object of the present invention is also achieved by a computer program according to an interface device of the present invention and a control method of the present invention and a program storage medium storing the computer program.

### Advantageous Effects of Invention

The present invention is able to provide an interface device having an input function with high recognition accuracy.

### BRIEF DESCRIPTION OF DRAWINGS

FIG. 1 is a block diagram illustrating a configuration of an interface device according to a first exemplary embodiment of the present invention.

FIG. 2 is a block diagram illustrating a configuration of a control unit included in the interface device according to the first exemplary embodiment.

FIG. 3 is a diagram illustrating an operation of the control unit according to the first exemplary embodiment.

FIG. 4 is a diagram illustrating calibration processing.

FIG. 5 is a diagram further illustrating the calibration processing.

FIG. 6 is a diagram further illustrating the calibration processing.

FIG. 7 is a diagram further illustrating the calibration processing.

FIG. 8 is a diagram further illustrating the calibration processing.

FIG. 9 is a diagram further illustrating the calibration processing.

FIG. 10 is a diagram further illustrating the calibration processing.

FIG. 11 is a flowchart illustrating an example of operations of the interface device according to the first exemplary embodiment.

FIG. 12 is a diagram illustrating a first specific example of an interface provided by the interface device according to the first exemplary embodiment.

FIG. 13 is a diagram further illustrating the first specific example.

FIG. 14 is a diagram illustrating a second specific example of an interface provided by the interface device according to the first exemplary embodiment.

FIG. 15 is a diagram further illustrating the second specific example.

FIG. 16 is a diagram further illustrating the second specific example.

FIG. 17 is a diagram further illustrating the second specific example.

FIG. 18 is a diagram illustrating a third specific example of an interface provided by the interface device according to the first exemplary embodiment.

FIG. 19 is a diagram further illustrating the third specific example.

FIG. 20 is a diagram further illustrating the third specific example.

FIG. 21 is a diagram further illustrating the third specific example.

FIG. 22 is a diagram further illustrating the third specific example.

FIG. 23 is a diagram further illustrating the third specific example.

FIG. 24 is a diagram illustrating a fourth specific example of an interface provided by the interface device according to the first exemplary embodiment.

FIG. 25 is a diagram illustrating a fifth specific example of an interface provided by the interface device according to the first exemplary embodiment.

FIG. 26 is a diagram further illustrating the fifth specific example.

FIG. 27 is a diagram illustrating a sixth specific example of an interface provided by the interface device according to the first exemplary embodiment.

FIG. 28 is a diagram further illustrating the sixth specific example.

FIG. 29 is a diagram further illustrating the sixth specific example.

FIG. 30 is a diagram further illustrating the sixth specific example.

FIG. 31 is a diagram illustrating a seventh specific example of an interface provided by the interface device according to the first exemplary embodiment.

FIG. 32 is a diagram further illustrating the seventh specific example.

FIG. 33 is a diagram further illustrating the seventh specific example.

FIG. 34 is a diagram further illustrating the seventh specific example.

FIG. 35 is a diagram illustrating an example of a hardware configuration providing the interface device according to the first exemplary embodiment.

FIG. 36 is a diagram illustrating an example of a hardware configuration providing a projection unit included in the interface device according to the first exemplary embodiment.

FIG. 37 is a diagram illustrating an example of an element included in the interface device according to the first exemplary embodiment.

FIG. 38 is a diagram illustrating an example of the interface device according to the first exemplary embodiment applied to a tablet.

FIG. 39 is a diagram illustrating a common tablet.

FIG. 40 is a diagram illustrating an example of the interface device according to the first exemplary embodiment applied to a smartphone.

FIG. 41 is a diagram illustrating an example of the interface device according to the first exemplary embodiment applied to a small-sized terminal.

FIG. 42 is a diagram illustrating an example of the interface device according to the first exemplary embodiment applied to a wristband.

FIG. 43 is a diagram illustrating an example of the interface device according to the first exemplary embodiment applied to eyewear.

FIG. 44 is a diagram illustrating a first application example of the interface device according to the first exemplary embodiment.

FIG. 45 is a diagram further illustrating the first application example.

FIG. 46 is a diagram further illustrating the first application example.

FIG. 47 is a diagram further illustrating the first application example.

FIG. 48 is a diagram illustrating a second application example of the interface device according to the first exemplary embodiment.

FIG. 49 is a diagram further illustrating the second application example.

FIG. 50 is a diagram further illustrating the second application example.

FIG. 51 is a diagram illustrating a third application example of the interface device according to the first exemplary embodiment.

FIG. 52 is a diagram further illustrating the third application example.

FIG. 53 is a diagram further illustrating the third application example.

FIG. 54 is a diagram illustrating a fourth application example of the interface device according to the first exemplary embodiment.

FIG. 55 is a diagram further illustrating the fourth application example.

FIG. 56 is a diagram illustrating a fifth application example of the interface device according to the first exemplary embodiment.

FIG. 57 is a diagram further illustrating the fifth application example.

FIG. 58 is a block diagram illustrating a configuration of an interface device according to a second exemplary embodiment of the present invention.

FIG. 59 is a block diagram illustrating a configuration of a module according to a third exemplary embodiment of the present invention.

FIG. 60 is a block diagram illustrating a configuration of a control device according to a fourth exemplary embodiment of the present invention.

FIG. 61 is a block diagram illustrating a configuration of an interface device according to a fifth exemplary embodiment of the present invention.

FIG. 62 is a block diagram illustrating a configuration of a module according to a sixth exemplary embodiment of the present invention.

FIG. 63 is a block diagram illustrating a configuration of a module according to a seventh exemplary embodiment of the present invention.

### DESCRIPTION OF EMBODIMENTS

Exemplary embodiments according to the present invention will be described below with reference to the drawings. In all the drawings, a same reference sign is given to a same component, and description thereof is omitted as appropriate. Further, demarcation (division) represented by each block diagram is a configuration illustrated for convenience of description. Therefore, the present invention described with the respective exemplary embodiments as examples is not limited to configurations illustrated in the respective block diagrams, in terms of implementation thereof.

### First Exemplary Embodiment

### Description of Overview

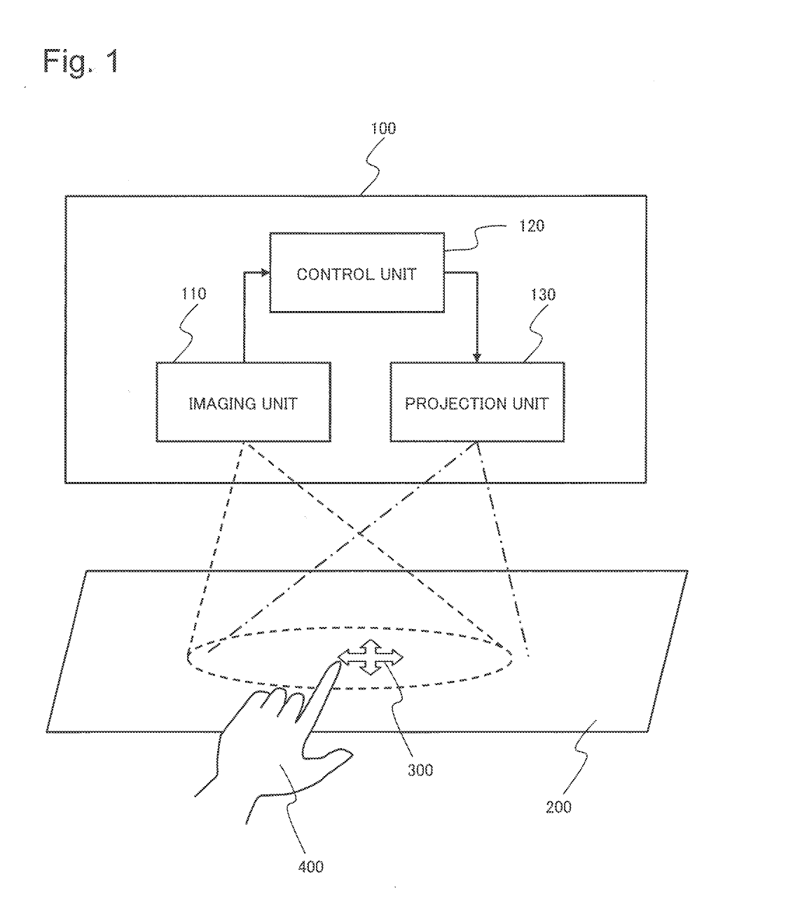

FIG. 1 is a block diagram illustrating a configuration of an interface device according to a first exemplary embodiment of the present invention. As illustrated in FIG. 1, an interface device 100 includes an imaging unit (imaging means) 110, a control unit (control means) 120, and a projection unit (projection means) 130.

The projection unit 130 has a function of projecting a projected image 300 determined by the control unit 120 onto a position or in a direction determined by the control unit 120. An image projected by the projection unit 130 is hereinafter expressed as a “projected image.” Further, a surface on which a projected image is projected is expressed as an operation surface 200.

As an example of a projected image 300, FIG. 1 illustrates an image of arrows representing upward, downward, leftward, and rightward directions. A “projected image” may hereinafter refer to an entire image projected by the projection unit 130, or part of an image projected by the projection unit 130 (such as a leftward arrow part in the example of the projected image 300 illustrated in FIG. 1). Light projected by the projection unit 130 is visible light. Light projected by the projection unit 130 may include ultraviolet light and infrared light, in addition to visible light.

An operating object 400 is an object pointing a projected image by the projection unit 130, and is, for example, a hand or a finger of a user using the interface device 100. Alternatively, the operating object 400 may be an object such as a pen, and may be light projected from a laser pointer. The operating object 400 is not limited to a finger, a hand, and the like, and an appropriate object that can be captured by the imaging unit 110 may be employed. It is assumed for convenience herein that, even when light from a laser pointer or the like is employed as a means of pointing an image projected by the projection unit 130, such light is also included in the operating object 400.

The imaging unit 110 includes a camera. The imaging unit 110 is capable of capturing an image including both the projected image 300 and the operating object 400. An image captured by the imaging unit 110 may be hereinafter expressed as a “captured image.” The imaging unit 110 captures visible light. The imaging unit 110 may include a camera capable of also capturing ultraviolet light or infrared light in addition to visible light. Further, depending on a function required for the interface device 100, the imaging unit 110 may include a device having another function such as a 3D depth measurement device.

The imaging unit 110 is set in consideration of a positional relation with the projection unit 130 so as to capture an image including both a projected image 300 projected on the operation surface 200 and an operating object 400 pointing the projected image.

Preferably, the imaging unit 110 and the projection unit 130 are placed close to one another. The reason is that such a placement is advantageous from a viewpoint of miniaturization of the interface device 100. Further, it is preferable that an angle of view of the imaging unit 110 and an angle of view of the projection unit 130 are aligned. Therefore, it is also advantageous from such a viewpoint that the imaging unit 110 and the projection unit 130 are placed close to one another. FIG. 1 illustrates the angle of view of the imaging unit 110 in dotted lines and the angle of view of the projection unit 130 in dot-and-dash lines.

By performing image processing on a picture image captured by the imaging unit 110, the control unit 120 calculates a positional relation between a position (captured position) in which an image of, for example, a character and a graphic, included in a projected image 300, is captured, and a position (captured position) in which the operating object 400 is captured. The control unit 120 recognizes operation information of the operating object 400 by detecting which image in the projected image 300 is pointed by the operating object 400 based on the calculated positional relation. For example, the interface device 100 is provided with information about projected images which are successively projected in response to operation and are associated with operation information. In this case, the control unit 120 determines a projected image 300 to be projected by the projection unit 130 next, and a projected position thereof based on the recognized operation information and information about the projected image associated with the operation information. Next, the control unit 120 controls the projection unit 130 such that the determined projected image 300 is projected onto the determined projected position.

A user of the interface device 100 inputs operation information to the interface device 100 by, for example, changing a relative position of the operating object 400 with respect to the projected image 300 projected on the operation surface 200. A typical example of an operation by the operating object 400 is that a user moves the operating object 400 on the operation surface 200 on which a projected image 300 is projected. Alternatively, in case that the imaging unit 110 is able to capture the operating object 400 along with the projected image 300, the user may move the operating object 400 in a position having an interval to the operation surface 200.

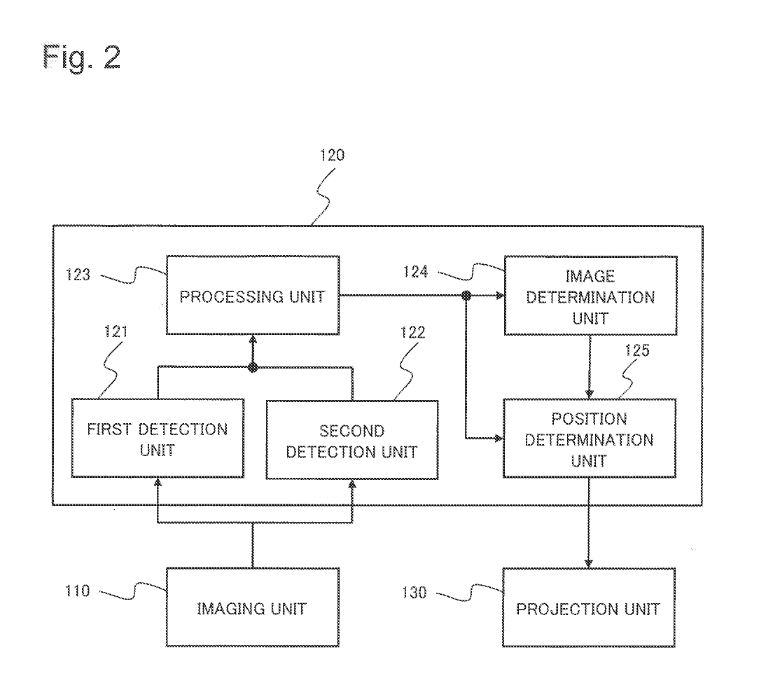

Next, the control unit 120 will be described in detail. FIG. 2 is a block diagram illustrating details of the control unit 120. As illustrated in FIG. 2, the control unit 120 includes a first detection unit (detection means) 121, a second detection unit (detection means) 122, a processing unit (processing means) 123, an image determination unit (image determination means) 124, and a position determination unit (position determination means) 125.

The first detection unit 121 has a function of detecting a position (captured position) in which an operating object 400 is captured in a captured image by image processing. The first detection unit 121 may have a function of detecting a motion (such as speed or acceleration) of the operating object 400 by use of, for example, object tracking processing. Additionally, the first detection unit 121 may have a function of detecting a shape of the operating object 400 by, for example, outline extraction processing. For example, in case that the operating object 400 is a hand of a user using the interface device 100, the first detection unit 121 may have a function of detecting a shape of a hand.

The second detection unit 122 has a function of detecting a position (captured position) of an image captured in a captured image by image processing, the image of the captured image is, for example, a character and a graphic (that is, an image related to operation information) included in a projected image 300.

The processing unit 123 has a function of detecting a positional relation between an image included in a projected image 300 and the operating object 400 in a captured image based on captured position information of the operating object 400 provided by the first detection unit 121 and captured position information of image provided by the second detection unit 122. The processing unit 123 has a function of recognizing operation information on the operating object 400 (that is, detecting what instruction is issued by use of the operating object 400 by a user) based on the detected positional relation. Additionally, the processing unit 123 may have an object recognition function of recognizing an object captured in a captured image based on, for example, outline data of the object and outline information obtained by performing image processing on the captured image. Furthermore, the processing unit 123 may recognize operation information on the operating object 400 based on, for example, data associating a motion of the operating object 400 with operation information related to the motion, and information about a motion of the operating object 400 provided by the first detection unit 121.

The image determination unit 124 has a function of determining a projected image 300 to be projected next by the projection unit 130 based on aggregate data of projected images 300 corresponding to operation information, and the operation information recognized by the processing unit 123.

The position determination unit 125 has a function of determining a projected position (projecting direction) of the projected image 300 determined by the image determination unit 124 based on data representing a projected position (or a projecting direction) of a projected image 300 being projected in response to operation information and the operation information recognized by the processing unit 123. Further, the position determination unit 125 has a function of controlling the projection unit 130 such that the projected image 300 determined by the image determination unit 124 is projected onto the determined position or in the determined direction.

The control unit 120 having a configuration illustrated in FIG. 2 is configured as described above. When the interface device 100 is implemented on (incorporated into) another device, the control unit 120 may have a function of exchanging information with the other device.

Further, the control unit 120 does not necessarily be placed close to the imaging unit 110 or the projection unit 130. For example, the imaging unit 110 and the projection unit 130 may be incorporated into a mobile device including a power source and a wireless unit, and the control unit 120 may be implemented on a device other than the mobile device. In this case, the control unit 120 provides the aforementioned function by communicating with the imaging unit 110 and the projection unit 130 by use of a wireless communication technology.

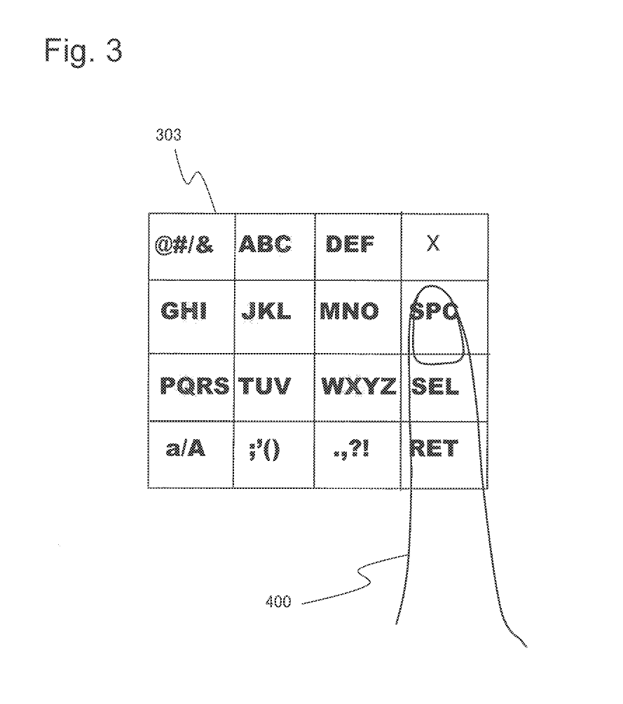

Next, an example of an operation of the control unit 120 will be described by use of FIG. 3. FIG. 3 is a diagram illustrating an example of a captured image captured by the imaging unit 110. FIG. 3 illustrates a projected image 303 and an operating object 400 as a captured image.

The projected image 303 in FIG. 3 includes a plurality of key-shaped images, and provides a user with an interface for entering a character.

The processing unit 123 recognizes operation information on the operating object 400 based on a positional relation between a captured position of the operating object 400 and a captured position of an image included in the projected image 303 in a captured image. In the example in FIG. 3, the processing unit 123 recognizes that the operating object 400 selects (points) a key “SPC (space).”

In the captured image illustrated in FIG. 3, a total of three keys, namely, the key “SPC (space),” a key “SEL (select),” and a key “RET (return),” overlap with the operating object 400. A specific example of a recognition operation by the processing unit 123 in this case will be described. A specific example described below is intended for facilitating understanding, and the specific example does not limit the operation of the processing unit 123.

For example, the first detection unit 121 detects a captured position of a tip (fingertip) of an operating object (finger) 400 by performing image processing on a captured image. The processing unit 123 detects a key in a projected image 303 with which the fingertip of the operating object 400 overlaps based on a positional relation between a captured position of the fingertip of the operating object 400 and a captured position of an image of each key included in the projected image 303. Then, the processing unit 123 recognizes that the key overlapping with the fingertip is the key selected (pointed) by the operating object 400. Thus, the processing unit 123 is able to recognize that the operating object 400 selects the key “SPC (space),” based on the captured image illustrated in FIG. 3.

Another specific example of an operation of the processing unit 123 will be described. The processing unit 123 recognizes that key is selected by the operating object 400 based on an area of a part in which the operating object 400 overlaps with a key in a captured image. In other words, in this case, the control unit 120 is given data representing an area of each key or an outline of each key. The processing unit 123 calculates an area of an overlapping part between the operating object 400 and a key, based on the data, outline information of the operating object 400, for example, detected by the first detection unit 121, and a positional relation between a captured position of each key and a captured position of the operating object 400. Then, the processing unit 123 detects (recognizes) the key selected by the operating object 400 based on the calculated area of the overlapping part and a predetermined rule. Specifically, in the example in FIG. 3, while 70 to 80 percent of the area of the key “SPC (space)” overlaps with the operating object 400, nearly the entire area of the key “SEL (select)” and the key “RET (return)” overlaps with the operating object 400. A rule that, for example, “a key having an area greater than or equal to 60 percent and less than 90 percent of which overlaps with the operating object 400 is regarded as being selected by the operating object 400” is given to the processing unit 123. The processing unit 123 is able to detect that the operating object 400 selects the key “SPC (space),” in the example in FIG. 3 based on an area of an overlapping part between the operating object 400 and a key and the rule.

As described above, the control unit 120 recognizes operation information on the operating object 400 based on a positional relation between a captured position of an image included in a projected image 300 and a captured position of the operating object 400 in a captured image.

The interface device 100 according to the first exemplary embodiment is able to recognize operation information on the operating object 400 by implemented with one imaging unit 110 and one projection unit 130. In other words, the interface device 100 according to the first exemplary embodiment can be provided with a small number of parts, and therefore is able to promote miniaturization, weight reduction, and power saving.

Further, when operating the interface device 100, a user does not necessarily need to have the operation object (finger) 400 in direct contact with the operation surface 200. In other words, even when the operating object 400 is not in contact with the operation surface 200, the control unit 120 is able to recognize operation information on the operating object 400, as long as the imaging unit 110 is able to capture an image in which the operating object 400 appears to point a part corresponding to an operation content in an projected image 300.

For example, in the case of a touch panel, a finger of a user directly contacts an operation surface thereof. When the touch panel is used by a large number of unspecified users, fingers of the large number of unspecified users contact the operation surface of the touch panel. In this case, a sensitive user is not able to comfortably use the touch panel. Further, a risk such as spread of an infectious disease through a contaminated touch panel may be considered.

By contrast, in the case of the interface device 100, a user does not need to have a finger in direct contact with the operation surface 200, and therefore the interface device 100 is superior from a hygienic viewpoint. Thus, a sensitive user is able to comfortably use the interface device 100. Further, unlike an interface device employing a touch panel, a user wearing gloves or the like is able to use the interface device 100 without any trouble.

—Description of Calibration Processing—

Calibration processing in the interface device 100 according to the first exemplary embodiment will be described below with reference to FIGS. 1 and 4 to 10.

In the interface device 100, in case that an optical axis of an optical system providing the imaging unit 110 and an optical axis of an optical system providing the projection unit 130 are assumed to be coaxial, a center position of a projected image 300 provided by the projection unit 130 and a center position of a captured image provided by the imaging unit 110 match. In this case, even when an interval between the interface device 100 and the operation surface 200, and an inclination of the operation surface 200 change, a captured position of an image included in a projected image 300 does not change in a captured image provided by the imaging unit 110, as long as a projecting direction of the projected image 300 provided by the projection unit 130 does not fluctuate.

However, in practice, an optical axis of the imaging unit 110 and an optical axis of the projection unit 130 are not coaxial. In this case, even when a projecting direction of a projected image 300 provided by the projection unit 130 remains the same, a captured position of an image included in the projected image 300 changes in a captured image depending on change in an interval between the interface device 100 and the operation surface 200, and an inclination of the operation surface 200. Consequently, the control unit 120 needs to obtain a positional relation between the imaging unit 110 and the operation surface 200 in a three-dimensional space based on a captured image provided by the imaging unit 110 in order to precisely obtain a part of a projected image 300 pointed by the operating object 400.

Processing of the control unit 120 obtaining a positional relation between the imaging unit 110 and the operation surface 200 in a three-dimensional space is hereinafter referred to as “calibration processing.”

Difference between commonly-performed calibration processing and calibration processing according to the first exemplary embodiment will be described.

First, a case of applying commonly-performed calibration processing to the interface device 100 will be described. In commonly-performed calibration processing, a pattern or the like drawn on the operation surface 200 is used. This case is easily understood by considering the operation surface 200 as a screen. Specifically, in the commonly-performed calibration processing, positions of four points or more are read based on a pattern or the like drawn on the screen itself. Then, the calibration processing is performed by aligning the read positions of the points with positions of points in a captured image. In such a method, calibration processing is required for every change in a position or an inclination of the operation surface 200 with respect to the imaging unit 110.

By contrast, the calibration processing according to the first exemplary embodiment is performed as follows. In the calibration processing according to the first exemplary embodiment, calibration processing is performed by use of a projected image 300 projected on the operation surface 200, instead of a pattern or the like drawn on the operation surface 200 itself.

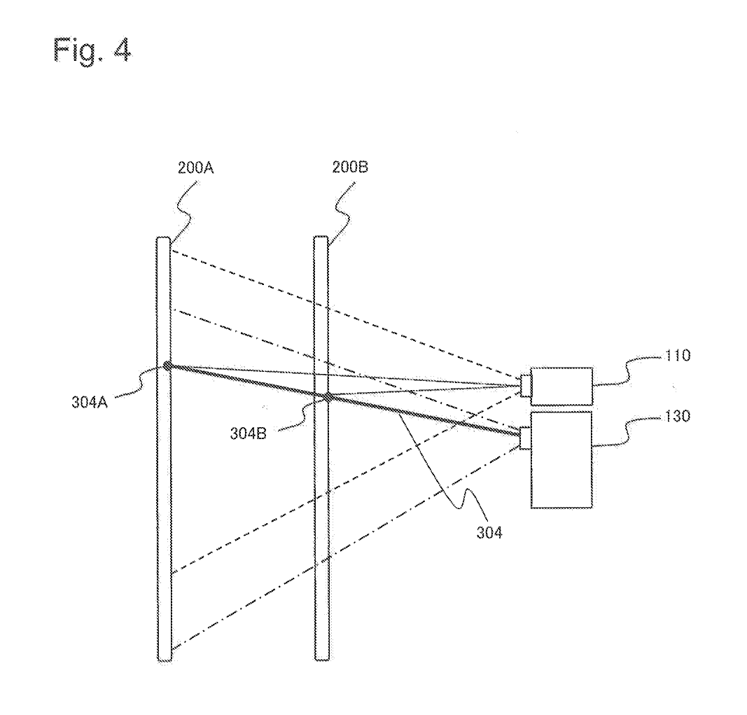

The processing will be described by use of FIG. 4. FIG. 4 is a diagram illustrating the calibration processing according to the first exemplary embodiment. FIG. 4 illustrates an angle of view of the imaging unit 110 in dotted lines and an angle of view of the projection unit 130 in dot-and-dash lines. As illustrated in FIG. 4, an optical axis of the imaging unit 110 and an optical axis of the projection unit 130 are not coaxial (not set collinearly), and therefore a center position of a capturing range provided by the imaging unit 110 and a center position of a projected image provided by the projection unit 130 are different. Consequently, even when a projecting direction of a projected image 300 provided by the projection unit 130 does not fluctuate, a captured position of an image included in the projected image 300 becomes different as a position of the operation surface 200 changes in a captured image provided by the imaging unit 110.

Assume that, in case that the operation surface 200 is at a position 200A illustrated in FIG. 4, a projected image (an image of a point) 304 is projected onto a position 304A illustrated in FIG. 4. In this case, the projected image 304 is positioned above a center part in a vertical direction in a captured image provided by the imaging unit 110.

On the other hand, in case that the operation surface 200 is at a position 200B closer to the imaging unit 110 than the position 200A, the projected image 304 is projected onto a position 304B. In this case, the projected image 304 is positioned near a center point in a vertical direction in a captured image provided by the imaging unit 110.

Thus, even when a projecting direction of a projected image 304 provided by the projection unit 130 remains the same, a captured position of an image included in a projected image 300 becomes different in a captured image, depending on a position and an inclination of the operation surface 200. The control unit 120 according to the first exemplary embodiment uses the difference (deviation) in captured positions to perform calibration processing. Thus the interface device 100 obtains a positional relation, between the imaging unit 110 and the operation surface 200 in a three-dimensional space.

In other words, the control unit 120 is able to obtain a positional relation between the imaging unit 110 and the operation surface 200 in a three-dimensional space based on a captured position of an image in a captured image. An example of a specific method will be described. For example, the interface device 100 is given a following formula in advance. The formula refers to a formula calculating a positional relation between the imaging unit 110 and the operation surface 200 in a three-dimensional space based on a captured position of an image of a character, a graphic, and the like included in a projected image 300 of a captured image provided by the imaging unit 110. Instead of the formula, the interface device 100 may be given, for example, a lookup table. Such a formula or a lookup table is obtained through an operation described below.

For example, a positional relation between the interface device 100 and the operation surface 200 in a three-dimensional space is obtained at a plurality of points. Then, for example, while changing positional relations among some of the points (hereinafter described as measurement points), the interface device 100 measures (detects) captured positions for each measurement points in a captured image provided by the imaging unit 110. For example, the interface device 100 is given a format in advance in order to generate a formula or a lookup table calculating a positional relation. The interface device 100 generates the formula or the lookup table described above based on the format and data obtained by the measurement (detection).

As described above, the interface device 100 according to the first exemplary embodiment performs calibration processing based on a captured position of an image projected on the operation surface 200. Therefore, the interface device 100 is readily able to perform the calibration processing, even when a pattern such as acting as a mark in calibration processing is not drawn on the operation surface 200.

Further, by obtaining a positional relation between the imaging unit 110 and the operation surface 200 in a three-dimensional space with performing calibration processing at first, the interface device 100 is able to specify an actual position of the operation surface 200 through merely analyzing a captured position of a projected image. Therefore, the interface device 100 is readily able to perform subsequent calibration processing. Even when a positional relation with the operation surface 200 changes dynamically, the interface device 100 is able to continue obtaining a positional relation between the imaging unit 110 and the operation surface 200 in a three-dimensional space by periodic calibration processing.

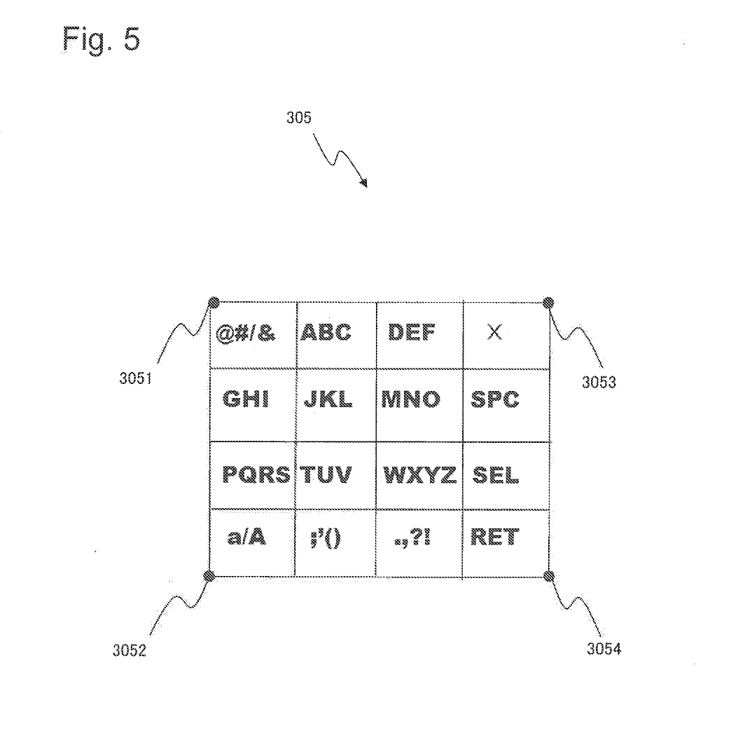

FIG. 5 is a diagram illustrating an example of a projected image which is provided by the projection unit 130 and is used by the control unit 120 in the calibration processing. A projected image 305 illustrated in FIG. 5 is a projected image identical to the projected image 303 illustrated in FIG. 3.

The projected image 305 includes a large number of line intersections, and therefore, the control unit 120 uses the intersections in the calibration processing. For example, the control unit 120 uses points 3051, 3052, 3053, and 3054 illustrated in FIG. 5, in the calibration processing. The reason such points are used is that use of an outermost point in an image instead of a point in a center part leads to a larger change in a captured position of a point with respect to a fluctuation of a position and an inclination of the operation surface 200, and thus improves accuracy of the calibration processing. As described above, the control unit 120 detects a positional relation between the imaging unit 110 and the operation surface 200 in a three-dimensional space based on the captured positions of the points 3051, 3052, 3053, and 3054 in the captured image.

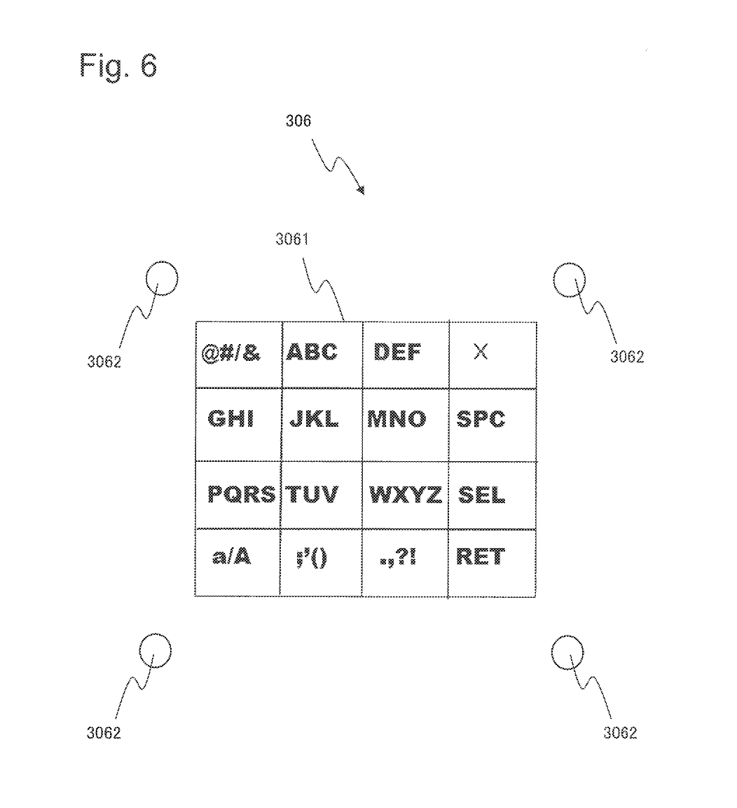

FIG. 6 is a diagram illustrating another example of a projected image which is provided by the projection unit 130 and is used by the control unit 120 in the calibration processing. A projected image 306 illustrated in FIG. 6 includes a region 3061 used by the operating object 400 (hereinafter described as an “operation region 3061”) and a part 3062 used for the calibration processing (hereinafter described as a “marker 3062”). The operation region 3061 is an image part in which the interface device 100 recognizes operation information on the operating object 400 by the part being pointed by the operating object 400. In the example in FIG. 6, an image of the operation region 3061 is an image similar to the projected image 305 illustrated in FIG. 5.

As illustrated in FIG. 6, the projected image 306 includes the marker 3062 aside from the operation region 3061. Thus, the control unit 120 is able to perform the calibration processing with high accuracy, regardless of what shape of an image the operation region 3061 is, by performing the calibration processing by use of the marker 3062.

The marker 3062 is an image, a plurality of which (four in the example in FIG. 6) are displayed on a circumferential part in the projected image 306, with an interval among each other, and also is preferably projected on a part by which a projected position on the operation surface 200 can be specified. Further, it is preferable that a shape of the marker 3062 is, for example, a circular or elliptical shape. The reason is that such a shape facilitates the control unit 120 to calculate a center point of the marker.

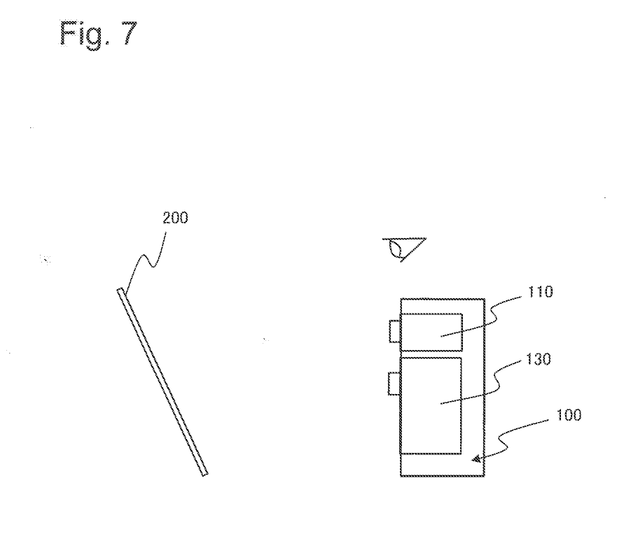

An advantage of separating the marker 3062 from the operation region 3061 will be described by use of FIGS. 7, 8, and 9.

FIG. 7 illustrates the operation surface 200 in a position inclined with respect to optical axes of the imaging unit 110 and the projection unit 130 of the interface device 100. For example, when the projected image 306 illustrated in FIG. 6 is projected onto the thus inclined operation surface 200, the operation region 3061 being originally a rectangle is transformed into a trapezoid having an upper base longer than a lower base. Further, the four markers 3062 are originally positioned at corners of a virtual rectangular shape. However, the four markers 3062 are positioned at corners of a virtual trapezoidal shape. In other words, an interval between the two upper markers 3062 is wider than an interval between the two lower markers 3062. Thus, relative positional relations among the four markers 3062 change due to an inclination of the operation surface 200. The cause of such transformation is that the projected image 306 expands as a distance between the interface device 100 and the operation surface 200 becomes greater.

The control unit 120 is able to recognize that the operation surface 200 is inclined, by detecting that relative positional relations among the markers 3062 in a captured image are deviated (changed) based on relative positional relations being reference among a plurality of the markers 3062.

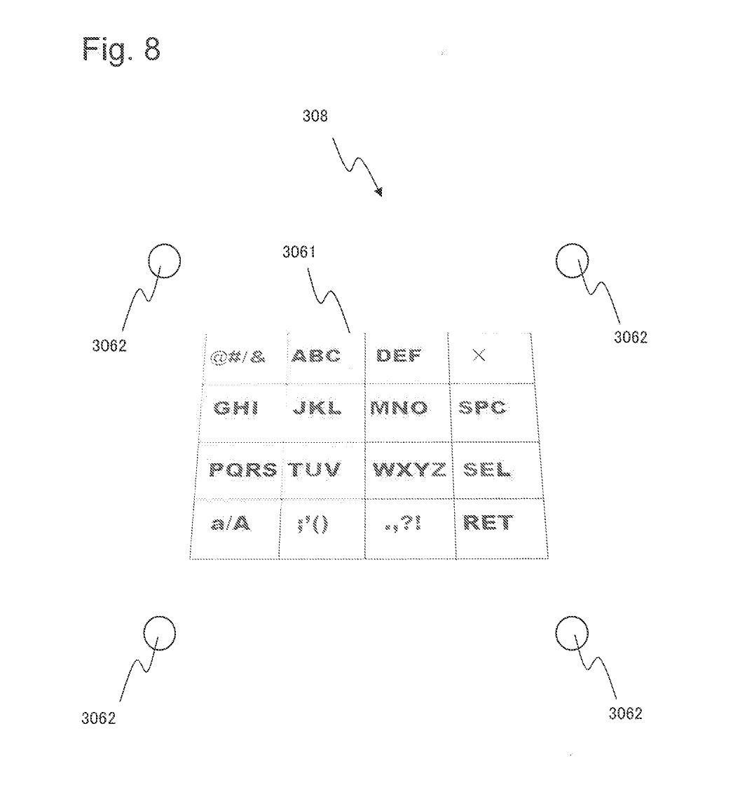

Further, as described above, there arises a problem that a shape of the operation region 3061 is transformed (distorted) due to inclination of the operation surface 200 with respect to the optical axis of the projection unit 130. Specifically, there arises a problem that, despite an intention of displaying a rectangular-shaped operation region 3061 on the operation surface 200, the operation region 3061 displayed on the operation surface 200 becomes a trapezoidal shape due to inclination of the operation surface 200. In order to prevent the problem, the control unit 120 controls the projection unit 130 to project, for example, as illustrated in FIG. 8, a projected image 308 including a pre-transformed operation region 3061 on the projection surface 200.

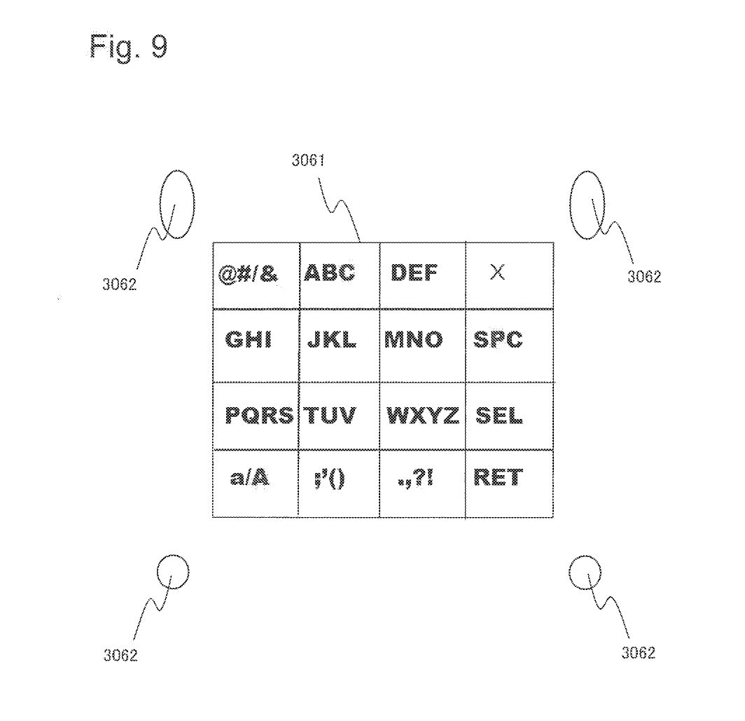

When the projected image 308 as illustrated in FIG. 8 is projected on the operation surface 200, a user of the interface device 100 viewing the operation surface 200 illustrated in FIG. 7 should view an image as illustrated in FIG. 9. Thus, even when the operation surface 200 is inclined with respect to the optical axis of the projection unit 130, an operation region 3061 is displayed on the operation surface 200 without distortion in shape, by projecting the operation region 3061 in a shape considering inclination of the operation surface 200.

As described above, in the first exemplary embodiment, the calibration processing is performed by use of transformation (distortion) of a projected image 300 due to change such as inclination of the operation surface 200. By providing the marker 3062 used in the calibration processing aside from the operation region 3061, a following effect can be obtained. Specifically, the effect is an effect that the calibration processing can be performed by use of the markers 3062, and also, an image of the operation region 3061 without distortion, as illustrated in FIG. 9, can be displayed on the inclined operation surface 200. By contrast, when an entire projected image 300 is an operation region 3061, transformation based on inclination of the operation surface 200 is permitted in part of the operation region 3061 in the calibration processing, and it is difficult to put a remaining part in a state of being displayed on the operation surface 200 without transformation.

Thus, the calibration processing can be performed on the projected image 300 in actual use by use of the markers 3062, and also the operation region 3061 without distortion can be projected on the operation surface 200.

When the control unit 120 completes the aforementioned calibration processing, the interface device 100 may project a projected image 300 allowing a user to recognize that the calibration processing is complete.

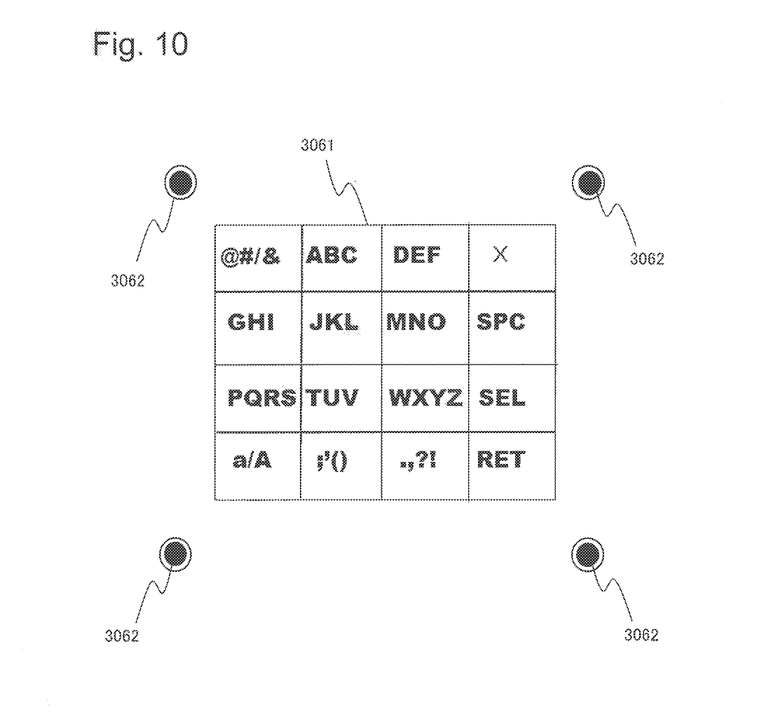

FIG. 10 is a diagram illustrating an example of the action described above. The interface device 100 changes the marker 3062 from a form illustrated in FIG. 6 to a form illustrated in FIG. 10 after, for example, the control unit 120 performs the calibration processing. By the change of the marker 3062, a user is able to recognize that the calibration processing is performed.

The marker 3062 is not necessarily an image based on visible light. For example, in case that the imaging unit 110 includes a camera capable of capturing infrared rays, the marker 3062 may be an image based on infrared rays. For example, the operation region 3061 may be an image based on visible light and the marker 3062 may be an image based on infrared rays.

——Example of Operation of Interface Device 100 According to First Exemplary Embodiment——

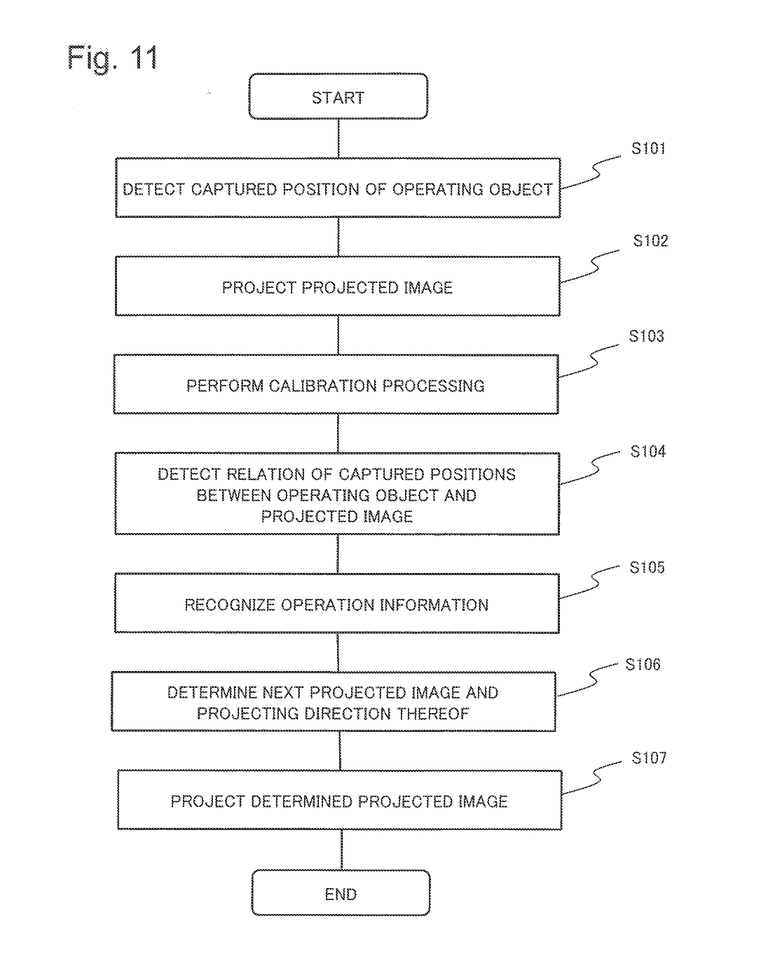

Next, an example of operations of the interface device 100 according to the first exemplary embodiment will be described by use of FIG. 11. FIG. 11 is a flowchart illustrating an example of operations of the interface device 100.

The interface device 100 detects the captured position of the operating object 400 in a captured image (Step S101). The interface device 100 accordingly projects the projected image 300 onto a region peripheral to the operating object 400 (including the operating object 400) (Step S102). Subsequently, the interface device 100 performs the calibration processing (Step S103). Thus, the interface device 100 obtains the positional relation between the operation surface 200 and the imaging unit 110. Then, the interface device 100 adjusts the projecting direction of the projected image 300 and the like. After the adjustment, the interface device 100 projects the projected image 300 being identical to or different from the projected image 300 projected in Step S102. A series of operations starting from Step S102 and ending when the projected image 300 after the adjustment is projected complete within a frame or two frames, and therefore the projected image 300 may appear to switch instantaneously to a user.

Subsequently, the interface device 100 detects a positional relation between a captured position of the operating object 400 and a captured position of the projected image 300 in the captured image (Step S104). Then, the interface device 100 recognizes operation information on the operating object 400 based on relation data between an image such as a character and a graphic included in the projected image 300 and the operation information associated with the image, and the detected positional relation (Step S105).

Subsequently, the interface device 100 determines the projected image 300 to be projected next, and a projecting direction thereof and the like based on the operation information recognized in Step S105 (Step S106). Then, the interface device 100 projects the determined projected image 300 in the determined direction (Step S107).

An order of the respective operations described above in the interface device 100 is not limited the aforementioned order, and may be changed without causing a trouble. For example, the operations of aforementioned Steps S101 and S102 may not be performed in this order. For example, the interface device 100 may project the projected image 300 in a predetermined direction before detecting a position in which the operating object 400 is captured in the captured image.

——Description of Specific Examples of Interface——

Several specific examples of interfaces provided by the interface device 100 will be described hereafter. For ease of understanding, description of details of the operation performed by the control unit 120 is omitted as appropriate. For example, the operations of the control unit 120 and the projection unit 130 are simply expressed as the projection unit 130 projecting the projected image 300. Those operations is that the control unit 120 determines the projected image 300 and the projecting direction thereof and the projection unit 130 accordingly projects the projected image 300 in the determined projecting direction by the control operation of the control unit 120.

Further, the operations of the imaging unit 110 and the control unit 120 are simply expressed as the control unit 120 recognizing operation information. Those operations is that the imaging unit 110 captures an image, and the control unit 120 recognizes the operation information on the operating object 400 based on the relation between the captured position of the operating object 400 and the captured position of the projected image 300 in a captured image.

Additionally, the movements of the operating object 400 may be expressed as the operating object 400 operating a projected image 300. Those movements is that the operating object 400 is brought above the projected image 300 projected on the operation surface 200 by a user of the interface device 100, and the operating object 400 is moved above the projected image 300.

Furthermore, the function performed by the control unit 120 and the like, as a result of information being input to the interface device 100 by the operating object 400 operating a projected image 300, may be expressed as a function provided by the projected image 300.

Furthermore, for ease of understanding, the operation of the interface device 100 may be described below from a viewpoint of a user of the interface device 100. Further, even when the calibration processing is performed, a description related to the calibration processing may be omitted below.

### First Specific Example

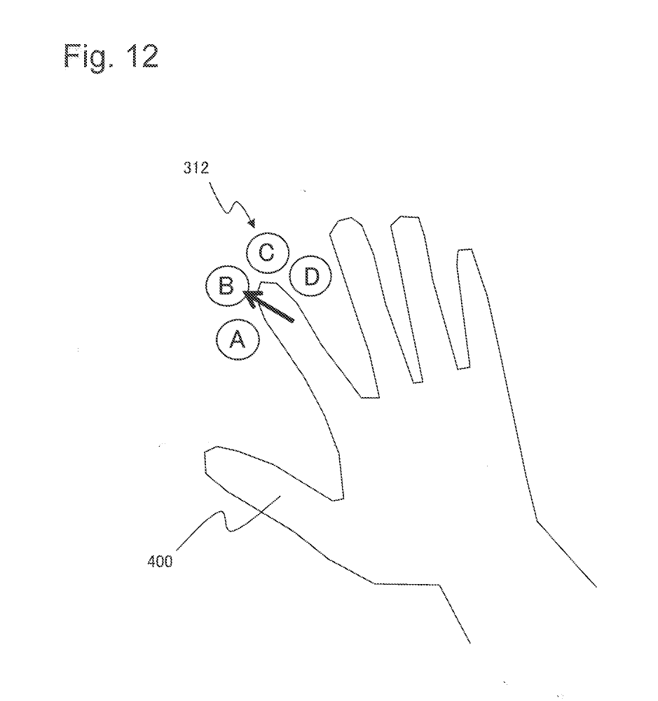

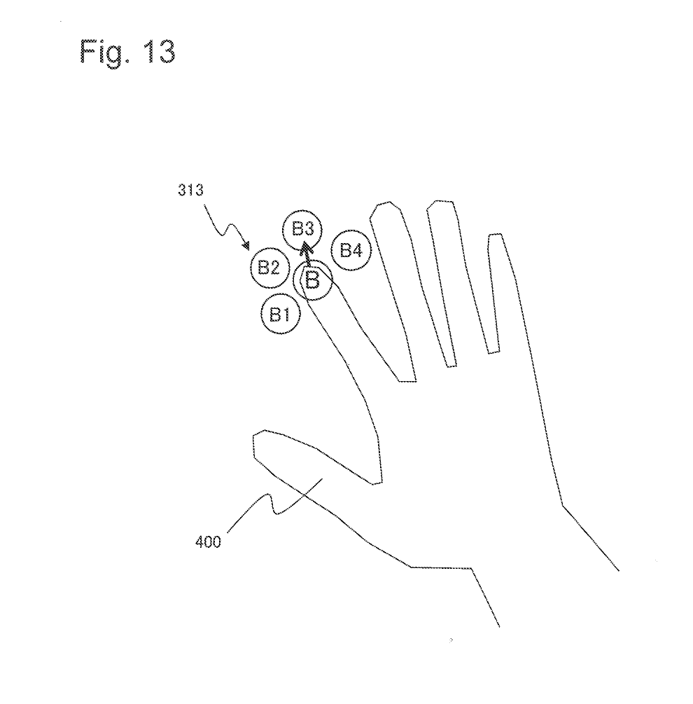

An interface according to a first specific example will be described with reference to FIGS. 12 and 13. When the operating object 400 (a fingertip in this case) is captured in the captured image provided by the imaging unit 110, the interface device 100 projects a projected image 312 onto a region peripheral to the operating object 400 (also including the operating object 400). The situation is illustrated in FIG. 12. As described above, the interface device 100 first projects the projected image 312 onto the region peripheral to the operating object 400. Then, the interface device 100 obtains (detects) the positional relation between the operation surface 200 and the imaging unit 110 (such as the interval between the imaging unit 110 and the operation surface 200, and the inclination of the operation surface 200 relative to the optical axis of the imaging unit 110) based on the captured position of the projected image 312 in the captured image. Then, by use of the detection result, the interface device 100 adjusts a projecting direction of the projected image 312 and the like, and, after the adjustment, re-projects the projected image 312 on the periphery of the operating object 400 (fingertip).

Subsequently, for example, when the control unit 120 detects that the operating object 400 moves in a direction toward an image of a character “B” in the projected image 312 of the captured image, the control unit 120 detects that the character “B” is selected. Then, the control unit 120 controls the projection unit 130 such that another projected image 313 as illustrated in FIG. 13 being related to the selected character “B,” is projected on the periphery of the operating object 400. From a viewpoint of a user, when the operating object 400 is moved to select the character “B,” the projected image 312 disappears and another projected image 313 is displayed on the periphery of the operating object 400. The projected image 313 is an image displaying options related to the selected character “B”, namely, characters “B1,” “B2,” “B3,” and “B4,” along with the character “B.” That is, the projected image 313 is an image displaying an option related to the option selected in the projected image 312. Thus, the interface device 100 is given, for example, information about a plurality of projected images differing from each other, including an image of an option, and information for controlling a display order of the projected images.

When the control unit 120 detects that the operating object 400 moves in a direction toward an image of a character “B3” in the projected image 313 of the captured image including the projected image 313, the control unit 120 accepts the character “B3” as an entry result (selection result [information]). Then, the control unit 120 controls the projection unit 130 such that the projected image 312 as illustrated in FIG. 12 is projected again on the region peripheral to the operating object 400. Thus, the control unit 120 recognizes operation information associated with the character “B3” being the entry result (selection result) as operation information based on the operating object 400.

Meanwhile, in a state that the projected image 313 illustrated in FIG. 13 is projected, there is a case, for example, that the operating object 400 moves in a direction departing from an image of a character. In this case, the control unit 120 regards that none of the options displayed in the projected image 313 is selected, does not recognize any operation information, and controls the projection unit 130 such that the projected image 312 is projected on the periphery of the operating object 400 again.

Thus, in the first specific example of the interface provided by the interface device 100, the control unit 120 first detects selection information based on the operating object 400 with respect to the first projected image 300 (projected image 312). Then, based on the selection information, the control unit 120 controls the projection unit 130 to project the second projected image 300 (projected image 313), in order to obtain next selection information. Subsequently, by detecting selection information on the operating object 400 with respect to the second projected image 300 (projected image 313), the control unit 120 recognizes operation information on the operating object 400.

Thus, by being configured to obtain the operation information in a multi-stage operation, the interface device 100 is able to limit a size of the projected image 300, even when there are a large number of options. The reason is that there is no need to display images of all options in the first projected image 300. When a size of the projected image 300 is large, inconveniences is occurred. The inconveniences are such that the projected image 300 does not fit in an angle of view of the imaging unit 110, the projected image 300 cannot be projected onto the small operation surface 200, and operability is degraded due to a need for the operating object 400 to be moved widely. By contrast, the interface in the first specific example is able to prevent occurrence of such inconveniences by successively displaying options in multiple stages.

### Second Specific Example

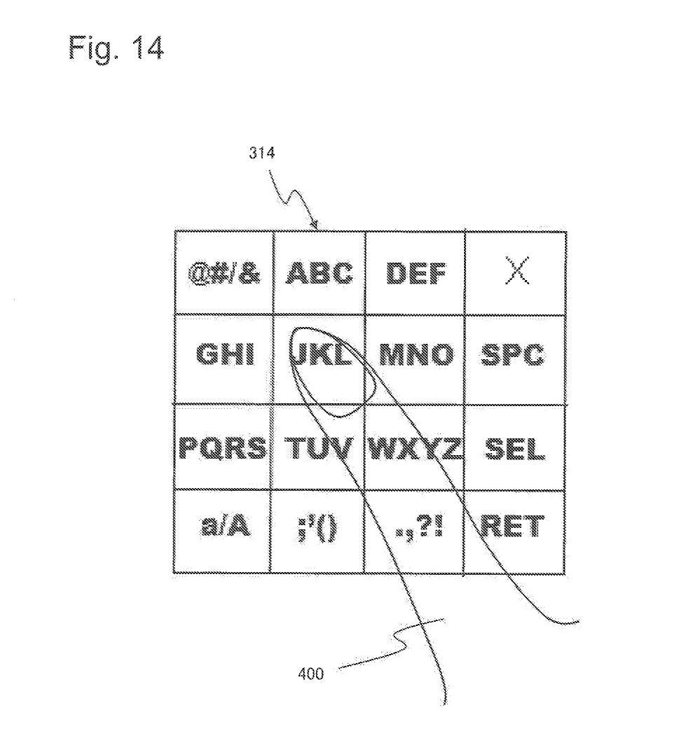

An interface according to a second specific example will be described with reference to FIGS. 14 to 16. A projected image 314 illustrated in FIG. 14 is an image displaying a plurality of key-shaped images similar to the projected image 305 illustrated in FIG. 5, and is an image providing a user with an interface related to character entry. In the second specific example, the projected image 314 is projected by the projection unit 130 as a main image.

The control unit 120 detects a positional relation between the captured position of the operation object (fingertip) 400 and the captured position of each key included in the projected image 314 in the captured image. For example, the control unit 120 detects the tip position of the operating object 400 in the captured image by image processing. Then, the control unit 120 recognizes an operation performed by the operating object 400 based on a following rule (criterion). The rule is, for example, such that “when a state that a key overlaps with a tip of the operating object 400 continues for a predetermined time or longer, the operating object 400 is regarded as selecting the key overlapping with the tip”. The rule to that effect is hereinafter also described as a first rule.

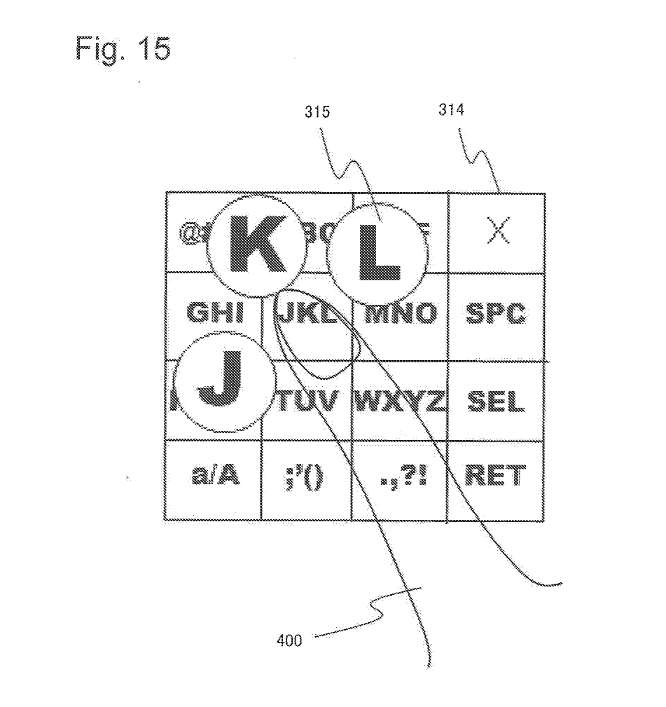

Assume that, as illustrated in FIG. 14, the control unit 120 recognizes that a key “JKL” is selected by the operating object 400 based on the tip of the operating object 400 overlapping with the key “JKL” in the projected image 314. Based on the recognition, the control unit 120 controls the projection unit 130. Consequently, the interface device 100 projects a projected image as illustrated in FIG. 15.

In the projected image illustrated in FIG. 15, an image 315 related to the selected key is superimposed on the projected image 314 being the main image. In the example in FIG. 15, the image 315 is an image unfolding to a user and displaying keys “J”, “K” and “L” being options related to the key “JKL” selected by the operating object 400.

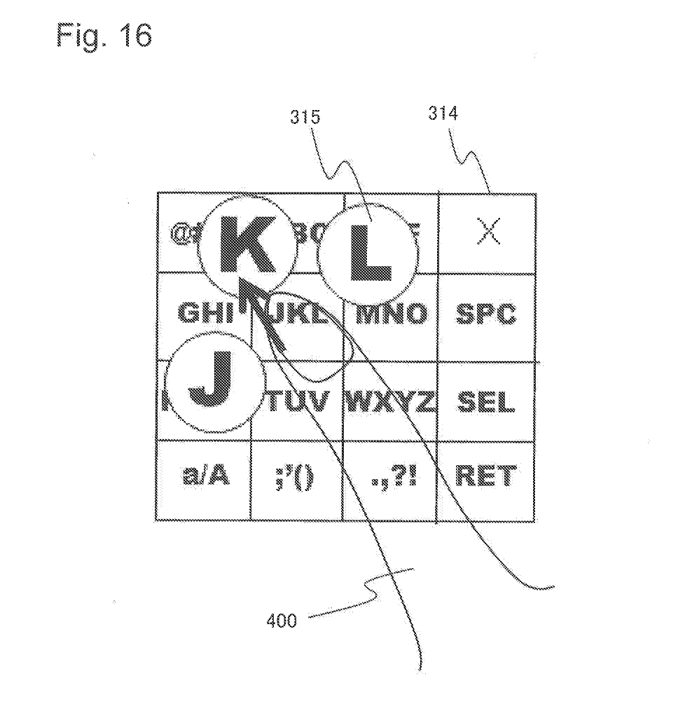

Then, as illustrated in FIG. 16, when the control unit 120 detects that the operating object 400 rapidly moves in a direction toward the key (option) “K”, the control unit 120 detects that a character “K” is selected, and, consequently, recognizes that entry of the character “K” is instructed.

Further, the control unit 120 may recognize an operation performed by the operating object 400 based on, for example, a following rule. The rule is such that, for example, “in a state that the projected image 315 is projected, when the operating object 400 moves toward one of keys being displayed as the projected image 315 at a speed (or acceleration) greater than or equal to a threshold value, and the operating object 400 stops at a position overlapping with the key, the operating object 400 is regarded as selecting the key”. The rule to that effect is hereinafter also described as a second rule. Further, as described above, when the speed (or acceleration) of the operating object 400 is used, the control unit 120 performs a function of calculating the speed (or acceleration) of the operating object 400, by use of, for example, tracking processing by image processing. Further, the interface device 100 is given, in advance, a large number of images successively displayed based on selection information on the operating object 400, and information related to an order of displaying the images.

Moreover, in a state that the projected image 315 as illustrated in FIG. 15 is projected, assume that, for example, the operating object 400 slowly moves to the position of the key “K” and stays at the position for a predetermined time or longer. When the control unit 120 detects the motion of the operating object 400, the control unit 120 may determine that a key “@#/&” being a key superposed on the key “K” is selected by the operating object 400 instead of the key “K.” In this case, the control unit 120 does not recognize that the character “K” is selected.

When detecting that the key “@#/&” is selected, similarly to the above, the control unit 120 controls the projection unit 130 such that an image, unfolding and displaying an option related to the key “@#/&” to a user, is projected in proximity to the key “@#/&” (on the periphery of the operating object 400).

Thus, in the second specific example, the interface device 100 recognizes operation information on the operating object 400 by detecting a motion (speed or acceleration) of the operating object 400 in addition to a positional relation between the captured position of the operating object 400 and the captured position of a projected image 300.

Further, in the second specific example, a rule (first rule) to determine an operation content of the operating object 400 with respect to the projected image 314 (first projected image) and a rule (second rule) to determine an operation content of the operating object 400 with respect to the projected image 315 (second projected image) differ from one another.

As described above, the interface device 100 in the second specific example recognizes operation information on the operating object 400 in consideration of not only the positional relation in a captured picture image but also a motion of the operating object 400. Therefore, in addition to the effect provided by the first specific example, the interface device 100 in the second specific example additionally provides an effect of reducing erroneous entries. The reason will be described below.

For example, in a state that the projected image 314 as illustrated in FIG. 14 is projected, it is assumed that the operating object 400 may continue moving for a while on the projected image 314. In such a case, assume that the operating object 400 arrives, for example, above the key “JKL.” In this case, it is difficult for the control unit 120 to precisely determine whether the operating object 400 selects the key “JKL” or is merely passing over the key “JKL,” by simply using the positional relation in a captured picture image.

Assume that the interface device 100 (control unit 120) determines that the operating object 400 selects the key “JKL”, although the object is merely passing over the key “JKL”. In this case, a state that the interface device 100 erroneously enters a character arises, and a user is required to perform an operation such as deleting the erroneously entered character. In other words, the interface device 100 may give a discomfort feeling to a user due to operational complicatedness.

By contrast, in the second specific example, as described above, even when the interface device 100 erroneously determines that the operating object 400 selects the key “JKL”, the image (projected image 315) representing the option related to the key to a user is merely unfolded. In this case, the user is able to reselect another key in the projected image 314 simply by moving the operating object 400 slowly toward another key. Then, the user is able to enter a desired character by moving the operating object 400 rapidly toward a desired key in the projected image 315 displayed by the interface device 100 as desired.

In terms of a number of options displayed in conjunction with the projected image 315 in the example illustrated in FIG. 15, a number of options (keys) included in the projected image 315 superimposed on the projected image 314 is less than a number of options (keys) included in the projected image 314. Consequently, the control unit 120 is able to detect an action of “the operating object 400 rapidly moving to a key” practically without error.

There are various methods of the control unit 120 detecting that a state (key selection state) when a captured position of a key overlaps with a captured position of a tip of an operating object 400 in a captured image continues for a predetermined time or longer, and an appropriately selected technique is employed.

Describing a specific example, for example, the control unit 120 detects that a state that a captured position of a tip of the operating object 400 in a captured image does not change for a predetermined number of frames or more (herein a positive integer, N). Next, triggered by the detection, the control unit 120 analyzes the captured image (that is, the captured image as a still image) of a next frame (an [N+1]-th frame from halt of change in the captured position of the tip of the operating object 400). Consequently, the control unit 120 detects the positional relation between the captured position of the key and the captured position of the tip of the operating object 400 in the captured image, and, according to the detected positional relation, detects the aforementioned key selection state. Alternatively, the control unit 120 may analyze the captured image being a dynamic image by use of a known dynamic image recognition processing technology, and accordingly detect that a state (key selection state) that the key overlaps with the tip of the operating object 400 continues for a predetermined time or longer. A technique (operation) by which the control unit 120 detects the key selection state is not limited to such the specific example.

Further, there are various techniques of the control unit 120 detecting that an operating object 400 moves toward a key at a speed greater than or equal to a threshold value in a captured image, and an appropriately selected technique out of the techniques is employed.

Describing a specific example, for example, the control unit 120 analyzes the captured image (that is, the captured image as a still image) for each frame and detects a moving speed of an operating object 400 by tracking the captured position of the operating object 400 in the captured image in each frame. Further, the control unit 120 detects a moving direction of the operating object 400 and the captured position of each key included in the projected image 315. Next, the control unit 120 detects that the operating object 400 moves toward a key at a speed greater than or equal to a threshold value based on the comparison result between the detected moving speed and the threshold value, the moving direction of the operating object 400, and the captured position of the key. Alternatively, the control unit 120 detects the moving speed of the operating object 400 by analyzing the captured image being dynamic image by the known dynamic image recognize processing technology. Then, similarly to the above, the control unit 120 may detect that the operating object 400 moves toward a key at a speed greater than or equal to a threshold value by use of the detected moving speed. A technique (operation) by which the control unit 120 detects the movement of the operating object 400 is not limited to the specific example.

### Variation of Second Specific Example

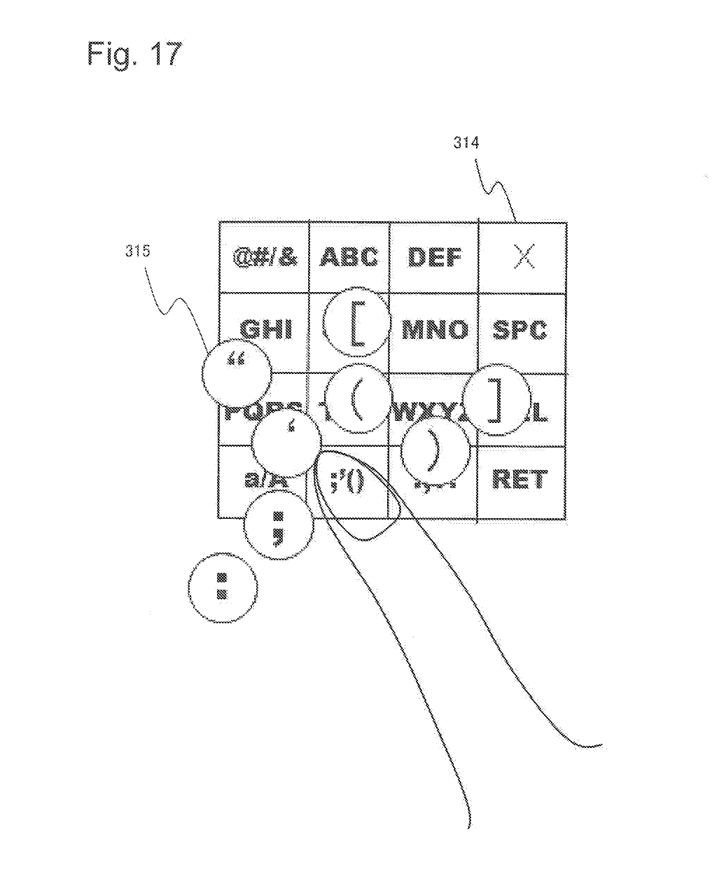

FIG. 17 is a diagram illustrating an example of a projected image 315 projected when the operating object 400 selects a key “;′( )” in the projected image 314. The interface device 100 is configured to project information (image) instead of displaying information (image) on a screen of a display device, and is moderately restricted in terms of a size of a projected image. Therefore, the interface device 100 is readily able to display the projected image 315 extending off the projected image 314 as illustrated in FIG. 17.

### Third Specific Example

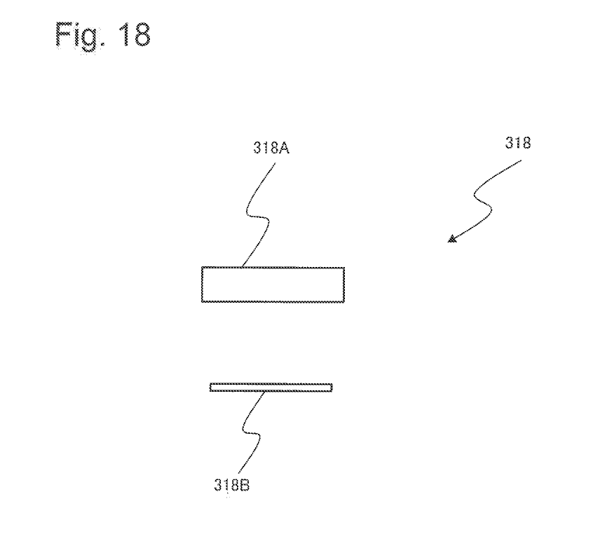

An interface in a third specific example will be described with reference to FIGS. 18 to 22. The interface in the third specific example is an interface accepting number entry. A user enters a number to the interface device 100 by repeating a first operation of displaying a number being a selection candidate, out of numbers from 0 to 9, and a second operation of selecting one of the numbers displayed by the first operation.

FIG. 18 is a diagram illustrating an example of a projected image 318 provided by the projection unit 130. The projected image 318 includes a region 318A displaying a number determined to be entered (hereinafter described as a determination region 318A), and a region 318B used for recognizing an operation by the operating object 400 (hereinafter described as an operation region 318B).

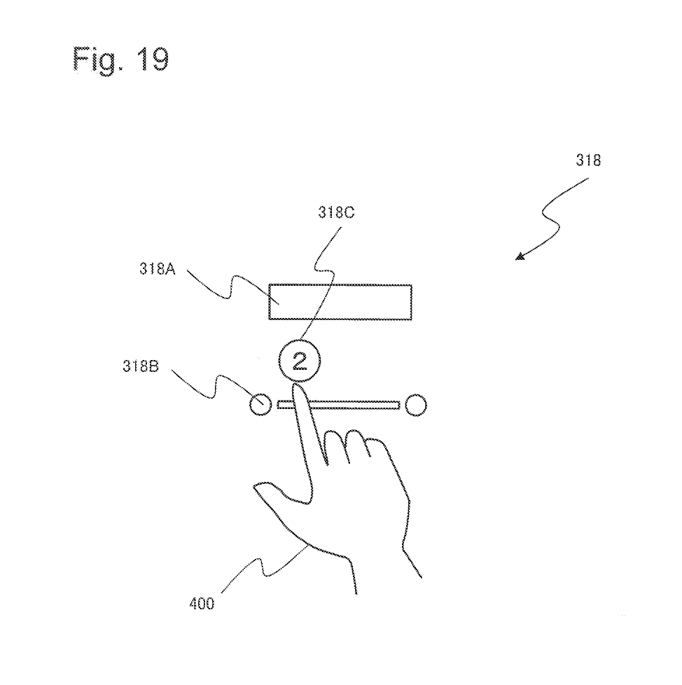

In the example in FIG. 18, the operation region 318B is a linear- or bar- (belt-) shaped image. The operation region 318B defines a moving range of the operating object 400. Specifically, a user operates the interface device 100 by moving the operating object 400 along the operation region 318B. The operation region 318B is not limited to the shape illustrated in FIG. 18. For example, as illustrated in FIG. 19, the operation region 318B may be an image including a line or a bar indicating a moving range of the operating object 400, and circles arranged to have an interval to the respective ends of the line or the bar.

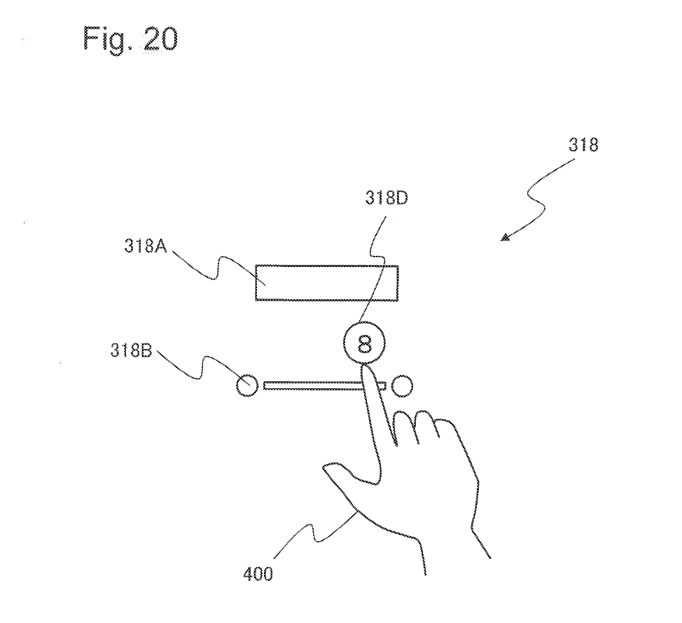

The first operation (an operation of displaying a selection candidate number out of numbers from 0 to 9) using of the projected image 318 by the operating object 400 will be described with reference to FIGS. 19 and 20. A user selects a desired number out of numbers from 0 to 9 by moving (sliding) the operating object 400 along the operation region 318B. For example, the left end of the line (bar) in the operation region 318B corresponds to 0, a corresponding number becomes greater from the left side toward the right side of the line (bar), and the right end of the line (bar) corresponds to 9.

FIGS. 19 and 20 illustrate a situation that a selection candidate number changes successively in response to the operating object 400 sliding from the left side to the right side of the operation region 318B. For example, in FIG. 19, the operating object 400 is positioned on the left side of the operation region 318B. The control unit 120 obtains the positional relation between the captured position of the operation region 318B and the captured position of the operating object 400 in the captured image, and determines that the operating object 400 is at a position corresponding to a number “2” based on the obtained positional relation. Then, the control unit 120 controls the projection unit 130 such that the projection unit 130 projects an image 318C indicating the number “2” in proximity to the operating object 400. At this time, the number “2” is displayed merely as a selection candidate, and is not yet selected.

Then, as illustrated in FIG. 20, assume that the operating object 400 further slides rightward along the operation region 318B. In this case, similarly to the above, the control unit 120 obtains the positional relation between the captured position of the operation region 318B and the captured position of the operating object 400 in the captured image, and determines that the operating object 400 is at a position corresponding to a number “8” based on the obtained positional relation. Then, the control unit 120 controls the projection unit 130 such that the projection unit 130 projects an image 318D indicating the number “8” in proximity to the operating object 400. At this time, the number “8” is displayed merely as a selection candidate, and is not yet selected.

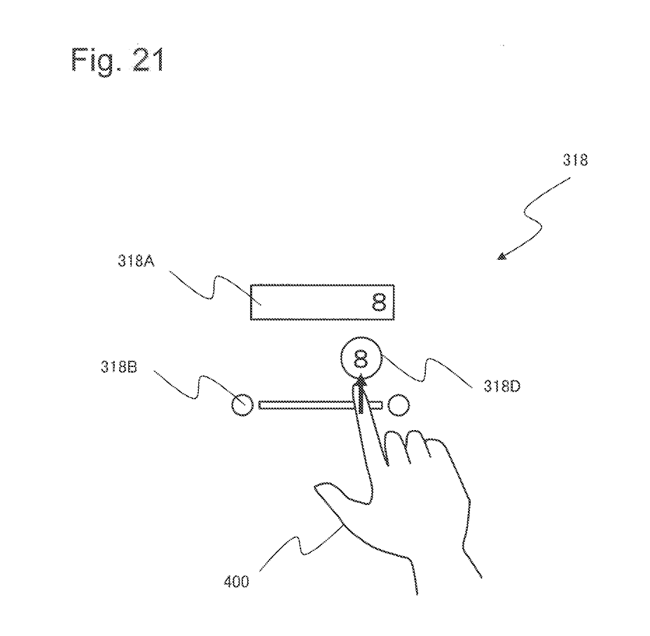

Next, a second operation (an operation of selecting one of the numbers displayed by the first operation) by the operating object 400 will be described with reference to FIGS. 21 to 23. FIG. 21 is a diagram illustrating an example of an operation of number selection by the operating object 400. As illustrated in FIG. 21, in a state that a number “8” is projected, the user slides the operating object 400 toward the number “8.” When detecting the operation (motion) of the operating object 400 by use of a result of image processing performed on the captured image provided by the imaging unit 110, the interface device 100 (control unit 120) determines that the number “8” is selected. Then, the interface device 100 (control unit 120) controls the projection unit 130, and projects the number “8” on the determination region 318A by the projection unit 130. Entry of the number “8” to the interface device 100 may be determined at this time, or a step of collectively determining entry to the interface device 100 after the user determining a number with a desired number of digits, may be separately prepared.

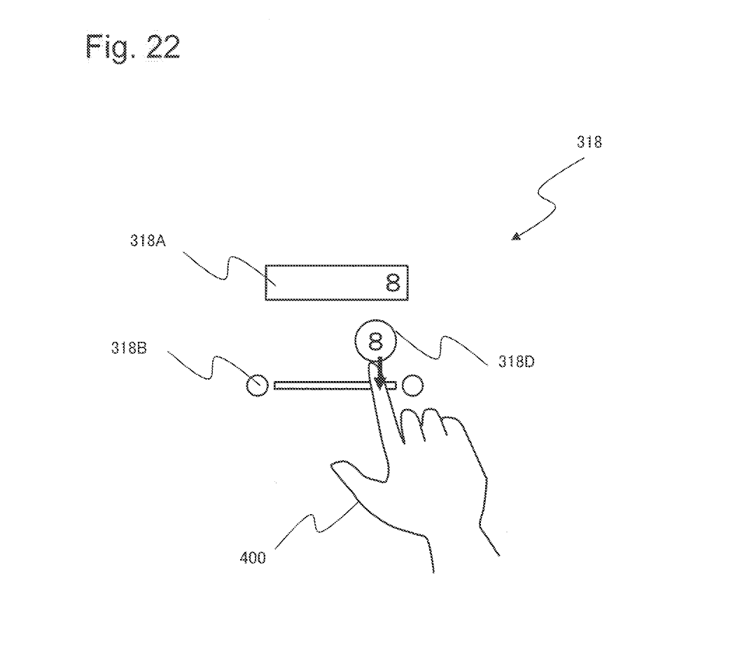

FIG. 22 is a diagram illustrating another example of an operation of number selection by the operating object 400. In the example illustrated in FIG. 22, in a state that the number “8” is projected, the user slides the operating object 400 in a direction from the number “8” toward the operation region 318B. Similarly to the above, when detecting the motion, the interface device 100 (control unit 120) determines that the number “8” is selected. Then, the interface device 100 (control unit 120) controls the projection unit 130, and projects the number “8” on the determination region 318A by the projection unit 130.

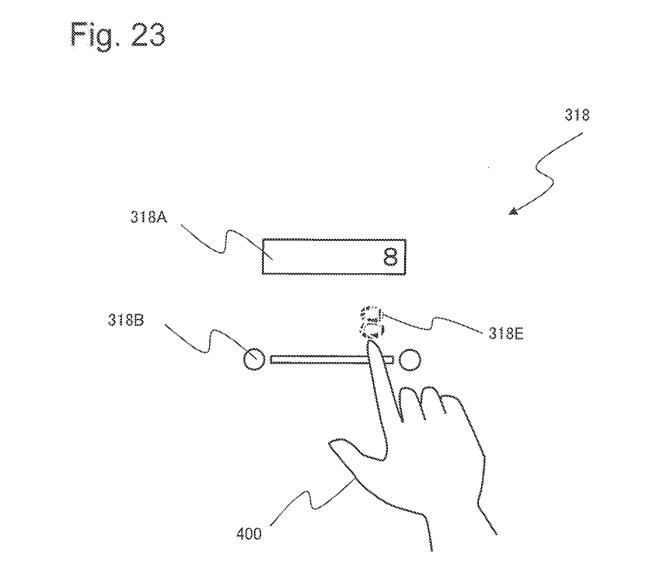

Alternatively, another specific example of an operation of number selection by the operating object 400 is, for example, the user keeps the operating object 400 at a position corresponding to a selected number for a predetermined time (such as 1.5 seconds) or longer. Similarly to the above, when detecting the motion, the interface device 100 (control unit 120) determines that the number “8” is selected. Then, the interface device 100 (control unit 120) controls the projection unit 130 to project, for example, an animation as illustrated in FIG. 23: the number “8” expands, explodes, and then disappears, and to subsequently project the number “8” on the determination region 318A. By using such a display, the user is able to clearly recognize that the number “8” is selected.

In addition to the effect provided by the interface in the first specific example, the interface in the third specific example described by use of FIGS. 18 to 23 is further able to provide an effect of reducing erroneous entries. The reason will be described below.

In the third specific example, the interface device 100 recognizes that a selection candidate is selected out of a plurality of options based on the positional relation between the captured position of the operating object 400 and the captured position of the operation region (first projected image) 318B in the captured image. Then, the interface device 100 (control unit 120) controls the projection unit 130 to project an image (second projected image) 318C or 318D relating to a selection candidate option in proximity to the operating object 400. In a state that the image of the selection candidate (second projected image) 318C or 318D is projected, when detecting that the operating object 400 performs the predetermined operation of selecting the selection candidate, the interface device 100 recognizes that the selection candidate is selected.

Specifically, in the third specific example, when the operating object 400 performs the operation of determining selection of the selection candidate selected out of the plurality of options, the option other than the selection candidate is not displayed (projected). Therefore, the interface device 100 applying the third specific example is able to prevent erroneous entry that a number other than a number to be selected is erroneously selected.

### Fourth Specific Example

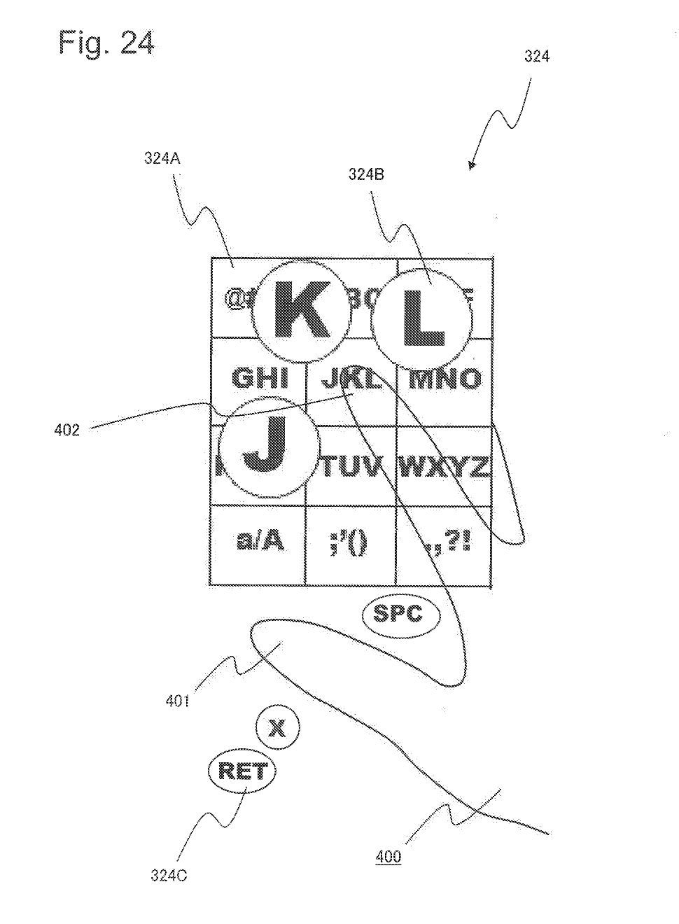

An interface in a fourth specific example will be described with reference to FIG. 24.

The control unit 120 in the interface device 100 in the fourth specific example is provided with an image processing engine, detecting a shape of a hand (operating object 400) and detecting a shape and an action of each finger.

FIG. 24 is a diagram illustrating a situation that a projected image 324 is projected in proximity to the operation object (right hand) 400. The projected image 324 illustrated in FIG. 24 includes regions 324A, 324B, and 324C. The region 324A is an image having a similar function to the projected image 314 illustrated in FIG. 15. However, unlike the projected image 314, keys related to operations, such as “SPC (space),” “x (delete),” and “RET (return),” are omitted in the region 324A illustrated in FIG. 24. The region 324B is an image having a similar function to the projected image 315 illustrated in FIG. 15. The region 324C is an image displaying a key related to an operation such as “SPC (space),” “x (delete),” or “RET (return).”

The control unit 120 distinctively detects a thumb 401 and a forefinger 402 of the operating object 400 in the captured image respectively by use of the aforementioned image processing engine. Then, the control unit 120 controls the projection unit 130 such that, as illustrated in FIG. 24, the regions 324A and 324B are projected in proximity to the forefinger 402, and the region 342C is projected in proximity to the thumb 401.

The control unit 120 recognizes operation information on the operating object 400 based on the positional relation between the captured position of the projected image 300 and the captured position of the thumb 401 or the forefinger 402 in the captured image.

In addition to the effect provided by the interface device 100 in the first specific example, the interface device 100 applying the fourth specific example described using FIG. 24 further provides an effect of enabling rapid entry. The reason is that the control unit 120 respectively detects the position and the motion of the thumb 401 and the position and the motion of the forefinger 402, and recognizes operation information on the operating object 400 based on the detected information.

### Fifth Specific Example

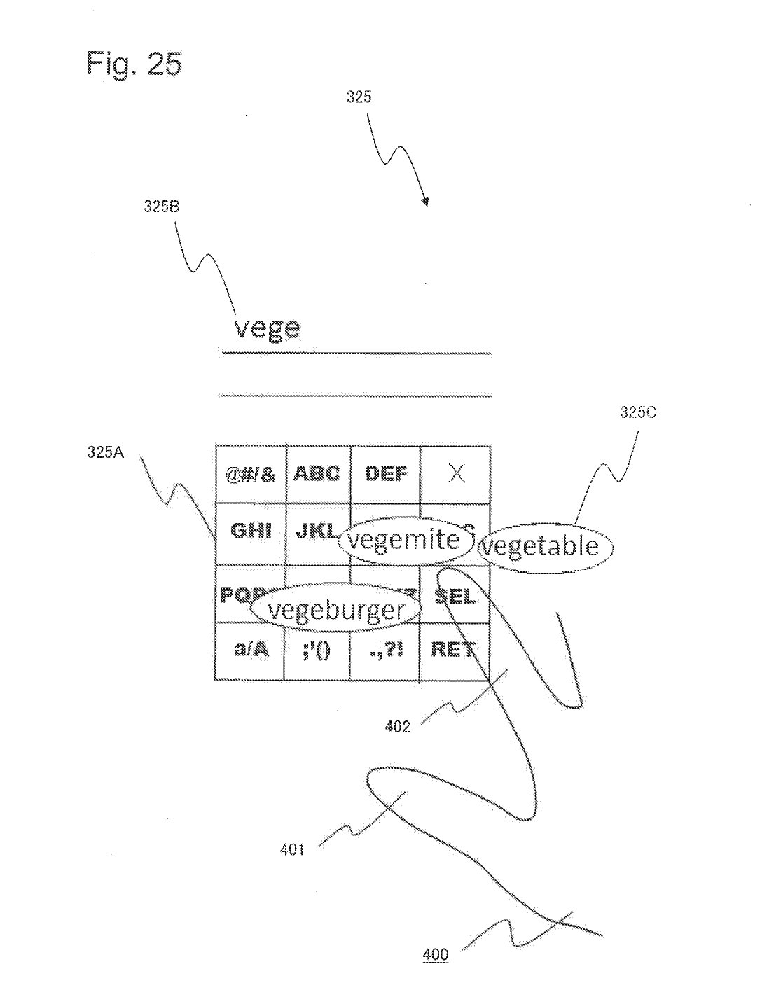

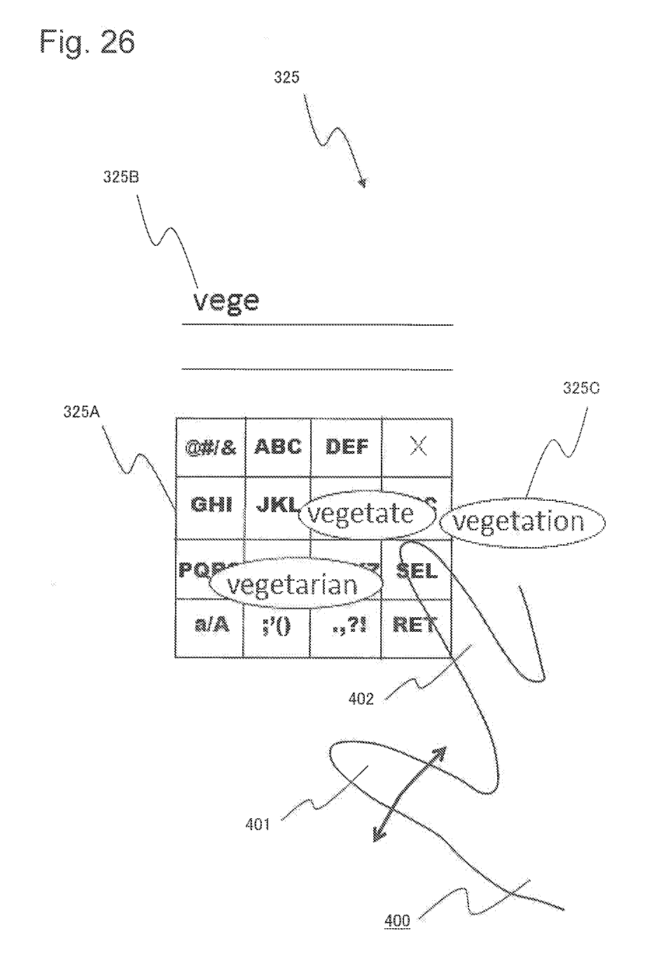

An interface in a fifth specific example will be described with reference to FIGS. 25 and 26. The interface in the fifth specific example is an interface accepting word entry. A projected image 325 illustrated in FIG. 25 includes regions 325A, 325B, and 325C. The region 325A is a region having a similar function to the projected image 314 in the second specific example. The region 325B is a region displaying a character entered by use of the region 325A. In the example in FIG. 25, a character string “vege” is displayed in the region 325B.

The region 325C is a region in which an image providing a so-called predictive input function is projected. Specifically, in the example in FIG. 25, when the operating object 400 selects a key “SEL (select)” in a state that the character string “vege” is displayed in the region 325B, a word candidate (entry prediction candidate) image 325C is projected in proximity to the forefinger 402. In the example in FIG. 25, word candidates starting with “vege”, namely, “vegeburger”, “vegemite” and “vegetable” are displayed (“vegemite” is a registered trademark). For example, when the control unit 120 detects that “vegetable” is pointed by the forefinger 402 in this state, as described above, the interface device 100 recognizes that the word “vegetable” is entered. When positions and motions of the thumb 401 and the forefinger 402 of the operating object 400 are distinctively detected, the control unit 120 is given an image processing engine similar to the fourth specific example.

Meanwhile, a word “vegetarian” is not displayed as an entry prediction candidate in the projected image 325C in FIG. 25. Therefore, when a user has a desire to enter, for example, the word “vegetarian,” the user is not able to enter the word with the state of the projected image 325C in FIG. 25. Accordingly, the interface device 100 in the fifth specific example is configured to be able to change a word candidate displayed (projected) in the projected image 325C by the user moving the thumb 401.

Details will be described by use of FIG. 26. When detecting movement of the thumb 401 based on the captured image provided by the imaging unit 110, the control unit 120 causes the projection unit 130 to project a projected image 325C representing other word candidates starting with “vege” as illustrated in FIG. 26. Consequently, it appears to the user that the word candidates change from the candidates illustrated in FIG. 25 to the candidates illustrated in FIG. 26. The user enters the word “vegetarian” to the interface device 100 by pointing “vegetarian” with the forefinger 402.

Thus, the control unit 120 does not necessarily recognize operation information on the operating object 400 based on the positional relation between the captured position of the image included in the projected image 300 and the captured position of the operating object 400 in the captured image. In other words, as described in the fifth specific example, regardless of the positional relation, when detecting the motion of the thumb 401, the control unit 120 recognizes operation information on the operating object 400, and accordingly switches the projected image 325C.

The character entry interface in the aforementioned fifth specific example is applicable to, for example, functions such as a kanji conversion function in Japanese input.

### Sixth Specific Example

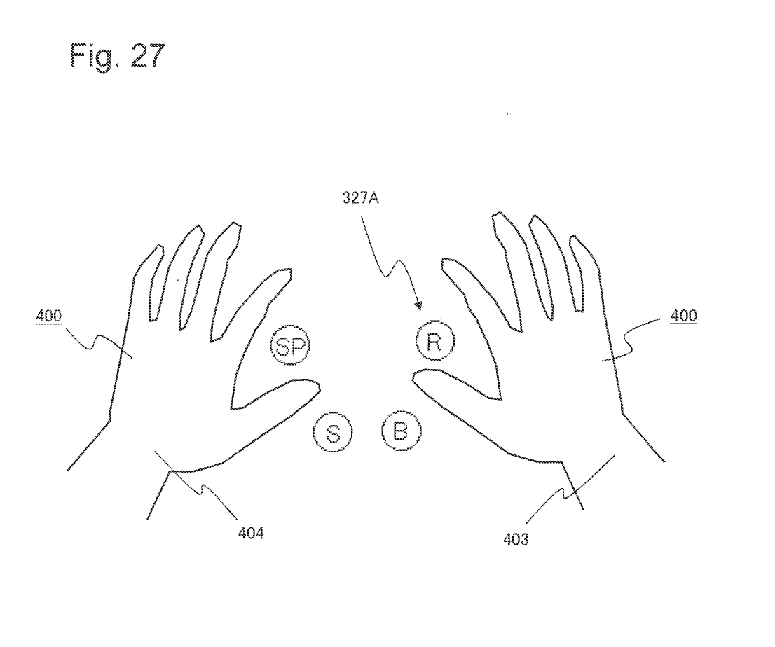

An interface in a sixth specific example will be described with reference to FIGS. 27 to 30. The interface in the sixth specific example is an interface providing a full-keyboard function. The control unit 120 in the interface device 100 providing the sixth specific example has a function of detecting a plurality of fingers in the captured image, and also detecting motions thereof.

In the sixth specific example, the control unit 120 detects positions of a right hand 403 and a left hand 404 of the operating object 400 in the captured image. Then, the control unit 120 controls the projection unit 130 such that a projected image 327A is projected in proximity to the right hand 403 and the left hand 404. The projected image 327A includes keys “SP (space)”, “S (shift)”, “R (return)” and “B (backspace)”. The projected image 327A does not include alphabet keys configuring a full keyboard.

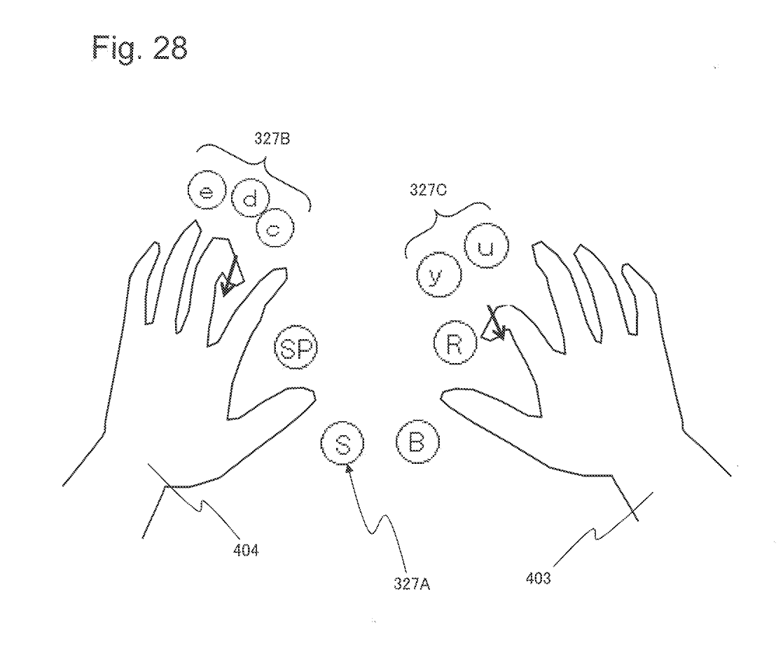

In a state illustrated in FIG. 27, when detecting that the tip side of the middle finger of the left hand 404 moves toward the palm side as illustrated in FIG. 28 based on the captured image, the control unit 120 controls the projection unit 130 such that a projected image 327B is projected in proximity to the middle finger of the left hand 404. The projected image 327B illustrated in FIG. 28 includes keys “e”, “d” and “c”. The three keys are keys assigned to the middle finger of the left hand 404 on a common full keyboard.

In a state that the projected image 327B is thus projected, when detecting that the middle finger of the left hand 404 moves toward any key based on the captured image, the control unit 120 recognizes a character corresponding to the key toward which the middle finger moves as a character being an entry target. Further, when detecting that the tip side of the middle finger of the left hand 404 further moves toward the palm side, or the tip side of another finger moves toward the palm side based on the captured image, the control unit 120 stops displaying the projected image 327B.

On a common full keyboard, a total of six keys, namely, keys “y”, “h”, “n”, “u”, “j” and “m” are assigned to the forefinger of the right hand. When detecting that the tip side of the forefinger of the right hand 403 moves toward the palm side based on the captured image, the control unit 120 controls the projection unit 130 such that a projected image 327C as illustrated in FIG. 28 is projected in proximity to the forefinger of the right hand 403. The projected image 327C includes, for example, keys “y” and “u”.

For example, when detecting that the forefinger of the right hand 403 moves toward a key “y” based on the captured image, the control unit 120 controls the projection unit 130 such that an image of keys associated with the key “y” is projected in proximity to the forefinger of the right hand 403. The keys associated with the key “y” include, for example, keys “h” and “n” and an image of the keys is projected along with an image of the key “y” as described above.

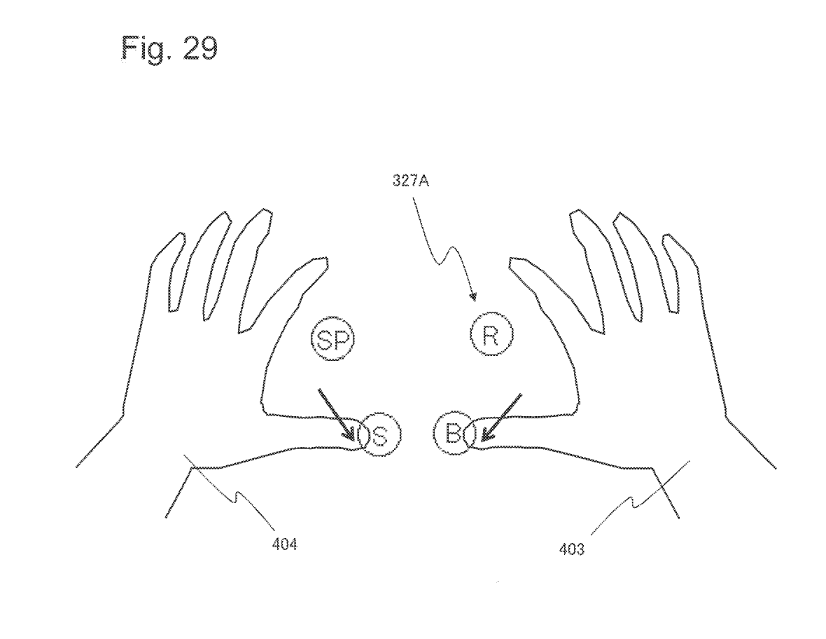

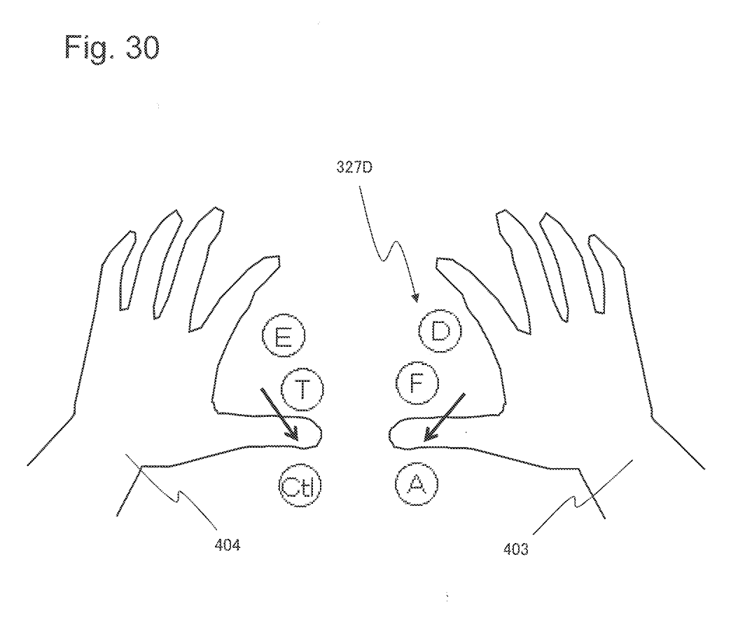

Next, a function related to the other operation of keys included in a full keyboard in the sixth specific example will be described. When detecting that the thumbs of the right hand 403 and the left hand 404 simultaneously move in a direction toward a body of a user as illustrated in FIG. 29, the control unit 120 controls the projection unit 130 such that a projected image 327D as illustrated in FIG. 30 is projected in proximity to the thumbs of the both hands. The projected image 327D includes an escape key (E), a tab key (T), a control key (Ctl), an alt key (A), a function key (F), and a delete key (D).

When detecting that a thus projected key is selected, the control unit 120 recognizes operation information on the operating object 400 based on the selected key and performs an operation (function) based on the operation information.

The specific example described by use of FIGS. 27 to 30 is merely an example. The interface device 100 is capable of displaying various options based on respective motions of a plurality of fingers, similarly to the above.

### Seventh Specific Example

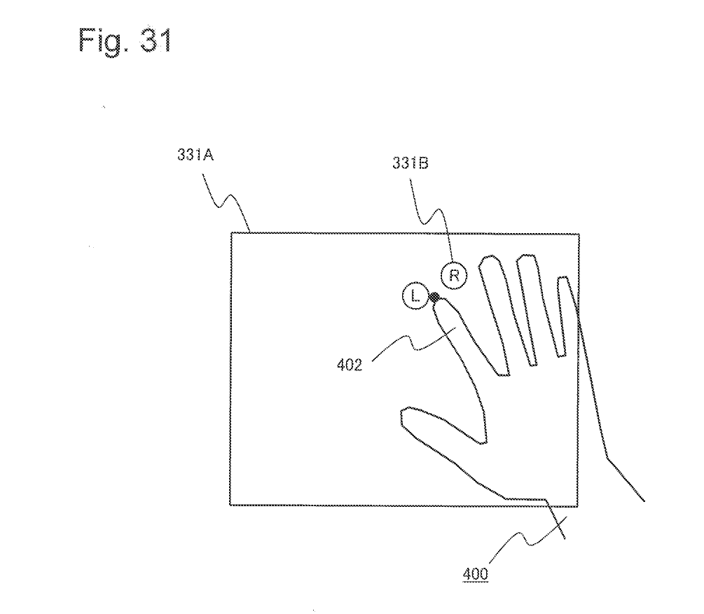

An interface in a seventh specific example provided by the interface device 100 will be described with reference to FIGS. 31 to 34. The interface in the seventh specific example is an interface providing a function equivalent to a mouse (a kind of input device [auxiliary input device] inputting information to a computer).

The projection unit 130 first projects a projected image 331A as illustrated in FIG. 31 onto the operation surface 200 through control of the control unit 120. The projected image 331A is, for example, a rectangular frame-shaped image. When detecting that the operating object (hand) 400 is placed on the projected image 331A based on the captured image, the control unit 120 detects the captured position of the entire operating object 400 and the captured position of the forefinger 402 in the captured image. The control unit 120 controls the projection unit 130 such that a projected image 331B as illustrated in FIG. 31 is projected in proximity to the forefinger 402.

The projected image 331B includes an “L button” and an “R button”. The “L button” in the projected image 331B provides a function equivalent to an L button of a common mouse. The “R button” in the projected image 331B provides a function equivalent to an R button of a common mouse.

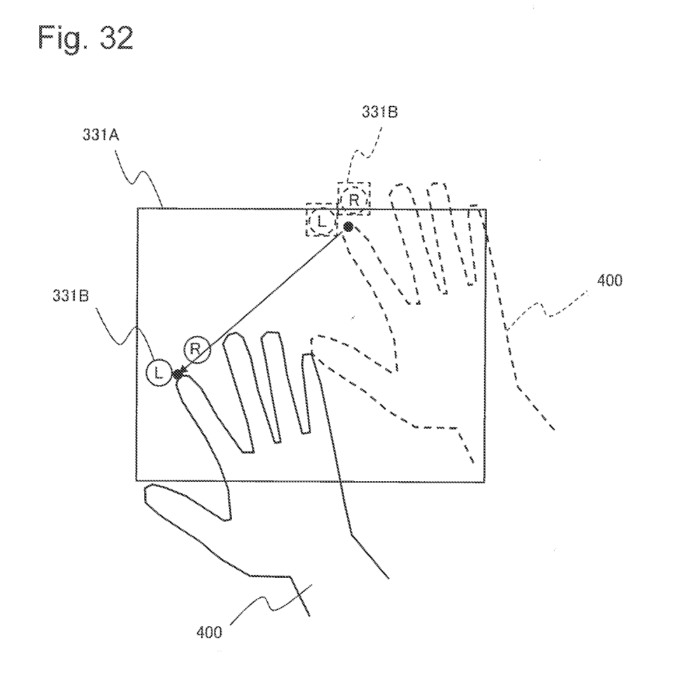

Assume that a user moves the position of the operating object 400 from the position illustrated in FIG. 31 to a position illustrated in FIG. 32. When detecting such a motion by the operating object 400 based on the captured image, the control unit 120 recognizes the change in position information of the operating object 400 as operation information. Consequently, the interface according to the seventh specific example provides a function similar to a position-information-input function included in a mouse and the like. When the operating object 400 moves as illustrated in FIG. 32, the control unit 120 detects the motion of the operating object 400 based on the captured image, and accordingly controls the projection unit 130 such that a projected position of the projected image 331B follows the motion of the operating object 400.

When detecting that, for example, the forefinger of the operating object 400 moves in a direction toward the “L button” in the projected image 331B based on the captured image, the control unit 120 performs a function similar to a function corresponding to a left-click operation of a mouse. Similarly, when detecting that, for example, the forefinger of the operating object 400 moves in a direction toward the “R button” in the projected image 331B based on the captured image, the control unit 120 performs a function similar to a function corresponding to a right-click operation of a mouse. By detecting a motion of a finger, similarly to the above, the control unit 120 may perform, for example, a function similar to a function corresponding to double-click and a drag operation of a mouse.

In consideration of a user of the interface device 100 being left-handed, the control unit 120 may have a function of controlling the projection unit 130 such that the “L button” and the “R button” in the projected image 331B are projected with the right and left sides reversed from the state illustrated in FIGS. 31 and 32. Further, the control unit 120 may have a function of controlling the projection unit 130 such that the “L button” is projected on either region of a region in proximity to the user's thumb and a region in proximity to the user's middle finger, and the “R button” is projected on the other region.

### Variation 1 of Seventh Specific Example

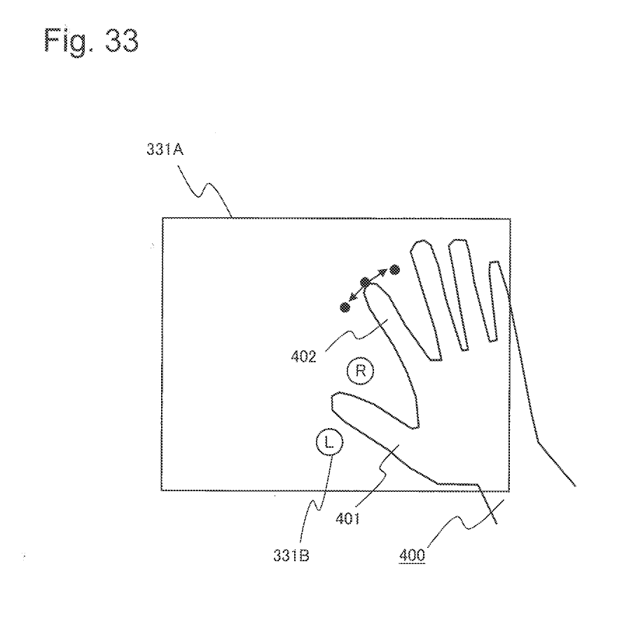

FIG. 33 is a diagram illustrating an application example 1 (variation 1) of the seventh specific example. In the example, the control unit 120 performs a function similar to a function corresponding to an operation equivalent to a left click or a right click of a mouse based on the positional relation between a captured position (or the motion) of a thumb 401 and the captured position of the projected image 331B. Further, the control unit 120 detects a motion of the forefinger 402, and recognizes position information specifying, for example, a set position of a cursor based on the motion of the forefinger 402. In the example, the control unit 120 recognizes position information by the motion of the forefinger 402, but does not recognize selection information of options. Consequently, even when the operating object (hand) 400 rapidly moves and thus the forefinger 402 simply passes over the position of the “R button” or the “L button” in the projected image 331B, the control unit 120 can prevent false recognition that the “R button” or the “L button” is selected.

### Variation 2 of Seventh Specific Example

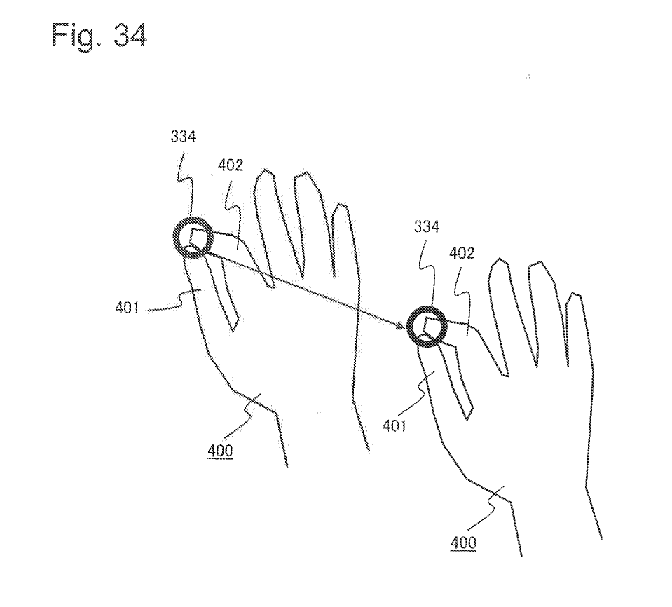

FIG. 34 is a diagram illustrating an application example 2 (variation 2) of the seventh specific example. In the example, meaning is attached to a shape formed by a plurality of fingers. Specifically, the control unit 120 detects a shape of the operating object 400 in the captured image, and recognizes operation information represented in the detected operating object 400. For example, when a shape of the operating object (hand) 400 is a shape of the thumb 401 attached to the forefinger 402, the control unit 120 recognizes a start of a drag operation. The drag operation is one of operations using a mouse being a kind of input device, and is an operation of, for example, inputting a computer information such as specifying a range by moving the mouse while holding down a mouse button.

As illustrated in FIG. 34, when recognizing a start of a drag operation based on the shape of the operating object 400, the control unit 120 controls the projection unit 130 such that a projected image 334 is projected in proximity to the thumb 401 and the forefinger 402. The projected image 334 is an image displaying to a user that the start of the drag operation is recognized.

In a state that the projected image 334 is projected, when detecting that the operating object 400 moves based on the captured image, the control unit 120 recognizes information on a drag operation (such as information of a specified range). An arrow illustrated in FIG. 34 is a trajectory of the drag operation. Control related to such a drag operation may be combined with control techniques in the aforementioned various specific examples.

——Description of Hardware Configuration——

—Hardware Configuration Example of Control Unit 120—

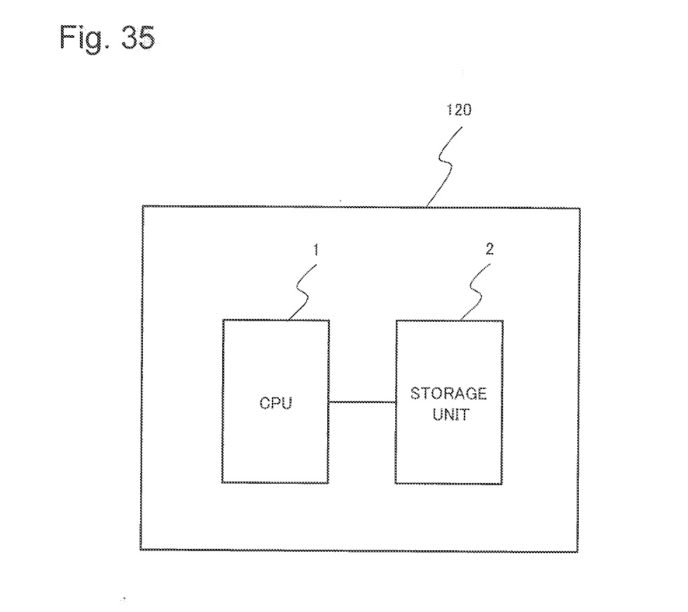

FIG. 35 is a block diagram illustrating an example of a hardware configuration capable of providing the control unit 120.

Hardware constituting the control unit 120 (computer) includes a central processing unit (CPU) 1 and a storage unit 2. The control unit 120 may include an input device (not illustrated) and an output device (not illustrated). Various functions of the control unit 120 are provided by, for example, the CPU 1 executing a computer program (a software program, hereinafter simply described as a “program”) read from the storage unit 2.

The control unit 120 may include a communication interface (I/F) not illustrated. The control unit 120 may access an external device through the communication I/F, and determine an image to be projected based on information acquired from the external device.

The present invention described with the first exemplary embodiment and respective exemplary embodiments described later as examples is also configured with a non-transitory storage medium such as a compact disk storing such a program. The control unit 120 may be a control unit dedicated to the interface device 100, or, part of a control unit included in a device including the interface device 100 may function as the control unit 120. A hardware configuration of the control unit 120 is not limited to the aforementioned configuration.

—Hardware Configuration Example of Projection Unit 130—

Next, an example of a hardware configuration of the projection unit 130 will be described. The projection unit 130 has only to have a function of projecting a projected image 300 by control from the control unit 120.

An example of a hardware configuration providing the projection unit 130 capable of contributing to miniaturization and power saving of the interface device 100, will be described below. The example described below is strictly a specific example of the projection unit 130 and does not limit the hardware configuration of the projection unit 130.

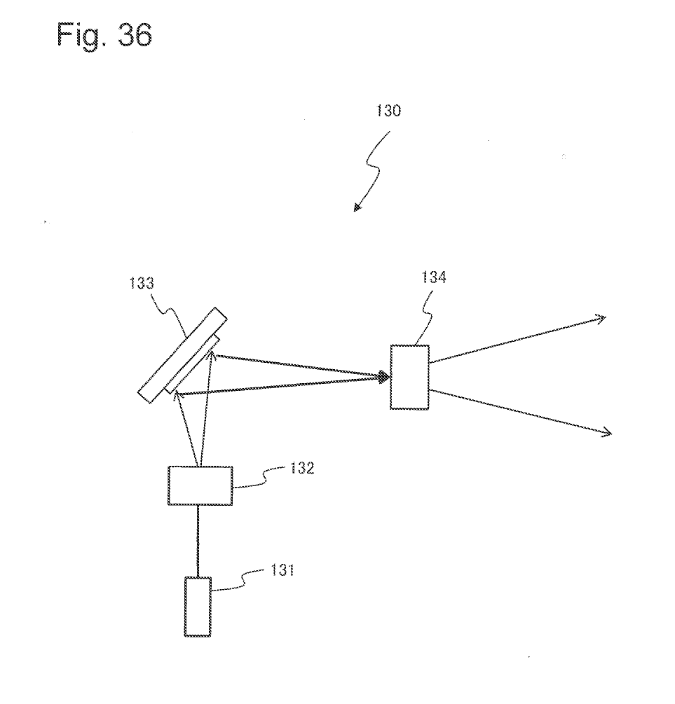

FIG. 36 is a diagram illustrating a specific example of a hardware configuration capable of providing the projection unit 130. In the example in FIG. 36, the projection unit 130 includes a laser light source 131, a first optical system 132, an element 133, and a second optical system 134.

Laser light emitted from the laser light source 131 is shaped to a mode suitable for subsequent phase modulation by the first optical system 132. Citing a specific example, the first optical system 132 includes, for example, a collimator, and converts the laser light into a mode suitable for the element 133 (that is, parallel light) with the collimator. Further, the first optical system 132 may have a function of adjusting polarization of the laser light to be suitable for subsequent phase modulation. Specifically, when the element 133 is a phase-modulation type, light having a polarization direction with a setting determined in a manufacture stage needs to be irradiated to the element 133. When the laser light source 131 is a semiconductor laser, light launched from the semiconductor laser is polarized, and therefore the laser light source 131 (semiconductor laser) has only to be placed such that a polarization direction of light incident on the element 133 matches the set polarization direction. By contrast, when light launched from the laser light source 131 is not polarized, the first optical system 132 is required to, for example, include a polarization plate, and make an adjustment such that a polarization direction of light incident on the element 133 matches the set polarization direction by use of the polarization plate. When the first optical system 132 includes a polarization plate, for example, the polarization plate is installed in closer to the element 133 than the collimator. Laser light guided from such a first optical system 132 to the element 133 enters a light-receiving surface of the element 133. The element 133 includes a plurality of light-receiving regions. The control unit 200 controls an optical characteristic (such as a refractive index) of each light-receiving region in the element 133 by for example varying a voltage applied to each light-receiving region based on information about each pixel of an image to be irradiated. Laser light being phase-modulated by the element 133 transmits a Fourier-transform lens (not illustrated), and is further condensed toward the second optical system 134. The second optical system 134 includes, for example, a projector lens, and the condensed light forms an image by the second optical system 134 and emitted to the outside.

While the element 133 constituting the projection unit 130 is a reflective type in the example in FIG. 36, the projection unit 130 may be provided by use of a transmissive-type element 133.

The element 133 will be described. As described above, laser light launched by the laser light source 131 enters the element 133 through the first optical system 132. The element 133 modulates a phase of the incident laser light, and launches the modulated laser light. The element 133 is also referred to as a spatial light phase modulator or a phase-modulation-type spatial modulation element. Details will be described below.

The element 133 includes a plurality of light-receiving regions (details will be described later). The light-receiving region is a cell constituting the element 133. The light-receiving region is arranged, for example, in a one-dimensional or two-dimensional array. The control unit 120 controls each of the plurality of light-receiving regions constituting the element 133 such that a parameter determining a difference between a phase of light incident on the light-receiving region and a phase of light emitting from the light-receiving region changes based on control information.

Specifically, the control unit 120 controls each of the plurality of light-receiving regions such that an optical characteristic such as a refractive index or an optical path length changes. Distribution of a phase of light incident on the element 133 varies with variation of an optical characteristic in each light-receiving region. Consequently, the element 133 emits light reflecting control information provided by the control unit 120.

The element 133 includes, for example, a ferroelectric liquid crystal, a homogeneous liquid crystal, or a homeotropic liquid crystal, and is implemented with, for example, a liquid crystal on silicon (LCOS). In this case, for each of the plurality of light-receiving regions constituting the element 133, the control unit 120 controls a voltage applied to the light-receiving region. A refractive index of a light-receiving region varies by applied voltage. Consequently, the control unit 120 is able to generate a difference in refractive index between the light-receiving regions by controlling a refractive index of each light-receiving region constituting the element 133. In the element 133, incident laser light appropriately diffracts in each light-receiving region depending on a difference in refractive index between the light-receiving regions based on control by the control unit 120.

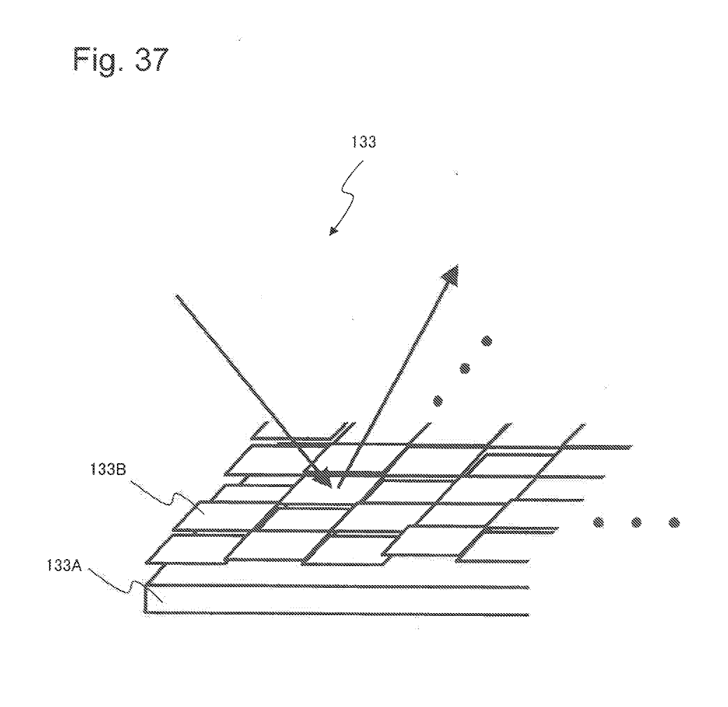

The element 133 may also be implemented by, for example, a micro electro mechanical system (MEMS) technology. FIG. 37 is a diagram illustrating a configuration of the element 133 implemented with a MEMS. The element 133 includes a substrate 133A and a plurality of mirrors 133B allocated to respective light-receiving regions on the substrate. Each of the plurality of light-receiving regions included in the element 133 is configured with a mirror 133B. The substrate 133A is, for example, parallel to a light receiving surface of the element 133, or nearly perpendicular to an incident direction of laser light.

For each of the plurality of mirrors 133B included in the element 133, the control unit 120 controls a distance between the substrate 133A and the mirror 133B. Consequently, the control unit 120 changes an optical path length of incident light at reflection for each light-receiving region. The element 133 diffracts incident light on a principle similar to a diffraction grating.

By diffracting incident laser light, the element 133 is theoretically able to form any image. Such the diffractive optical element is described in detail in, for example, NPL 3. Further, a method of the control unit 120 controlling the element 133 to form any image is described in, for example, NPL 4. Therefore, the descriptions are omitted herein.

While a hardware configuration providing the projection unit 130 is not limited to the aforementioned example, implementation of the projection unit 130 with the aforementioned hardware configuration provides a following effect.

The projection unit 130 having the aforementioned hardware configuration is able to achieve miniaturization and weight reduction by including the element 133 manufactured using an MEMS technology. Further, an image projected by the projection unit 130 having the aforementioned hardware configuration is formed by a part in which intensity of laser light is high due to optical diffraction, and therefore the projection unit 130 is able to project a bright image onto the distant projection surface 200.

—Application Example of Interface Device 100—

Specific examples of a device applying the interface device 100 will be described below. As described above, the interface device 100 is superior to a conventional interface device from viewpoints of size, weight, and power consumption. The present inventor has considered applying the interface device 100 to a mobile terminal capitalizing on the advantages. Further, the present inventor has also considered utilizing the device as a wearable terminal.

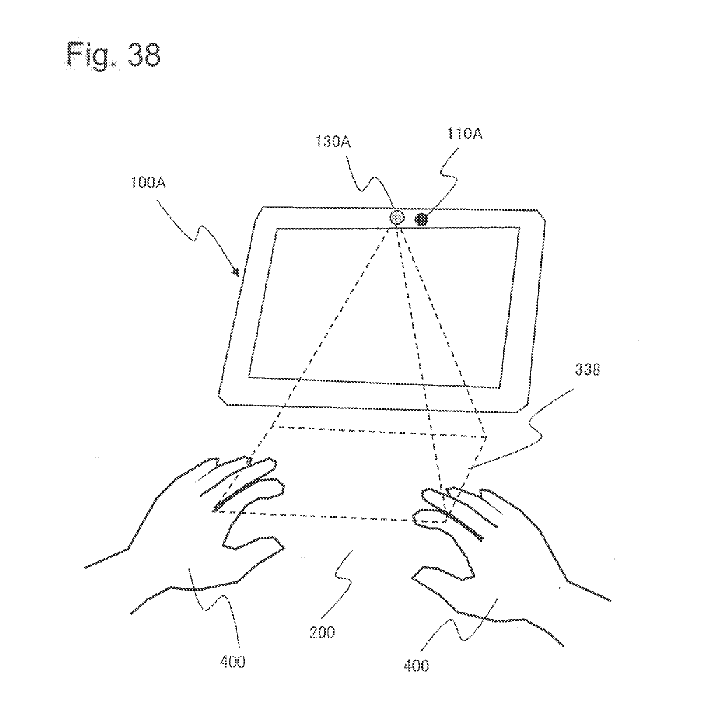

FIG. 38 is a diagram illustrating a specific example applying the interface device 100 to a tablet (portable device). As illustrated in FIG. 38, a tablet 100A includes an imaging unit 110A and a projection unit 130A. The projection unit 130A projects a projected image 338 onto the operation surface 200 (such as a tabletop). The projected image 338 is, for example, the projected image 300 providing a keyboard function. A user of the tablet 100A operates the tablet 100A using the projected image 338 projected on the operation surface 200. In the tablet 100A, the user is able to enter a character and the like using a keyboard (projected image 338), while, for example, displaying an image of an Internet site on an entire display, without displaying the keyboard on part of the display.

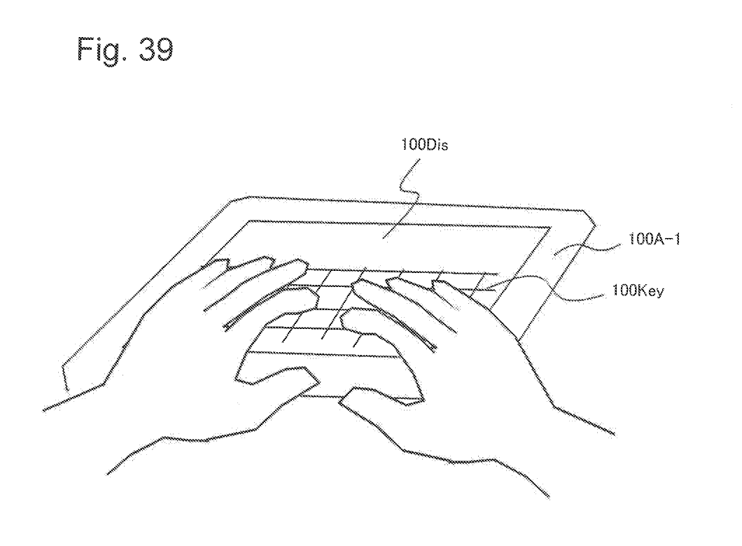

In other words, as illustrated in FIG. 39, a keyboard 100Key is displayed on part of a display 100Dis in a common tablet 100A-1. Accordingly, in a state that the keyboard 100Key is displayed, a region for displaying information such as an image and a character on the display 100Dis becomes small. Consequently, the user may feel difficulty and inconvenience in an operation of entering a character using the keyboard 100Key while referring to an image and the like displayed on the display 100Dis. By contrast, as described above, with the tablet 100A equipped with the interface device 100, the user is able to enter a character and the like using the keyboard (projected image 338) while referring to an image displayed on the entire display. That is, the tablet 100A improves user-friendliness.

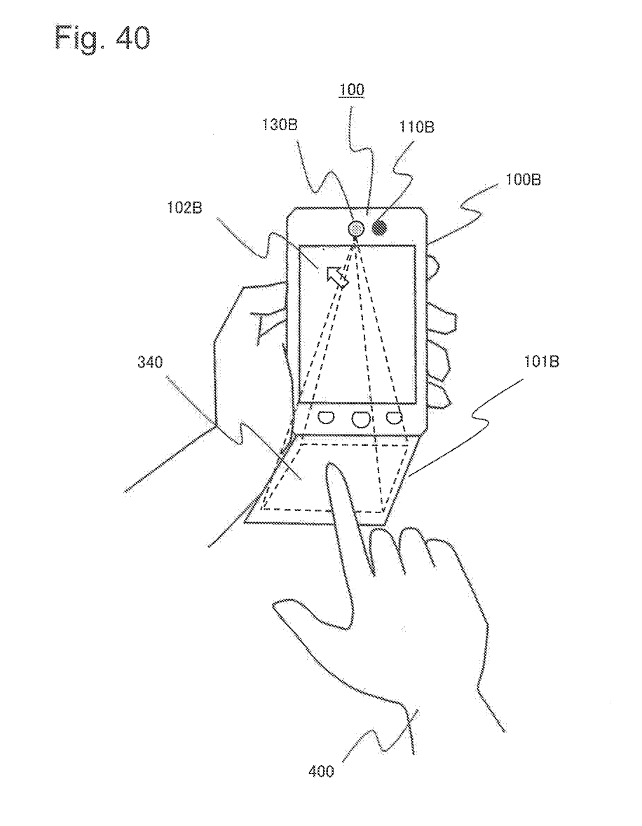

FIG. 40 is a diagram illustrating a specific example applying the interface device 100 to a smartphone (portable device).

A smartphone 100B illustrated in FIG. 40 includes an imaging unit 110B and a projection unit 130B. The projection unit 130B projects a projected image 340 onto the operation surface 200. The projected image 340 is, for example, the projected image 300 providing an input-key function. A user of the smartphone 100B operates the smartphone 100B using the projected image 340 projected on the operation surface 200. The operation surface 200 may be, for example, a tabletop surface, or a screen 101B attached to the smartphone 100B as illustrated in FIG. 40.

User friendliness can also be improved by the smartphone 100B similarly to the tablet 100A. Specifically, a user is able to operate the projected image 340 while referring to information displayed on an entire display of the smartphone 100B (or while visually observing a cursor 102B), and thus user friendliness of the smartphone 100B is improved.

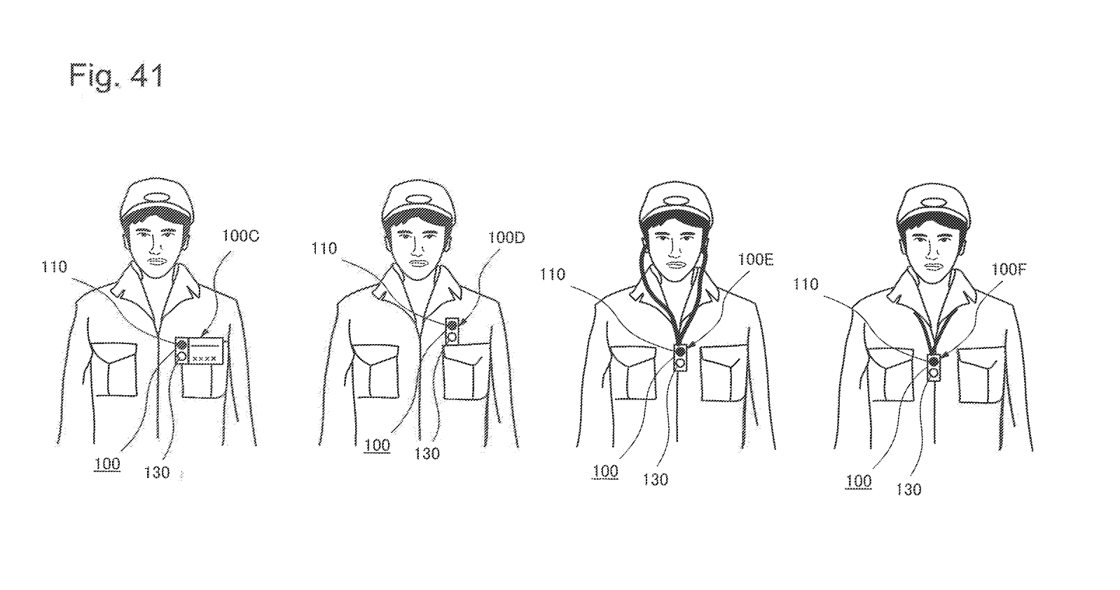

FIG. 41 is a diagram illustrating examples of the interface device 100 applied to various small-sized terminals (portable devices). A small-sized terminal 100C is a nameplate-shaped terminal equipped with the interface device 100. A small-sized terminal 100D is a pen-shaped terminal equipped with the interface device 100. A small-sized terminal 100E is a portable music terminal equipped with the interface device 100. A small-sized terminal 100F is a pendant-shaped terminal equipped with the interface device 100. While a target device to be equipped with the interface device 100 is not limited to a small-sized terminal, application to such a small-sized terminal is effective due to a simple configuration and easy miniaturization.

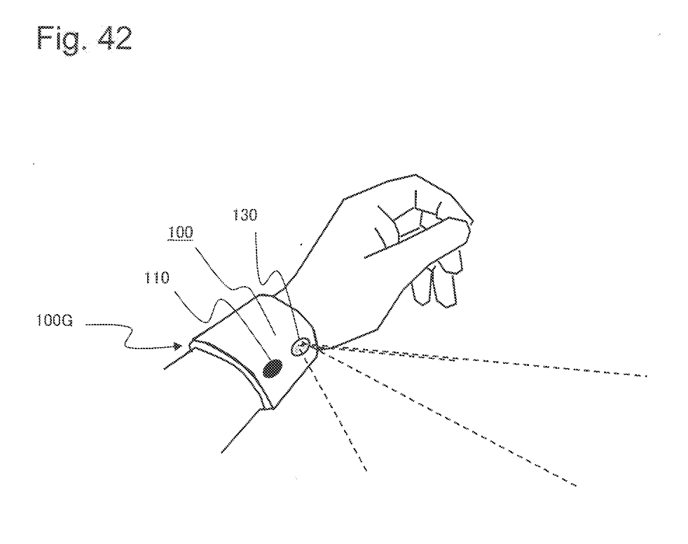

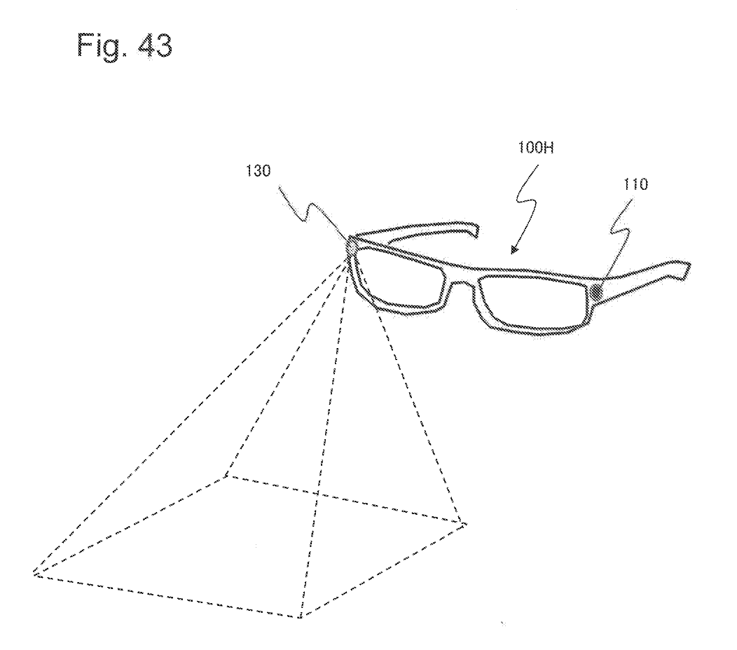

FIG. 42 is a diagram illustrating a specific example of equipping the interface device 100 on a wristband-type device (portable device [accessory]) 100G. FIG. 43 is a diagram illustrating a device (portable device [accessory]) 100H being eyewear such as glasses and sunglasses equipped with the interface device 100. Further, the interface device 100 may configure a wearable terminal (portable device [accessory]) by being equipped on a shoe, a belt, a necktie, a hat, or the like.

In the interface devices 100 illustrated in FIGS. 38 to 43, the imaging unit 110 and the projection unit 130 are provided at positions separated from one another. However, the imaging unit 110 and the projection unit 130 may be designed to be mutually coaxial.

Further, the interface device 100 may be considered to be used by being hung from the ceiling or on the wall, capitalizing on an advantage of being small-sized or lightweight.

### Application Example 1

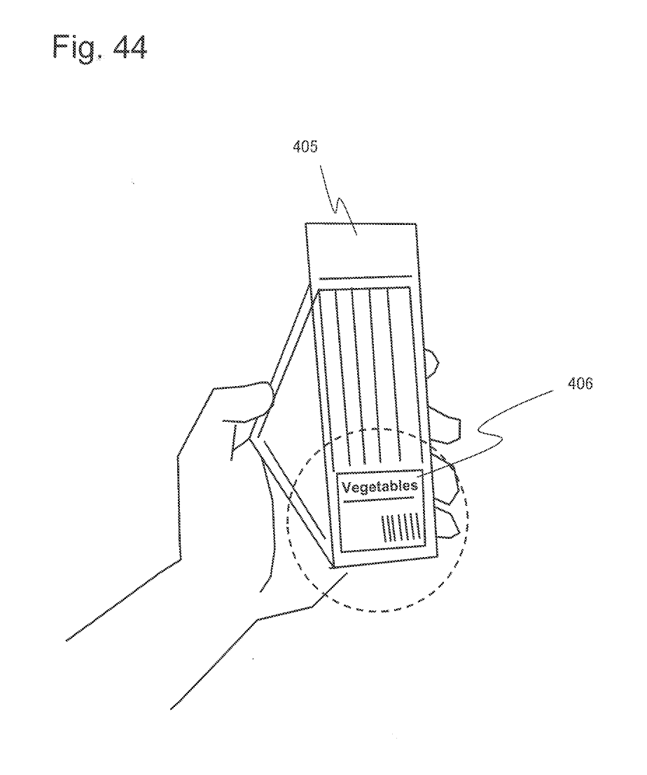

A specific example using the interface device 100 in a commodity selection operation will be described below with reference to FIGS. 44 to 47.

As illustrated in FIG. 44, for example, an operator holds a sandwich 405 in a hand and points the interface device 100 at the sandwich 405 to capture an image of the sandwich 405 by the imaging unit 110. The control unit 120 performs image processing on the captured image of the imaging unit 110, and recognizes that the sandwich 405 is captured in the captured image based on the image processing result and previously-given information about a sandwich (such as outline information). The control unit 120 further recognizes a label 406 affixed to the sandwich 405 and determines whether the sandwich 405 is past a sell-by date based on information contained in the label 406.

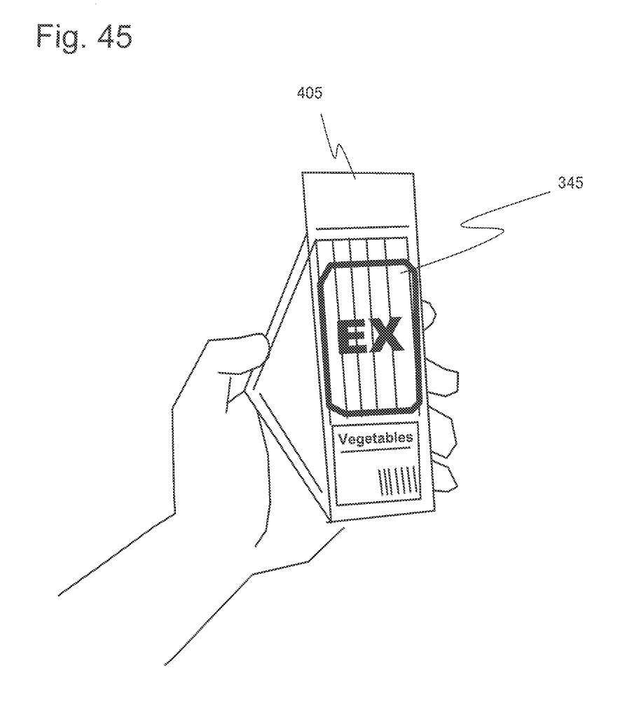

When determining that the sandwich 405 is past a sell-by date, the control unit 120 controls the projection unit 130 such that a projected image 345 as illustrated in FIG. 45 is projected on the sandwich 405. The projected image 345 is an image informing the operator about expiration.

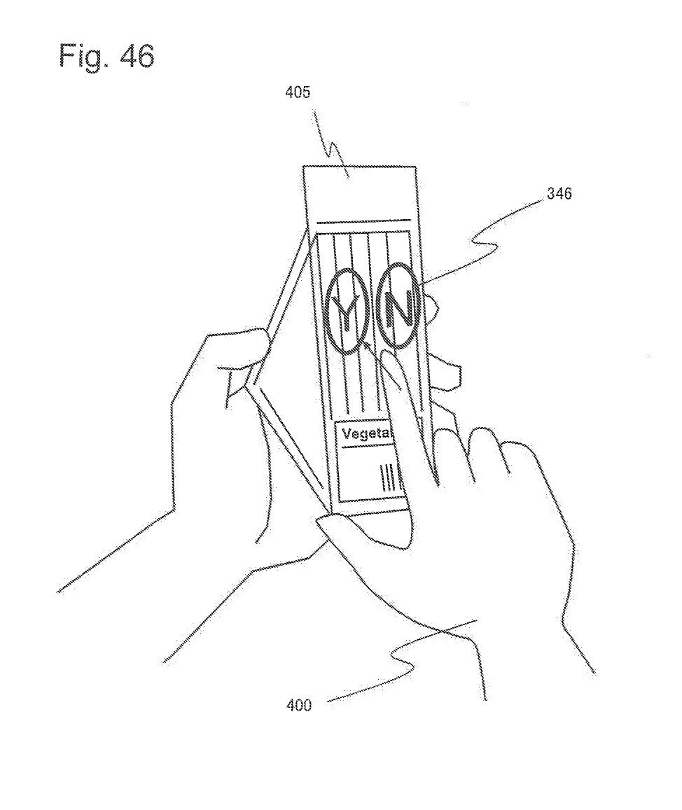

For example, the operator is able to perform slip processing for disposing of the sandwich 405 as follows. Specifically, the control unit 120 controls the projection unit 130 such that a projected image 346 as illustrated in FIG. 46 is projected on the sandwich 405. The projected image 346 is an image accepting selection of whether to dispose of the sandwich 405 from the operator.

The operator operates the projected image 346 with the operating object (finger) 400. When detecting that the operating object 400 moves toward a region indicating “Y (Yes)” in the captured image, the control unit 120 recognizes that disposal of the sandwich 405 is selected by the operator.

Further, when detecting that the operating object 400 moves toward a region indicating “N (No)” in the captured image, the control unit 120 ends the processing without any action.

When recognizing that disposal of the sandwich 405 is selected by the operator as described above, for example, the control unit 120 communicates with a server at a pre-specified store, and transmits information notifying disposal of the sandwich 405 to the server at the store. Thus, the slip processing by the operator is completed. In other words, the operator is able to complete the slip processing simply by selecting “Y (Yes)” in the projected image 346. As described above, the interface device 100 described here has a communication function for wireless or wired communication with a server.

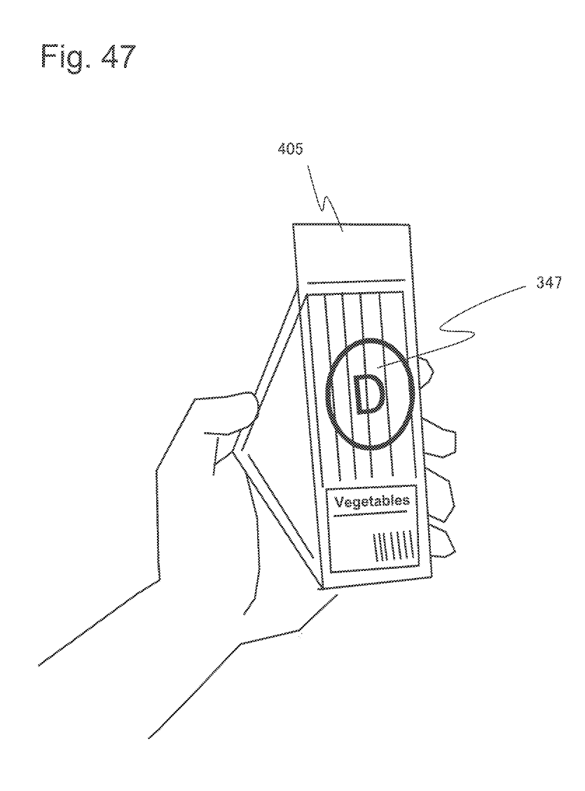

The server at the store receiving information notifying disposal of the sandwich 405, for example, transmits (replies) information notifying that slip processing related to the disposal of the sandwich 405 is completed, to the interface device 100. When receiving the information, the interface device 100 controls the projection unit 130 such that a projected image 347 as illustrated in FIG. 47 is projected on the sandwich 405. The projected image 347 is an image notifying the operator of completion of the slip processing.

When confirming the projected image 347, the operator performs disposal processing of the sandwich 405 by putting the sandwich 405 into, for example, a disposal basket.

For example, when an operator performs disposal processing using a check sheet, the operator tends to make a mistake such as leaving a food product to be disposed. By contrast, the operator is able to prevent such the mistake by checking individual item related to disposal of the sandwich 405 by use of the interface device 100.

### Application Example 2

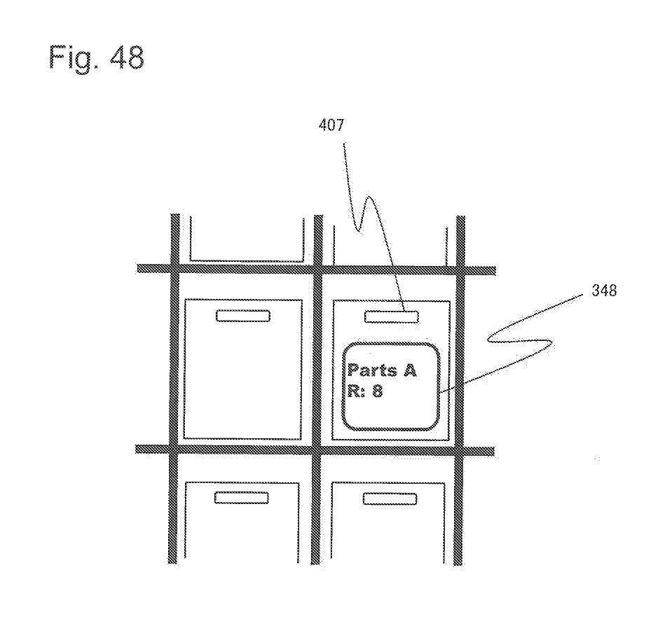

A specific example using the interface device 100 in an operation related to parts control will be described with reference to FIGS. 48 to 50.

When an operator wearing the interface device 100 stands in front of a parts shelf 407 as illustrated in FIG. 48, the imaging unit 110 captures an image of the parts shelf 407. By performing image processing on the captured image, the control unit 120 recognizes the parts shelf 407 in the captured image. The interface device 100 has a communication function, and is communicable with a server using the communication function. The interface device 100 inquires of the server about a type of a part and a quantity thereof stored in the parts shelf 407. The server accordingly transmits (replies) information notifying that, for example, eight of parts A are stored in the parts shelf 407, to the interface device 100.

When the interface device 100 receives the information, the control unit 120 controls the projection unit 130 such that a projected image 348 as illustrated in FIG. 48 is projected on, for example, a door of the parts shelf 407. The projected image 348 is an image indicating that eight of parts A are stored in the parts shelf 407, to the operator.

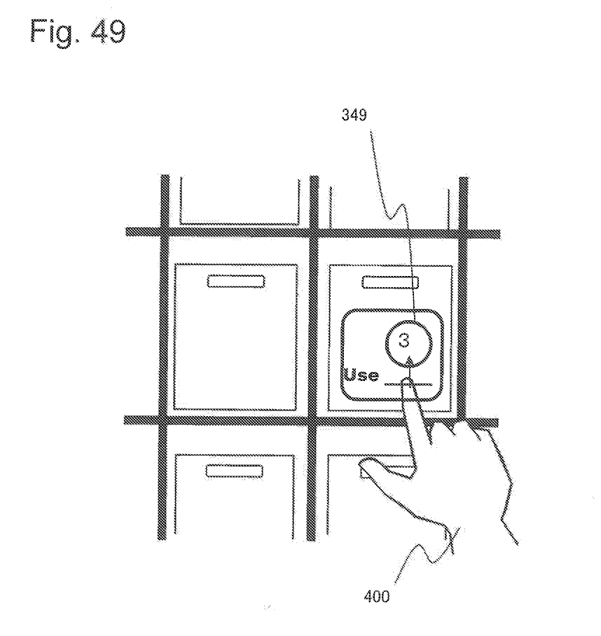

For example, assume that the operator intends to pick up three of parts A from the parts shelf 407. Alternatively, an instruction may be notified from the server to the interface device 100 to pick up three of parts A. The operator picks up three of parts A from the parts shelf 407, and subsequently taps the projected image 348 three times corresponding to the quantity of the parts being picked up. In this case, it appears to the operator that a number displayed on a projected image 349 as illustrated in FIG. 49 counts up every time the operator taps the projected image 348. In the example in FIG. 49, a display “3” is projected, in response to the operator tapping the projected image 349 three times.

Alternatively, when the interface device 100 has, for example, the function related to number entry presented in the third specific example, the operator enters the quantity of the parts A picked up from the parts shelf 407 to the interface device 100 by use of the function.

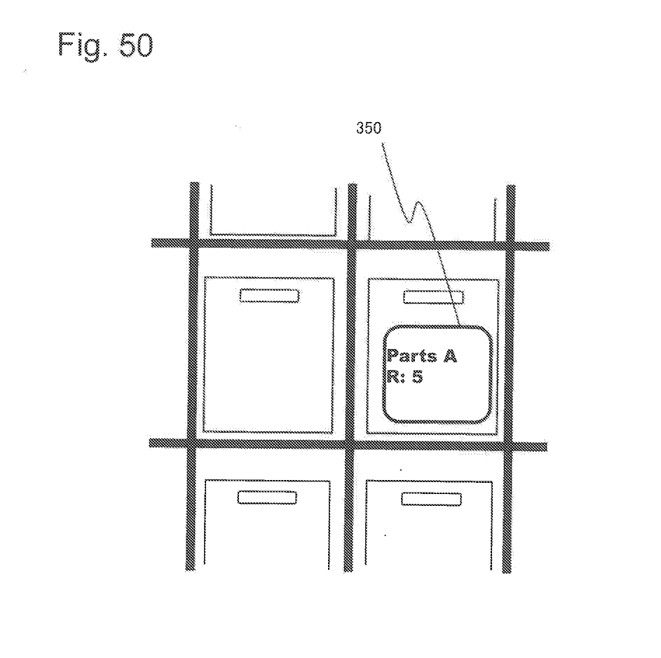

Subsequently, the operator performs a predetermined determination operation to determine the number “3” as a number to be entered (recognized) to the interface device 100. Consequently, the interface device 100 (control unit 120) recognizes entry of the number “3,” and calculates “5,” by subtracting the quantity picked up by the operator: “3” from the quantity of the parts A stored in the parts shelf 407: “8”. The control unit 120 controls the projection unit 130 such that a projected image 350 reflecting the calculation result as illustrated in FIG. 50 is projected on, for example, a door of the parts shelf 407.

The operation related to parts control is completed by the operator observing the projected image 350, and confirming that the quantity of the parts A displayed on the projected image 350 matches the quantity of the parts A stored in the parts shelf 407. Further, the interface device 100 transmits information notifying that three of the parts A are picked up from the parts shelf 407, to the server. Consequently, parts control data held by the server are updated.

Thus, use of the interface device 100 not only enables an easy-to-understand operation for an operator, but also completes an operation related to electronic parts control on the spot.

### Application Example 3

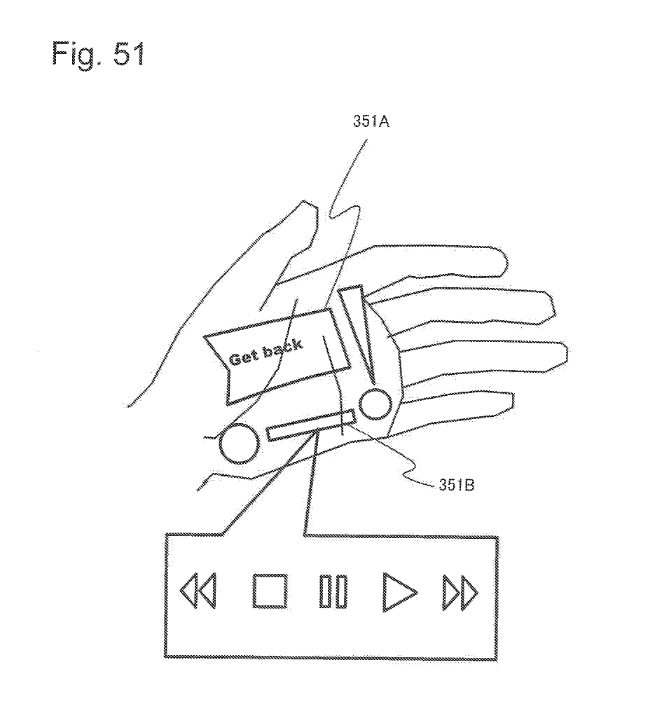

A specific example using the interface device 100 in an operation of a portable music terminal will be described below with reference to FIGS. 51 to 53. While a portable music terminal is a widely prevalent and convenient device enabling a user to listen to music anywhere, there is some inconvenience such as a need for being taken out of a bag or the like for each operation. Although part of an operation can be performed with a small device attached to an earphone or the like, an information amount and a content of an operation provided are limited, and moreover, there is a problem that such a device is too small to operate, to begin with. Use of the interface device 100 solves such inconveniences.

The interface device 100 may be implemented in combination with a portable music terminal, or may be provided separately from a portable music terminal, and configured to be communicable with the portable music terminal. Alternatively, the interface device 100 may be configured with a module including the control unit 120 and the projection unit 130, and a camera (that is, a camera functioning as the imaging unit 110) in a mobile phone communicable with the module. In this case, for example, the control unit 120 is communicable with the portable music terminal. Alternatively, the interface device 100 may be configured with an external camera (imaging unit 110), an external projector (projection unit 130), and a control device functioning as the control unit 120 communicable with the camera and the projector. In this case, the control unit 120 is communicable with each of the portable music terminal, the external camera, and the external projector.

For example, when recognizing that a hand is displayed in the captured image provide by the imaging unit 110, the control unit 120 controls the projection unit 130 such that a projected image 351 as illustrated in FIG. 51 is projected on a palm. The projected image 351 includes information 351A about a selected tune, and state selection bar 351B. The state selection bar 351B displays various options.

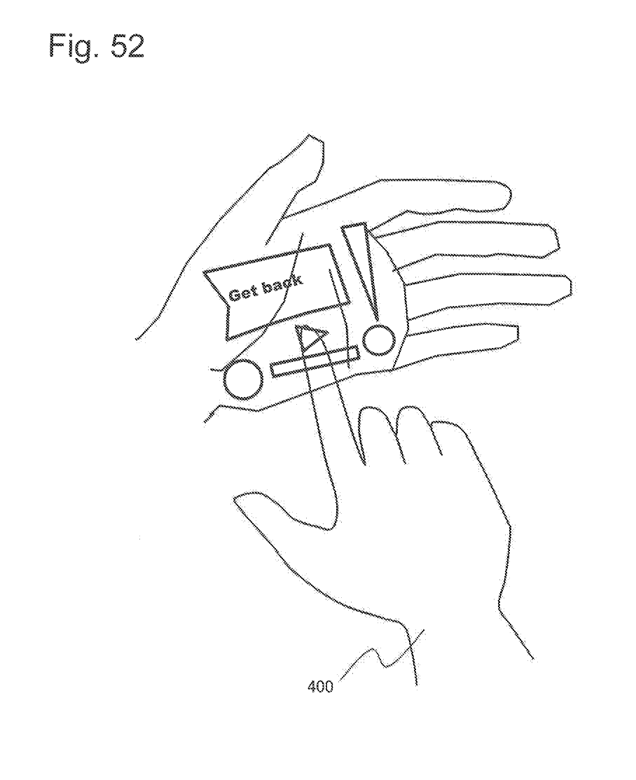

Similarly to the aforementioned third specific example, by the operating object 400 sliding along the state selection bar 351B as illustrated in FIG. 52, an option corresponding to a position of the operating object 400 is projected by the projection unit 130 based on control of the control unit 120. In the example in FIG. 52, the operating object 400 (user) selects playback (a triangular mark). By the control unit 120 recognizing the selection information, and transmitting the information to, for example, a control unit in a portable music terminal, the portable music terminal plays music.

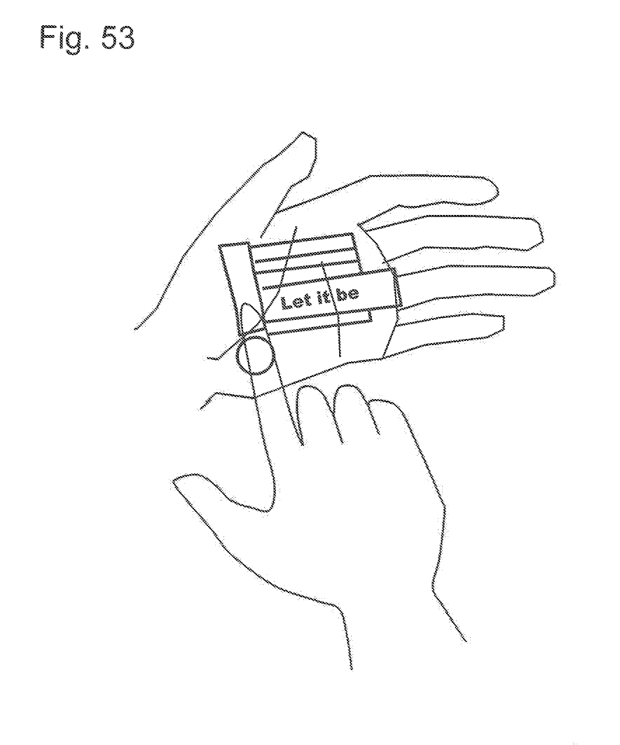

Further, for example, when recognizing that the operating object 400 is positioned at a position of a circular mark on the left side as illustrated in FIG. 53, the control unit 120 controls the projection unit 130 such that the projected image switches to an image of a music list (selection screen). Additionally, when recognizing that the operating object 400 slides along the selection bar on the left side, the control unit 120 controls the projection unit 130 such that selection target tunes are successively highlighted based on a slide position of the operating object 400. Furthermore, when recognizing that the operating object 400 is positioned at a position of a highlighted tune, the control unit 120 recognizes that the tune is selected. Furthermore, the control unit 120 transmits information about the selected tune to, for example, the control unit in the portable music terminal.

A function related to the aforementioned information display and the like may also be applied to, for example, display of information about a tune. Additionally, the function may be applied to, for example, display of telephone numbers in a telephone directory registered in a telephone, and a selection function thereof. Thus, the function may be applied to various functions.

### Application Example 4

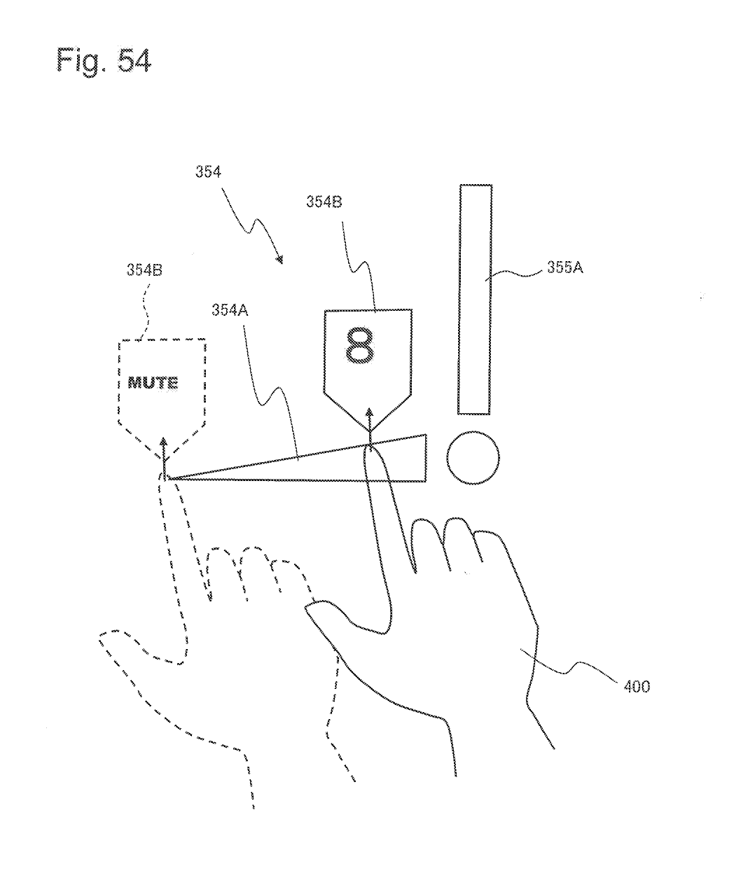

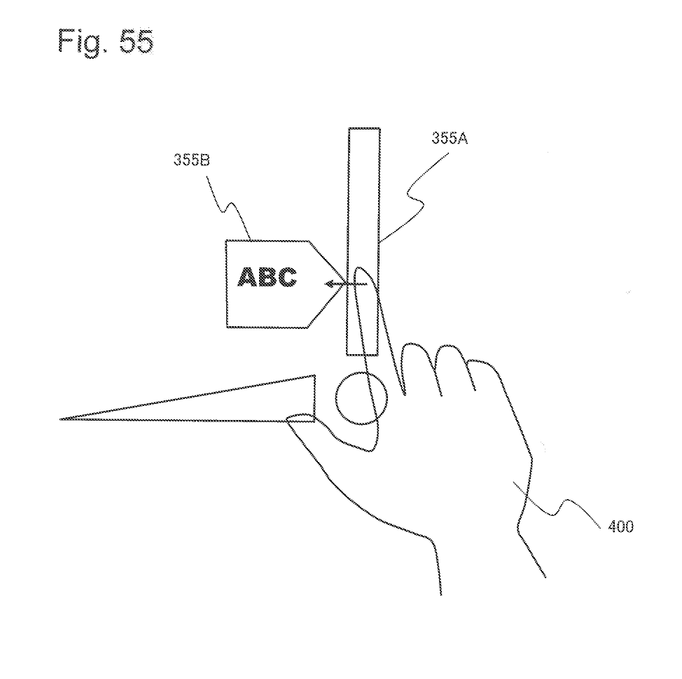

A specific example using the interface device 100 in a television remote control or the like will be described below with reference to FIGS. 54 and 55. The interface device 100 may be implemented in combination with a remote control, or may be provided separately from a remote control and configured to be communicable with the remote control. Alternatively, the interface device 100 may include an external camera (imaging unit 110), an external projector (projection unit 130), and a control device functioning as the control unit 120. In this case, the control device (control unit 120) is communicable with the external camera and the external projector.

As illustrated in FIG. 54, the interface device 100 projects a projected image 354 onto the operation surface 200. The projected image 354 includes a volume control bar 354A. Similarly to the third specific example, when an operating object 400 slides along the volume control bar 354A, the control unit 120 controls the projection unit 130 such that a projected image 354B indicating an option corresponding to a position of the operating object 400 on the volume control bar 354A is projected. In the example in FIG. 54, “MUTE” and “8” indicating a volume level are displayed as images of options (projected images 354B).

Moreover, the projected image 354 further includes a channel selection bar 355A. Similarly to the above, when the operating object 400 slides along the channel selection bar 355A as illustrated in FIG. 55, the control unit 120 controls the projection unit 130 such that a projected image 355B indicating an option corresponding to a position of the operating object 400 on the channel selection bar 355A is projected. In the example in FIG. 55, “ABC” indicating a channel name of a television broadcast is displayed as an image of an option (projected image 355B).

Similarly to the aforementioned television remote control, the interface device 100 is able to provide a function as a remote control of a device (equipment) such as an air conditioning machine and a lighting apparatus. Further, a remote control communicates with a body of a television or the like, generally by use of infrared rays, and the interface device 100 may accordingly project such infrared rays.

### Application Example 5

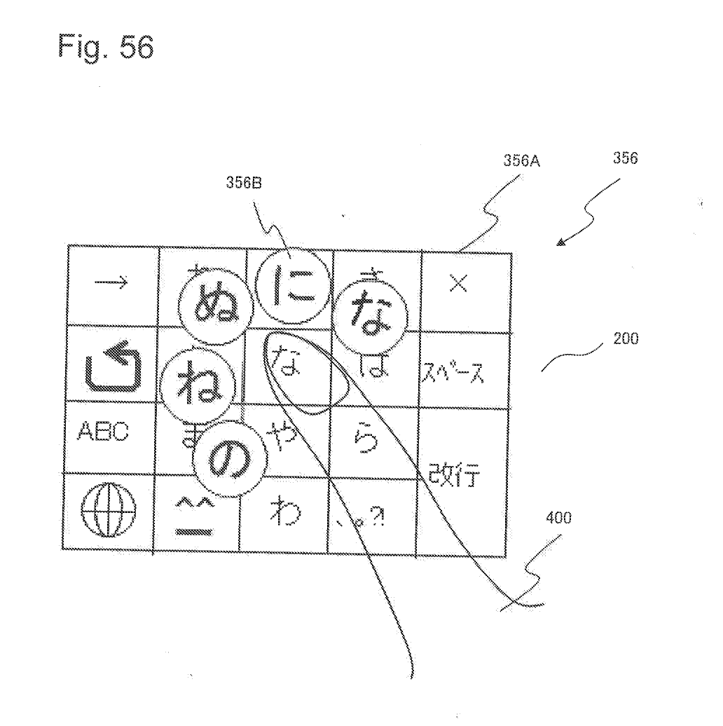

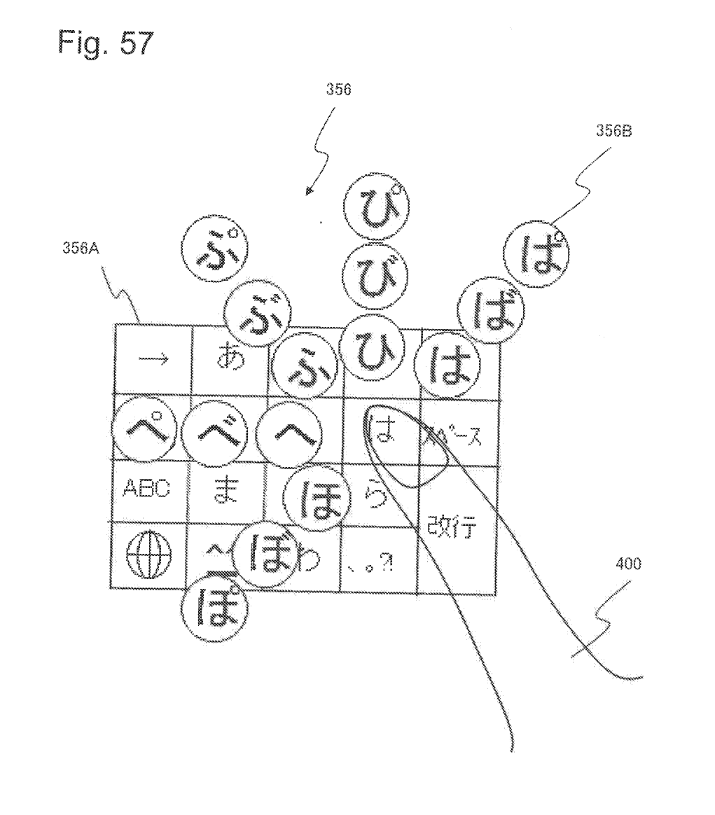

A specific example applying the interface device 100 to a device having a Japanese input function will be described below, with reference to FIGS. 56 and 57.

In the specific example, the projection unit 130 projects a projected image 356 as illustrated in FIG. 56 onto the operation surface 200, based on control by the control unit 120. The projected image 356 is an image displayed for entering Japanese, and includes a projected image 356A and a projected image 356B. The projected image 356A is an image displaying a plurality of key-shaped images. In the example, the projected image 356A includes images of a plurality of kana keys respectively displaying Japanese hiragana characters “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and “ [symbol] ”. Moreover, the projected image 356A further includes a key indicating Japanese (katakana) characters “ [symbol] ” meaning “space,” and a key indicating Japanese (kanji) characters “ [symbol] ” meaning “return.” The hiragana characters displayed in the projected image 356A, “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and “ [symbol] ” are characters all including a vowel “ [symbol] ” in respective pronunciations.

The projected image 356B is an image unfolding and displaying a plurality of options associated with a kana key pointed by the operating object 400, out of the plurality of kana keys in the projected image 356A. In the example in FIG. 56, the operating object 400 points a kana key “ [symbol] ” in the projected image 356A. Consequently, images of keys respectively indicating Japanese hiragana characters “ [symbol] ”, “ [symbol] ”, “ [symbol] ”, “ [symbol] ”, and “ [symbol] ” being a plurality of options associated with the kana key “ [symbol] ” are projected as the projected image 356B.

When detecting that one of the plurality of option keys in the projected image 356B is pointed by the operating object 400 based on the captured image provided by the imaging unit 110, the control unit 120 recognizes the character corresponding to the selected key as an entered character.

A difference between so-called flick input in a smartphone or the like and Japanese input described in the example will be described. In flick input, for example, when the operating object 400 stays at a key position in the projected image 356A, the character displayed on the key is recognized as an entered character by the device. Further, there is a case that the operating object 400 makes movement of temporarily stopping at a key position in the projected image 356A and subsequently, for example, sliding in a certain direction. In this case, the character determined by the key position at which the operating object 400 temporarily stops and the direction in which the operating object 400 subsequently slides is recognized as an entered character by the device. The flick input tends to cause a following problem of erroneous entry. Specifically, assume that, for example, a Japanese hiragana character “ [symbol] ” is recognized as an entered character by, for example, the operating object 400 staying at a key position in the projected image 356A. However, there may be a case (erroneous entry) that the user actually intends to enter a Japanese hiragana character “ [symbol] ”, related to the Japanese hiragana character “ [symbol] ”.

By contrast, in the specific example, when the operating object 400 stays at the key position in a projected image 356A, an image of a plurality of options (projected image 356B) associated with the character displayed on the key is projected. The projected image 356B also includes the character pointed by the operating object 400 in the projected image 356A as an option. Then, the character determined by the projected image and the position of the option pointed by the operating object 400 is recognized as an entered character by the device (control unit 120). In other words, in the specific example, the character is not entered by the operation of the operating object 400 with respect to the projected image 356A alone, and the entered character is recognized by the operation of the operating object 400 with respect to the projected image 356B corresponding to the operation of the operating object 400 with respect to the projected image 356A. That is, in the specific example, a criterion by which the operation of the operating object 400 with respect to the projected image 356A is recognized, and a criterion by which the operation of the operating object 400 with respect to the projected image 356B are different.

As described above, in the specific example, the entered character is recognized by the projected image 356B indicating an option, instead of the projected image 356A, and the option provided by the projected image 356B also includes the character of the key pointed in the projected image 356A. Thus, the interface device 100 in the specific example is able to prevent erroneous entry of a character.

FIG. 57 is a diagram illustrating another example of the projected image 356 in FIG. 56. In the example in FIG. 57, the operating object 400 points a key indicating a Japanese hiragana character “ [symbol] ” in the projected image 356A. Consequently, key-shaped images of a plurality of options related to the Japanese hiragana character “ [symbol] ” as illustrated in FIG. 57 are projected as the projected image 356B by the projection unit 130 based on control by the control unit 120. In the example in FIG. 57, Japanese hiragana characters “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ”, “ [symbol] ” and “ [symbol] ” are respectively displayed as options. Thus, by displaying characters including a voiced consonant or a p-sound together, the interface device 100 is able to provide an interface capable of rapid entry of a character. In the specific example described using FIGS. 56 and 57, an example of the interface device 100 displaying a Japanese character is described. Alternatively, in addition to display of a Japanese character, the interface device 100 may display, for example, a symbol such as an alphabet and an umlaut, and a character (emoticon) combining symbols, as an option of the projected image 356B. Thus, the interface device 100 in the specific example may be applied to various types of character entry interfaces.

### Second Exemplary Embodiment

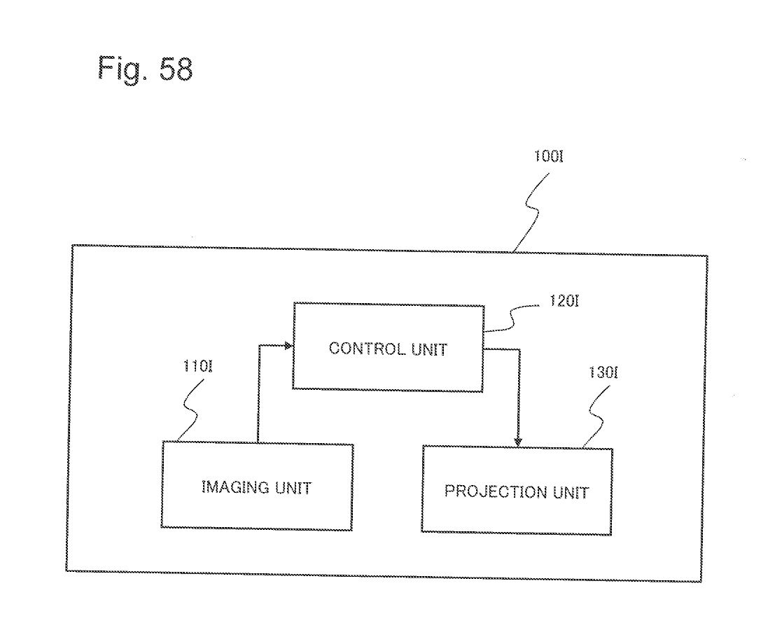

FIG. 58 is a block diagram illustrating a simplified configuration of an interface device 100I according to a second exemplary embodiment of the present invention. The interface device 100I includes an imaging unit 110I, a control unit 120I, and a projection unit 130I.

The projection unit 130I projects a first projected image. The imaging unit 110I is capable of capturing an image including at least an operating object operating the own device and the first projected image. The control unit 120I recognizes operation information on the operating object based on a relation between a captured position of the operating object and a captured position of the first projected image in a captured image being an image captured by the imaging unit 110I. Further, the control unit 120I controls the projection unit 130I based on the recognized operation information.

### Third Exemplary Embodiment

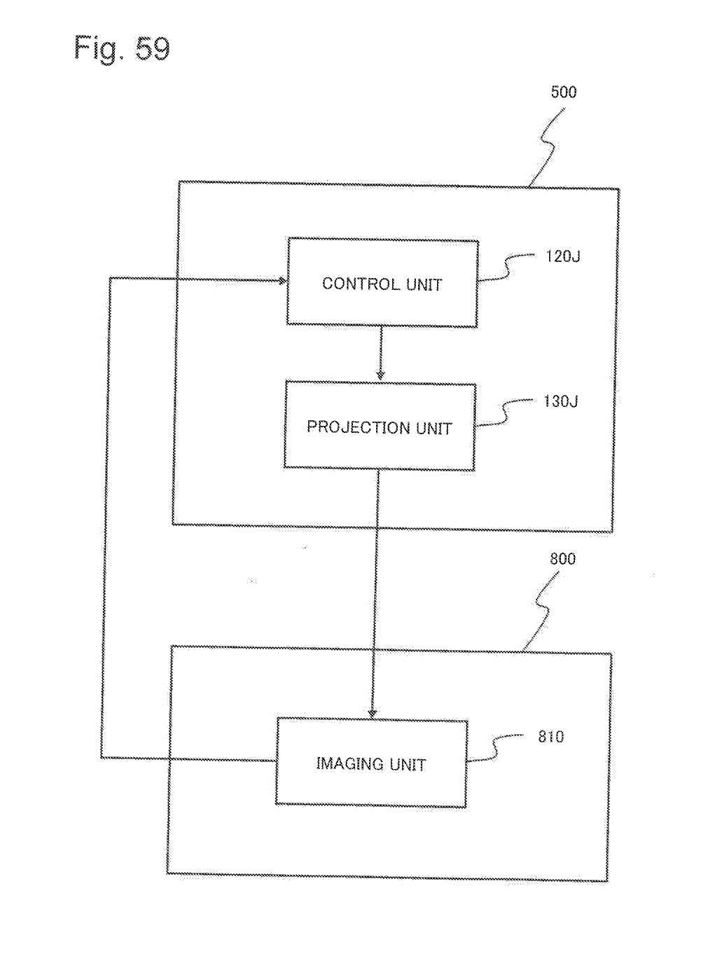

FIG. 59 is a block diagram illustrating a simplified configuration of a module 500 according to a third exemplary embodiment of the present invention. As illustrated in FIG. 59, the module 500 is used in a state communicably connected to an electronic part 800.

The electronic part 800 includes an imaging unit 810.

The module 500 includes a control unit 120J and a projection unit 130J. The projection unit 130J projects a first projected image. The control unit 120J receives a captured image captured by the imaging unit 810 from the electronic part 800. Then, the control unit 120J recognizes operation information on an operating object based on a positional relation between a captured position of the operating object and a captured position of the first projected image in the captured image. Additionally, the control unit 120J controls the projection unit 130J based on the operation information.

### Fourth Exemplary Embodiment

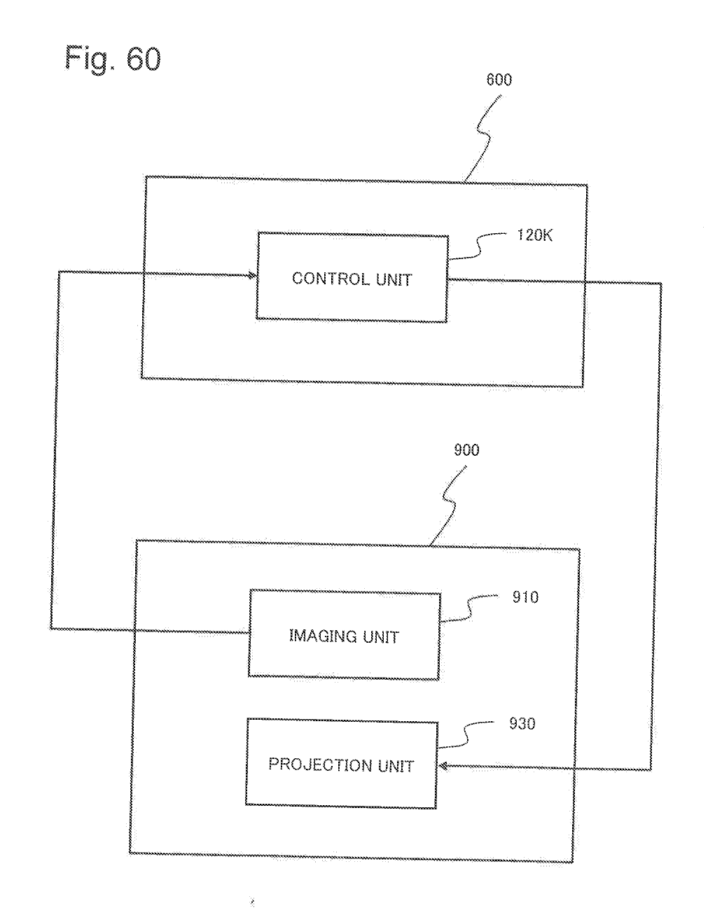

FIG. 60 is a block diagram illustrating a simplified configuration of a control device 600 according to a fourth exemplary embodiment of the present invention. The control device 600 is communicably connected to an electronic part 900.

The electronic part 900 includes an imaging unit 910 and a projection unit 930. The imaging unit 910 and the projection unit 930 may be implemented on separate electronic parts 900. In this case, the control device 600 is communicably connected to an electronic part 900 including the imaging unit 910, and another electronic part 900 including the projection unit 930 through a communication network.

The control device 600 includes a control unit 120K. The control unit 120K receives a captured image captured by the imaging unit 910. Then, the control unit 120K recognizes operation information on an operating object based on a relation between a captured position of the operating object and a captured position of a first projected image in the captured image. Additionally, the control unit 120K controls the projection unit 930 based on the operation information.

### Fifth Exemplary Embodiment

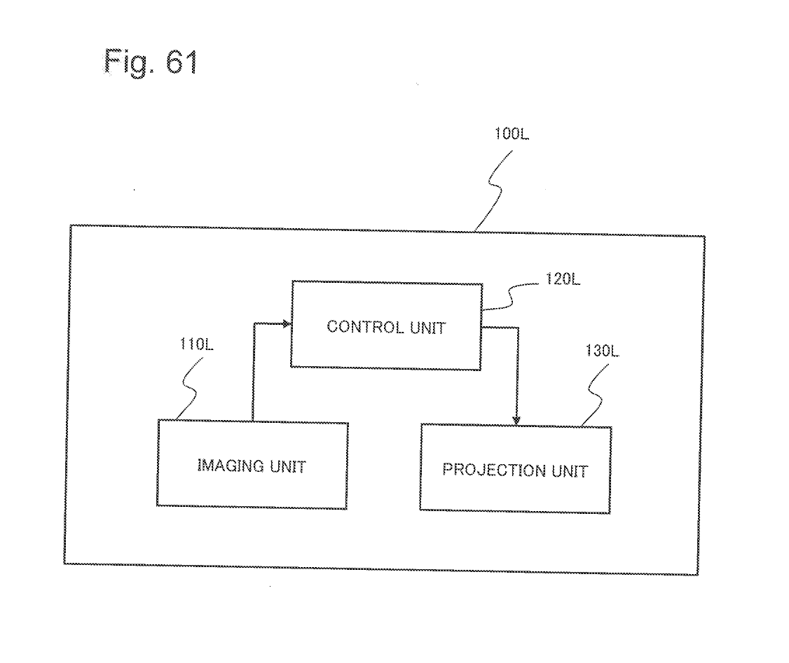

FIG. 61 is a block diagram illustrating a simplified configuration of an interface device 100L according to a fifth exemplary embodiment of the present invention. The interface device 100L includes an imaging unit 110L, a control unit 120L, and a projection unit 130L.

The projection unit 130L projects a projected image. The imaging unit 110L captures a projected image. The control unit 120L calculates a positional relation between a surface on which a projected image is projected (operation surface) and the imaging unit 110L based on a captured position of a projected image in a captured image captured by the imaging unit 110L.

### Sixth Exemplary Embodiment

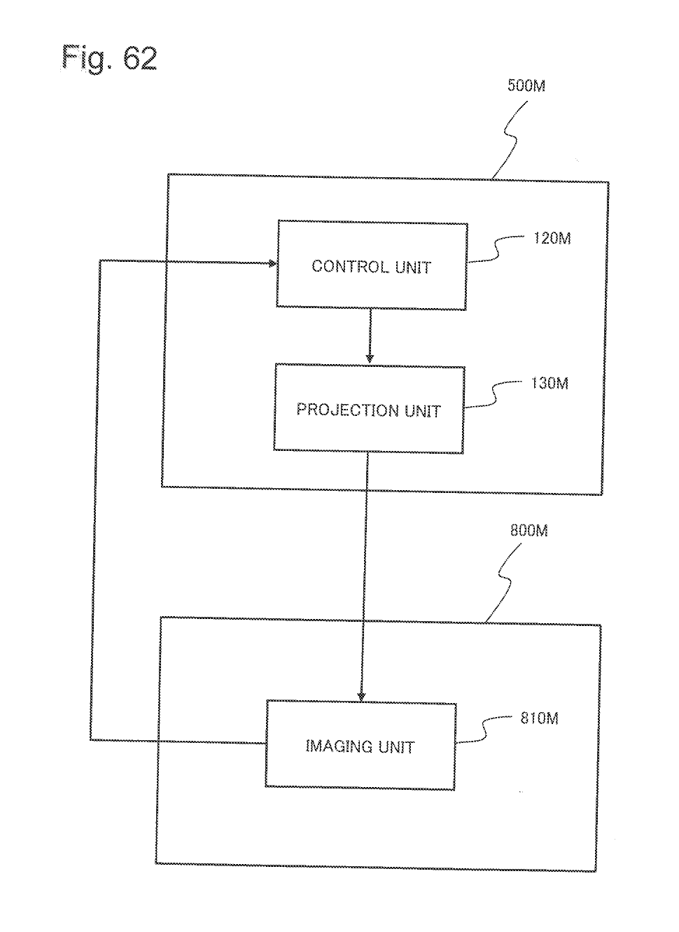

FIG. 62 is a block diagram illustrating a simplified configuration of a module 500M according to a sixth exemplary embodiment of the present invention. The module 500M is communicably connected to an electronic part 800M.

The electronic part 800M includes an imaging unit 810M. The module 500M includes a control unit 120M and a projection unit 130M. The projection unit 130M projects a projected image. The control unit 120M calculates a positional relation between a surface on which a projected image is projected (operation surface) and the imaging unit 810M based on a captured position of a projected image in a captured image captured by the imaging unit 810M.

### Seventh Exemplary Embodiment

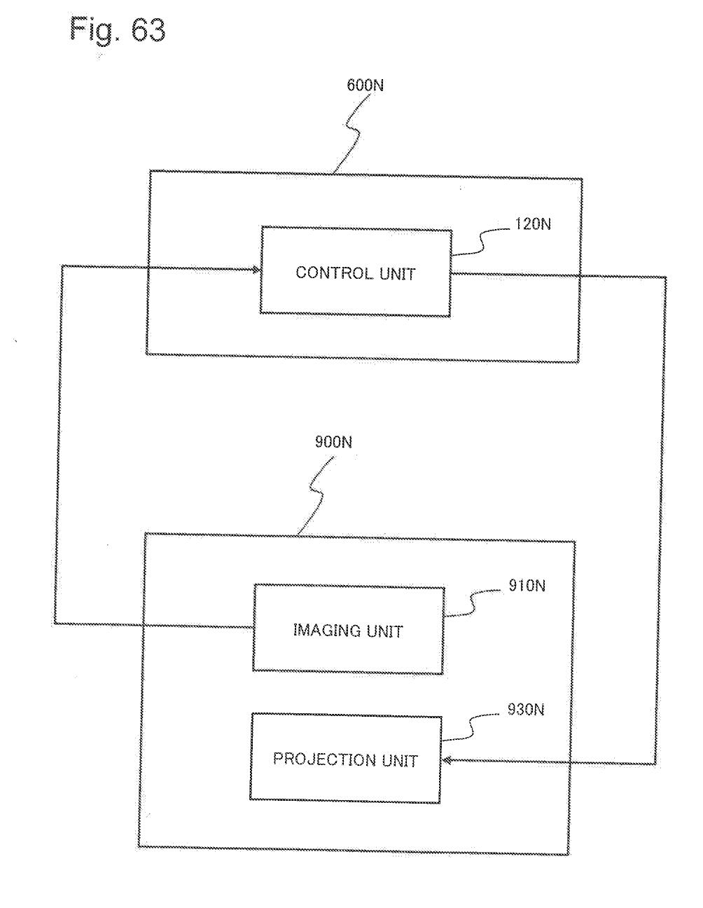

FIG. 63 is a block diagram illustrating a simplified configuration of a control device 600N according to a seventh exemplary embodiment of the present invention. The control device 600N is communicably connected to an electronic part 900N.

The electronic part 900N includes an imaging unit 910N and a projection unit 930N. The control device 600N includes a control unit 120N. The imaging unit 910N and the projection unit 930N may be implemented on separate electronic parts 900N. In this case, the control device 600N is communicably connected to an electronic part 900N including the imaging unit 910N, and another electronic part 900N including the projection unit 930N through a communication network.

The control unit 120N calculates a positional relation between a surface on which a projected image is projected (operation surface) and the imaging unit 910N based on information about a captured position of a projected image in a captured image captured by the imaging unit 910N.

The respective exemplary embodiments described above may be implemented in combination as appropriate. Further, the respective specific examples and the application examples described above may be implemented in combination as appropriate.

Further, block partitioning illustrated in each block diagram is made for convenience of description. Implementation of the present invention described with the respective exemplary embodiments as examples is not limited to configurations illustrated in the respective block diagrams.

While the exemplary embodiments of the present invention have been described above the aforementioned exemplary embodiments are intended for facilitation of understanding of the present invention, and not for limited recognition of the present invention. The present invention may be altered or modified without departing from the spirit thereof, and the present invention also includes an equivalent thereof. In other words, various embodiments that can be understood by those skilled in the art may be applied to the present invention, within the scope thereof.

This application claims priority based on Japanese Patent Application No. 2014-003224 filed on Jan. 10, 2014, the disclosure of which is hereby incorporated by reference thereto in its entirety.

Examples of reference exemplary embodiments will be described as Supplementary Notes below.

(Supplementary Note 1)

An interface device including:

a projection unit that projects a first projected image;

an imaging unit that captures an image including at least an operating object operating the own device and the first projected image; and

a control unit that accepts an operation by the operating object based on a relation between a position in which the operating object is captured and a position in which the first projected image is captured in a captured image being an image captured by the imaging unit, and controls the projection unit in response to the accepted operation.

(Supplementary Note 2)

The interface device according to Supplementary Note 1, wherein

the control unit controls the projection unit to project a second projected image in response to accepting the operation, and

the control unit further accepts an operation next to the accepted operation based on a relation between a position in which the operating object is captured and a position in which the second projected image projected by the projection unit is captured in the captured image.

(Supplementary Note 3)

The interface device according to Supplementary Note 2, wherein

the first projected image is an image for displaying a plurality of options,

the control unit accepts an operation of selecting a first option out of the plurality of options based on a relation between a position of the operating object and a position of the first projected image in the captured image, and

the second projected image is an image for displaying an option related to the first option.

(Supplementary Note 4)

The interface device according to Supplementary Note 3, wherein

the control unit accepts an operation by the operating object based on a relation between a position in which the operating object is captured and a position in which the projected image is captured in the captured image, and a motion of the operating object, and

the control unit accepts an operation based on mutually different criteria between a case of accepting an operation in relation to the first projected image, and a case of accepting an operation in relation to the second projected image.

(Supplementary Note 5)

The interface device according to Supplementary Note 4, wherein

the control unit controls the projection unit such that the second projected image is projected in a mode of being superposed on the first projected image, and

when the second projected image is captured in the captured image, the control unit performs processing of accepting input of information corresponding to the first option out of a plurality of options indicated by the second projected image, or, performs processing of controlling the projection unit to project the first projected image again based on a speed or an acceleration of the operating object in a captured image.

(Supplementary Note 6)

The interface device according to any one of Supplementary Notes 2 to 5, wherein

when the own device is operated by a plurality of the operating objects,

the control unit controls the projection unit to project the first projected image in proximity to a first operation object out of the plurality of operating objects, and to project the second projected image in proximity to a second operation object different from the first operation object.

(Supplementary Note 7)

The interface device according to Supplementary Note 6, wherein

the imaging unit captures an image including the first operation object, the first projected image, the second operation object, and the second projected image, and

the control unit performs processing of accepting an operation based on a relation between a position in which the first operation object is captured and a position in which the first projected image is captured in the captured image and a relation between a position in which the second operation object is captured and a position in which the second projected image is captured in the captured image, and controlling the projection unit in response to the accepted operation.

(Supplementary Note 8)

The interface device according to Supplementary Note 1, wherein

the control unit accepts selection of a determined certain option of out of a plurality of options based on a relation between a position in which the operating object is captured and a position in which the first projected image is captured in a captured image being an image captured by the imaging unit, and controls the projection unit to project a second projected image being an image corresponding to the certain option in proximity to the operating object, and

when detecting a specific action by the operating object in the captured image in a state that the captured image includes the second projected image, the control unit further accepts input of information corresponding to the determined certain option.

(Supplementary Note 9)

The interface device according to Supplementary Note 8, wherein

the specific action is an action that, in the captured image, a position in which the operating object is captured stays at a position corresponding to the specific option for a predetermined time or longer in relation to a position in which the first projected image is captured, or, an action that, in the captured image, a position in which the operating object is captured changes in a direction in which the second projected image is captured or a direction reverse to the direction in which the second projected image is captured at a predetermined speed or greater or at a predetermined acceleration or greater.

(Supplementary Note 10)

The interface device according to Supplementary Note 1, wherein

the operating object is a forefinger of a user operating the interface device, when detecting that the first projected image and the forefinger of the user are captured in the captured image, the control unit controls the projection unit to project a second projected image onto either region of a region in proximity to the forefinger of the user and in proximity to a thumb of the user, and a region in proximity to a middle finger of the user, and to project a third projected image onto the other region of the region in proximity to the forefinger of the user and in proximity to the thumb of the user, and the region in proximity to the middle finger of the user, and

the control unit further accepts a first operation based on a positional relation between a position in which the second projected image is captured and a position in which the forefinger of the user is captured in the captured image, and accepts a second operation based on a positional relation between a position in which the third projected image is captured and a position in which the forefinger of the user is captured in the captured image.

(Supplementary Note 11)

An interface device including:

a projection unit that projects a projected image;

an imaging unit that captures the projected image; and

a control unit that calculates a positional relation between a surface on which the projected image is projected and the imaging unit based on information indicating a position in which the projected image is captured in a captured image being an image captured by the imaging unit.

(Supplementary Note 12)

The interface device according to Supplementary Note 11, wherein

the imaging unit captures an image including an operating object operating the own device and the projected image,

the control unit performs processing of accepting an operation by the operating object based on a relation between a position in which the operating object is captured and a position in which the projected image is captured in a captured image being an image captured by the imaging unit, and controlling the projection unit in response to the accepted operation, and

the projected image includes a first region used for an operation with respect to the interface device based on a positional relation with the operating object, and a second region being a region different from the first region and being used for calculating a positional relation between a surface on which the projected image is projected and the imaging unit.

(Supplementary Note 13)

The interface device according to any one of Supplementary Notes 1 to 12, wherein

the projection unit includes

a laser light source that emits laser light, and

an element that modulates a phase of the laser light when the laser light is entered and emits the modulated laser light, and

the control unit determines an image formed by light emitted from the element based on a content of the accepted operation, and controls the element such that the determined image is formed.

(Supplementary Note 14)

The interface device according to Supplementary Note 13, wherein

the element includes a plurality of light-receiving regions, and each of the light-receiving regions modulates a phase of laser light incident on the light-receiving region, and launches the modulated light, and

for each of the light-receiving regions, the control unit controls the element to change a parameter determining a difference between a phase of light incident on the light-receiving region and a phase of light launched by the light-receiving region.

(Supplementary Note 15)

A portable electronic equipment incorporating the interface device according to any one of Supplementary Notes 1 to 14.

(Supplementary Note 16)

An accessory incorporating the interface device according to any one of

Supplementary Notes 1 to 14.

(Supplementary Note 17)

A module incorporated in electronic equipment, the module includes:

a projection unit that projects a first projected image; and a control unit that performs processing of receiving an image including at least an operating object operating the own device and the first projected image, accepting an operation by the operating object based on a relation between a position in which the operating object is captured and a position in which the first projected image is captured in a captured image being the received image, and controlling the projection unit in response to the accepted operation.

(Supplementary Note 18)

A control device controlling a projection unit for projecting a first projected image, the control device

receives an image including at least an operating object operating the own device and a first projected image, accepts an operation by the operating object based on a relation between a position in which the operating object is captured and a position in which the first projected image is captured in a captured image being the received image, and transmits a signal controlling the projection unit to the projection unit in response to the accepted operation.

(Supplementary Note 19)

A control method practiced by a computer controlling an interface device including an imaging unit and a projection unit for projecting a first projected image, the method including:

controlling the imaging unit to capture an image including at least an operating object operating the own device and the first projected image; and

performing processing of accepting an operation by the operating object based on a relation between a position in which the operating object is captured and a position in which the first projected image is captured in a captured image being an image captured by the imaging unit, and controlling the projection unit in response to the accepted operation.

(Supplementary Note 20)

A program for causing a computer controlling an interface device including an imaging unit and a projection unit for projecting a first projected image, to perform:

processing of controlling the imaging unit to capture an image including at least an operating object operating the own device and the first projected image; and

processing of accepting an operation by the operating object based on a relation between a position in which the operating object is captured and a position in which the first projected image is captured in a captured image being an image captured by the imaging unit, and controlling the projection unit in response to the accepted operation.

(Supplementary Note 21)

A module incorporated in electronic equipment including an imaging unit, the module including:

a projection unit that projects a projected image; and

a control unit that calculates a positional relation between a surface on which the projected image is projected and the imaging unit based on information indicating a position in which the projected image is captured in a captured image being an image captured by the imaging unit.

(Supplementary Note 22)

A control device controlling electronic equipment including an imaging unit and a projection unit that projects a projected image, the device

calculates a positional relation between a surface on which the projected image is projected and the imaging unit based on information indicating a position in which the projected image is captured in a captured image being an image captured by the imaging unit.

(Supplementary Note 23)

A control method practiced by a computer controlling an interface device including an imaging unit and a projection unit that projects a projected image, the method including

calculating a positional relation between a surface on which the projected image is projected and the imaging unit based on information indicating a position in which the projected image is captured in a captured image being an image captured by the imaging unit.

(Supplementary Note 24)

A program causing a computer controlling an interface device including an imaging unit and a projection unit that projects a projected image to perform

processing of calculating a positional relation between a surface on which the projected image is projected and the imaging unit based on information indicating a position in which the projected image is captured in a captured image being an image captured by the imaging unit.

### INDUSTRIAL APPLICABILITY

The present invention is applicable to, for example, providing an interface device having an input function with high recognition accuracy.

### REFERENCE SIGNS LIST

1 CPU
2 Storage unit
100 Interface device
110 Imaging unit
120 Control unit
130 Projection unit
200 Operation surface
300 Projected image
400 Operating object
500 Module
600 Control device
800 Electronic part

What is claimed is:

1. An interface device comprising:
a projection unit that projects a first projected image;
an imaging unit that captures an image of a region on which the first projected image is projected; and
a control unit that, when the first projected image is captured and also an operating object is captured in a captured image that is an image captured by the imaging unit, recognizes operation information on operation of the operating object based on a positional relation between a captured position in which the first projected image is captured and a captured position in which the operating object is captured in the captured image.

2. The interface device according to claim 1, wherein
the control unit controls the projection unit to project a second projected image in response to the operation information, and
the control unit further recognizes operation information on next operation of the operating object based on a positional relation between a captured position of the operating object and a captured position of the second projected image provided by the projection unit in the captured image.

3. The interface device according to claim 2, wherein the first projected image is an image in which a plurality of options are displayed,
the control unit recognizes information of an operation which selects a selected option from the plurality of options based on a positional relation between a captured position of the operating object and a captured position of the first projected image in the captured image, and
the second projected image is an image in which an option related to the selected option is displayed.

4. The interface device according to claim 3, wherein a criterion used by the control unit when recognizing operation information of the operating object based on a captured position of the first projected image in the captured image, is different from a criterion used by the control unit when recognizing operation information of the operating object based on a captured position of the second projected image in the captured image.

5. The interface device according to claim 2, wherein the projection unit projects the second projected image with superposing on the first projected image.

6. The interface device according to claim 1, wherein the control unit recognizes operation information on the operating object based on information about a motion of the operating object in addition to the positional relation.

7. The interface device according to claim 6, wherein,
when detecting an action of the operating object staying for a predetermined time or longer, the control unit recognizes operation information on the operating object based on the projected image projected on a position at which the operating object stays, or,
when detecting an action of the operating object moving linearly at a predetermined speed or greater, or at a predetermined acceleration or greater, the control unit recognizes operation information on the operating object based on the projected image positioned in a direction in which the operating object moves, or,
when detecting an action of the operating object moving linearly at a predetermined speed or greater, or at a predetermined acceleration or greater, the control unit recognizes operation information on the operating object based on the projected image projected on a position from which the operating object starts the motion.

8. The interface device according to claim 1, wherein the control unit has a function of distinguishing a plurality of types of the operating objects, and,
when the plurality of types of the operating objects are displayed in the captured image, the control unit controls the projection unit in such a way mutually distinct projected images are projected in proximity to the respective operating objects.

9. The interface device according to claim 8, wherein one of the operating objects is a thumb of a user, and another of the operating objects is a forefinger of the user,
the control unit controls the projection unit such that the first projected image is projected on a region including the thumb and the forefinger of the user, and further controls the projection unit such that mutually distinct projected images are projected in proximity to the thumb and in proximity to the forefinger, respectively, and
the control unit further recognizes operation information on the thumb based on a positional relation between a captured position of the thumb and a captured position of the projected image projected in proximity to the thumb, and also recognizes operation information on the forefinger based on a positional relation between a captured position of the forefinger and a captured position of the projected image projected in proximity to the forefinger.

10. An interface device comprising:
a projection unit that projects a projected image;
an imaging unit that captures an image of a region on which the projected image is projected; and
a control unit that calculates a positional relation between a surface on which the projected image is projected and the imaging unit based on information about a captured position in which the projected image is captured in a captured image being an image captured by the imaging unit.

11. The interface device according to claim 10, wherein, when the projected image is captured and also an operating object is captured in a captured image being an image captured by the imaging unit, the control unit recognizes operation information on the operating object based on a positional relation between a captured position in which the projected image is captured and a captured position in which the operating object is captured in the captured image, and,
the projected image provided by the projection unit further includes an image region used in processing of recognizing the operation information of the operating object, and an image region used in processing of calculating the positional relation between a surface on which the projected image is projected and the imaging unit.

12. The interface device according to claim 1, wherein the projection unit includes a laser light source emitting laser light and an element modulating a phase of the laser light entered from the laser light source and emitting the laser light after the modulation, and
the control unit determines an image formed by light emitted by the element in response to the operation information recognizing, and controls the element such that the determined image is formed.

13. The interface device according to claim 12, wherein the element includes a plurality of light-receiving regions and each of the light-receiving regions modulates a phase of laser light incident on the light-receiving region and emits the modulated light and,
the control unit controls the element such that a parameter of the light-receiving region is changed for each of the light-receiving regions, the parameter determining a difference between a phase of light incident on the light-receiving region and a phase of light emitting from the light-receiving region.

14. A portable device comprising the interface device according to claim 1.

15. A control device, comprising
a unit that receives a captured image displaying a projected image projected by a projection unit being a control target;
when the projected image and also an operating object are displayed in the captured image, recognizing operation information on the operating object based on a relation between a captured position in which the projected image is displayed and a captured position in which the operating object is displayed in the captured image; and
controlling the projection unit in response to the operation information.

16. A module comprising:
the control device according to claim 15 and
a projection unit controlled by the control device.

17. (canceled)

18. (canceled)
